(19) United States
(12) Patent Application Publication
(10) Pub. No.: US 2007/0066674 A1
(43) Pub. Date: Mar. 22, 2007

(54) Tricyclic imidzopyridines for use as gastric secretion inhibitors

(75) Inventor: Andreas Palmer, Konstanz (DE)

Correspondence Address: NATH & ASSOCIATES PLLC, 112 South West Street, Alexandria, VA, 22314, US

(73) Assignee: Altana Pharma AG, Konstanz (DE)

(21) Appl. No.: 10/582,395

(22) PCT Filed: Dec. 17, 2004
(86) PCT No.: PCT/EP04/53560

§ 371 Date: Jun. 30, 2006

(30) Foreign Application Priority Data
Dec. 19, 2003 (EP) 03029361.7

(51) Int. Cl. A01N 43/56

(52) U.S. Cl. 514/406

(57) ABSTRACT

The invention provides compounds of the formula 1, 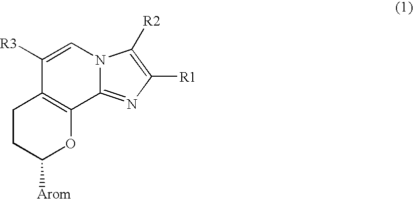 in which the substituents and symbols are as defined in the description. The compounds inhibit the secretion of gastric acid.

### TECHNICAL FIELD

The invention relates to enantiomers of tricyclic imidazopyridines, a process for the preparation of these enantiomers and their use in the pharmaceutical industry as active compounds for preparing medicaments.

### PRIOR ART

U.S. Pat. No. 4,468,400 describes tricyclic imidazo[1,2-a]pyridines having different ring systems fused to the imidazopyridine skeleton, which compounds are said to be suitable for treating peptide ulcer disorders. The International Patent Applications WO 95/27714, WO 98/42707, WO 98/54188, WO 00/17200, WO 00/26217, WO 00/63211, WO 01/72756, WO 01/72754, WO 01/72755, WO 01/72757, WO 02/34749, WO 03/014120, WO 03/016310, WO 03/014123, WO 03/068774 and WO 03/091253 disclose tricyclic imidazopyridine derivatives having a very specific substitution pattern, which compounds are likewise said to be suitable for treating gastrointestinal disorders.

### DESCRIPTION OF THE INVENTION

It has now been found that the compounds described for example in WO 03/014123 as racemic mixtures can be separated into their enantiomers or the enantiomers can be prepared in a stereoselective way. It has further been found, unexpectedly, that the enantiomers of the formula 1 have a pronounced activity in inhibiting gastric acid secrection as compared to their optical antipodes or the formula 2.

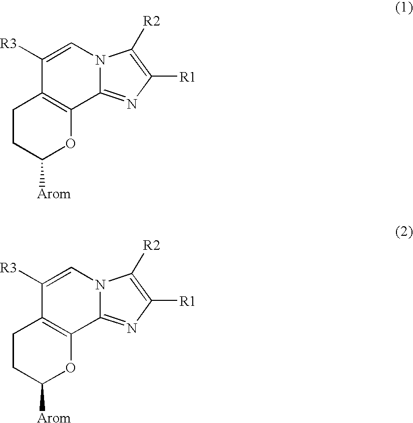

Although enantiomerically pure tricyclic imidazo[1,2-a]pyridine derivatives are known for example from the International Patent Application WO 95/27714, the higher activity of the compounds of the formula 1 as compared to the compounds of the formula 2 was unexpected. So far, the preference for enantiomers of the formula 1 due to a more pronounced activity in inhibiting gastric acid secretion as compared to their optical antipodes of the formula 2 has not been described yet for any combination of the substituents R1, R2, R3 and Arom.

The invention thus provides compounds of the formula 1 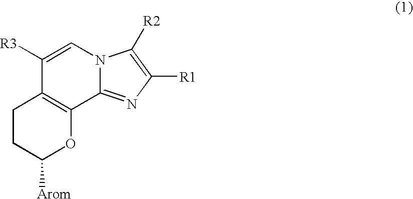
where
R1 is hydrogen, 1-4C-alkyl, 3-7C-cycloalkyl, 1-4C-alkoxy-1-4C-alkyl or 1-4C-alkoxycarbonyl
R2 is hydrogen, 1-4C-alkyl, halogen, 2-4C-alkenyl, 2-4C-alkynyl, hydroxy-1-4C-alkyl, 3-7C-cycloalkyl, 1-4C-alkoxycarbonyl
R3 is hydroxy-1-2C-alkyl, 1-4C-alkoxy-1-2C-alkyl, 1-4C-alkoxy-1-4C-alkoxy-1-2C-alkyl, 1-4-C-alkoxycarbonyl or the radical —CO—NR31R32,
   where
   R31 is hydrogen, 1-7C-alkyl, hydroxy-1-4C-alkyl or 1-4C-alkoxy-1-4C-alkyl and
   R32 is hydrogen, 1-7C-alkyl, hydroxy-1-4C-alkyl or 1-4C-alkoxy-1-4C-alkyl,
   or where
   R31 and R32 together and including the nitrogen atom to which they are attached are a pyrrolidino, piperidino, morpholino radical,
Arom is a R4-, R5-, R6- and R7-substituted mono- or bicyclic aromatic radical selected from the group consisting of phenyl, naphthyl, pyrrolyl, pyrazolyl, imidazolyl, 1,2,3-triazolyl, indolyl, benzimidazolyl, furanyl (furyl), benzofuranyl (benzofuryl), thiophenyl (thienyl), benzothiophenyl (benzothienyl), thiazolyl, isoxazolyl, pyridinyl, pyrimidinyl, quinolinyl and isoquinolinyl,
   where
   R4 is hydrogen, 1-4C-alkyl, hydroxy-1-4C-alkyl, 1-4C-alkoxy, carboxyl, 1-4C-alkoxycarbonyl, carboxy-1-4C-alkyl, 1-4C-alkoxycarbonyl-1-4C-alkyl, halogen, hydroxyl, aryl, aryl-1-4C-alkyl, aryloxy, aryl-1-4C-alkoxy, trifluoromethyl, nitro, amino, mono- or di-1-4C-alkylamino, 1-4C-alkylcarbonylamino, 1-4C-alkoxycarbonylamino, 1-4C-alkoxy-1-4C-alkoxycarbonylamino or sulfonyl,
   R5 is hydrogen, 1-4C-alkyl, 1-4C-alkoxy, 1-4C-alkoxycarbonyl, halogen, trifluoromethyl or hydroxyl,
   R6 is hydrogen, 1-4C-alkyl or halogen and
   R7 is hydrogen, 1-4C-alkyl or halogen,
   where
   aryl is phenyl or substituted phenyl having one, two or three identical or different substituents from the group consisting of 1-4C-alkyl, 1-4C-alkoxy, carboxyl, 1-4C-alkoxycarbonyl, halogen, trifluoromethyl, nitro, trifluoromethoxy, hydroxyl and cyano,
      and the salts of these compounds.

1-4C-Alkyl denotes straight-chain or branched alkyl radicals having 1 to 4 carbon atoms. Examples which may be mentioned are the butyl, isobutyl, sec-butyl, tert-butyl, propyl, isopropyl, ethyl and methyl radicals.

3-7C-Cycloalkyl denotes cyclopropyl, cyclobutyl, cyclopentyl, cyclohexyl and cycloheptyl, among which cyclopropyl, cyclobutyl and cyclopentyl are preferred.

1-4C-Alkoxy denotes radicals which, in addition to the oxygen atom, contain a straight-chain or branched alkyl radical having 1 to 4 carbon atoms. Examples which may be mentioned are the butoxy, isobutoxy, sec-butoxy, tert-butoxy, propoxy, isopropoxy and preferably the ethoxy and methoxy radicals.

1-4C-Alkoxy-1-4C-alkyl denotes one of the abovementioned 1-4C-alkyl radicals which is substituted by one of the abovementioned 1-4C-alkoxy radicals. Examples which may be mentioned are the methoxymethyl, the methoxyethyl and the butoxyethyl radicals.

1-4C-Alkoxycarbonyl (—CO-1-4C-alkoxy) denotes a carbonyl group to which is attached one of the abovementioned 1-4C-alkoxy radicals. Examples which may be mentioned are the methoxycarbonyl (CH₃O—C(O)—) and the ethoxycarbonyl (CH₃CH₂O—C(O)—) radicals.

For the purpose of the invention, halogen is bromine, chlorine and fluorine.

2-4C-Alkenyl denotes straight-chain or branched alkenyl radicals having 2 to 4 carbon atoms. Examples which may be mentioned are the 2-butenyl, 3-butenyl, 1-propenyl and the 2-propenyl (allyl) radicals.

2-4C-Alkynyl denotes straight-chain or branched alkynyl radicals having 2 to 4 carbon atoms. Examples which may be mentioned are the 2-butynyl, the 3-butynyl, 2-propynyl (propargyl) and, preferably, the 1-ethynyl, 1-propynyl and 1-butynyl radicals.

Hydroxy-1-4C-alkyl denotes abovementioned 1-4C-alkyl radicals which are substituted by a hydroxyl group. Examples which may be mentioned are the hydroxymethyl, the 2-hydroxyethyl and the 3-hydroxypropyl radicals.

1-2C-Alkyl denotes the methyl or the ethyl radicals.

Hydroxy-1-2C-alkyl denotes abovementioned 1-2C-alkyl radicals which are substituted by a hydroxyl group. Examples which may be mentioned are the hydroxymethyl and the 2-hydroxyethyl radicals.

1-4C-Alkoxy-1-2C-alkyl denotes one of the abovementioned 1-2C-akyl radicals which is substituted by one of the abovementioned 1-4C-alkoxy radicals. Examples which may be mentioned are the methoxymethyl, the methoxyethyl and the butoxyethyl radicals.

1-4Alkoxy-1-4C-alkoxy denotes one of the abovementioned 1-4C-alkoxy radicals which is substituted by a further 1-4C-alkoxy radical. Examples which may be mentioned are the radicals 2-(methoxy)ethoxy (CH₃—O—CH₂—CH₂—O—) and 2-(ethoxy)ethoxy (CH₃CH₂—O—CH₂—CH₂—O—).

1-4C-Alkoxy-1-4C-alkoxy-1-2C-alkyl denotes one of the abovementioned 1-4C-alkoxy-1-2C-alkyl radicals which is substituted by one of the abovementioned 1-4C-alkoxy radicals. An example which may be mentioned is the radical 2-(methoxy)ethoxymethyl (CH₃—O—CH₂—CH₂—O—CH₂—).

1-7C-Alkyl denotes straight-chain or branched alkyl radicals having 1 to 7 carbon atoms. Examples which may be mentioned are the heptyl, isoheptyl-(5-methylhexyl), hexyl, isohexyl-(4-methylpentyl), neohexyl-(3,3-dimethylbutyl), pentyl, isopentyl-(3-methylbutyl), neopentyl-(2,2-dimethylpropyl), butyl, isobutyl, sec-butyl, tert-butyl, propyl, isopropyl, ethyl and methyl radicals.

Carboxy-1-4C-alkyl denotes, for example, the carboxymethyl (—CH₂COOH) or the carboxyethyl (—CH₂CH₂COOH) radical.

1-4C-Alkoxycarbonyl-1-4C-alkyl denotes one of the abovementioned 1-4C-alkyl radicals which is substituted by one of the abovementioned 1-4C-alkoxycarbonyl radicals. An example which may be mentioned is the ethoxycarbonylmethyl (CH₃CH₂OC(O)CH₂—) radical.

Aryl-1-4C-alkyl denotes an aryl-substituted 1-4C-alkyl radical. An example which may be mentioned is the benzyl radical.

Aryl-1-4C-alkoxy denotes an aryl-substituted 1-4C-alkoxy radical. An example which may be mentioned is the benzyloxy radical.

Mono- or di-1-4C-alkylamino radicals contain, in addition to the nitrogen atom, one or two of the abovementioned 1-4C-alkyl radicals. Preference is given to di-1-4C-alkylamino and in particular to dimethyl-, diethyl- or diisopropylamino.

1-4C-Alkylcarbonylamino denotes an amino group to which a 1-4C-alkylcarbonyl radical is attached. Examples which may be mentioned are the propionylamino (C₃H₇C(O)NH—) and the acetylamino (acetamido, CH₃C(O)NH—) radicals.

1-4C-Alkoxycarbonylamino denotes an amino radical which is substituted by one of the abovementioned 1-4C-alkoxycarbonyl radicals. Examples which may be mentioned are the ethoxycarbonylamino and the methoxycarbonylamino radicals.

1-4C-Alkoxy-1-4C-alkoxycarbonyl denotes a carbonyl group to which one of the abovementioned 1-4C-alkoxy-1-4C-alkoxy radicals is attached. Examples which may be mentioned are the 2-(methoxy)-ethoxycarbonyl (CH₃—O—CH₂CH₂—O—CO—) and the 2-(ethoxy)ethoxycarbonyl (CH₃CH₂—O—CH₂CH₂O—CO—) radicals.

1-4C-Alkoxy-1-4C-alkoxycarbonylamino denotes an amino radical which is substituted by one of the abovementioned 1-4C-alkoxy-1-4C-alkoxycarbonyl radicals. Examples which may be mentioned are the 2-(methoxy)ethoxycarbonylamino and the 2-(ethoxy)ethoxycarbonylamino radicals.

Radicals Arom which may be mentioned are, for example, the following substituents: 4-acetoxyphenyl, 4-acetamidophenyl, 2-methoxyphenyl, 3-methoxyphenyl, 4-methoxyphenyl, 3-benzyloxyphenyl, 4-benzyloxyphenyl, 3-benzyloxy-4-methoxyphenyl, 4-benzyloxy-3-methoxyphenyl, 3,5-bis(trifluoromethyl)phenyl, 4-butoxyphenyl, 2-chlorophenyl, 3-chlorophenyl, 4-chlorophenyl, 2-chloro-6-fluorophenyl, 3-chloro-4-fluorophenyl, 2-chloro-5-nitrophenyl, 4-chloro-3-nitrophenyl, 3-(4-chlorophenoxy)phenyl, 2,4-dichlorophenyl, 3,4-difluorophenyl, 2,4-dihydroxyphenyl, 2,6-dimethoxyphenyl, 3,4-dimethoxy-5-hydroxyphenyl, 2,5-dimethylphenyl, 3-ethoxy-4-hydroxyphenyl, 2-fluorophenyl, 4-fluorophenyl, 4-hydroxyphenyl, 2-hydroxy-5-nitrophenyl, 3-methoxy-2-nitrophenyl, 3-nitrophenyl, 2,3,5-trichlorophenyl, 2,4,6-trihydroxyphenyl, 2,3,4-trimethoxyphenyl, 2-hydroxy-1-naphthyl, 2-methoxy-1-naphthyl, 4-methoxy-1-naphthyl, 1-methyl-2-pyrrolyl, 2-pyrrolyl, 3-methyl-2-pyrrolyl, 3,4-dimethyl-2-pyrrolyl, 4-(2-methoxycarbonylethyl)-3-methyl-2-pyrrolyl, 5-ethoxycarbonyl-2,4-dimethyl-3-pyrrolyl, 3,4-dibromo-5-methyl-2-pyrrolyl, 2,5-dimethyl-1-phenyl-3-pyrrolyl, 5-carboxy-3-ethyl-4-methyl-2-pyrrolyl, 3,5-dimethyl-2-pyrrolyl, 2,5-dimethyl-1-(4-trifluoromethylphenyl)-3-pyrrolyl, 1-(2,6)-dichloro-4-trifluoromethylphenyl)-2-pyrrolyl, 1-(2-nitrobenzyl)-2-pyrrolyl, 1-(2-fluorophenyl)-2-pyrrolyl, 1-(4-trifluoromethoxyphenyl)-2-pyrrolyl, 1-(2-nitrobenzyl)-2-pyrrolyl, 1-(4-ethoxycarbonyl)-2,5-dimethyl-3-pyrrolyl, 5-chloro-1,3-dimethyl-4-pyrazolyl, 5-chloro-1-methyl-3-trifluoromethyl-4-pyrazolyl, 1-(4-chlorobenzyl)-5-pyrazolyl, 1,3-dimethyl-5-(4-chlorophenoxy)-4-pyrazolyl, 1-methyl-3-trifluoromethyl-5-(3-trifluoromethylphenoxy)-4-pyrazolyl, 4-methoxycarbonyl-1-(2,6-dichlorophenyl)-5-pyrazolyl, 5-allyloxy-1-methyl-3-trifluoromethyl-4-pyrazolyl, 5-chloro-1-phenyl-3-trifluoromethyl-4-pyrazolyl, 3,5-dimethyl-1-phenyl-4-imidazolyl, 4-bromo-1-methyl-5-imidazolyl, 2-butylimidazolyl, 1-phenyl-1,2,3-triazol-4-yl, 3-indolyl, 4-indolyl, 7-indolyl, 5-methoxy-3-indolyl, 5-benzyloxy-3-indolyl, 1-benzyl-3-indolyl, 2-(4-chlorophenyl)-3-indolyl, 7-benzyloxy-3-indolyl, 6-benzyloxy-3-indolyl, 2-methyl-5-nitro-3-indolyl, 4,5,6,7-tetrafluoro-3-indolyl, 1-(3,5-difluorobenzyl)-3-indolyl, 1-methyl-2-(4-trifluorophenoxy)-3-indolyl, 1-methyl-2-benzimidazolyl, 5-nitro-2-furyl, 5-hydroxymethyl-2-furyl, 2-furyl, 3-furyl, 5-(2-nitro-4-trifluoromethylphenyl)-2-furyl, 4-ethoxycarbonyl-5-methyl-2-furyl, 5-(2-trifluoromethoxyphenyl)-2-furyl, 5-(4-methoxy-2-nitrophenyl)-2-furyl, 4-bromo-2-furyl, 5-dimethylamino-2-furyl, 5-bromo-2-furyl, 5-sulfo-2-furyl, 2-benzofuryl, 2-thienyl, 3-thienyl, 3-methyl-2-thienyl, 4-bromo-2-thienyl, 5-bromo-2-thienyl, 5-nitro2-thienyl, 5-methyl-2-thienyl, 5-(4-methoxyphenyl)-2-thienyl, 4-methyl-2-thienyl, 3-phenoxy-2-thienyl, 5-carboxy-2-thienyl, 2,5-dichloro-3-thienyl, 3-methoxy-2-thienyl, 2-benzothienyl, 3-methyl-2-benzothienyl, 2-bromo-5-chloro-3-benzothienyl, 2-thiazolyl, 2-amino-4-chloro-5-thiazolyl, 2,4-dichloro-5-thiazolyl, 2-diethylamino-5-thiazolyl, 3-methyl-4-nitro-5-isoxazolyl, 2-pyridyl, 3-pyridyl, 4-pyridyl, 6-methyl-2-pyridyl, 3-hydroxy-5-hydroxymethyl-2-methyl-4-pyridyl, 2,6-dichloro-4-pyridyl, 3-chloro-5-trifluoromethyl-2-pyridyl, 4,6-dimethyl-2-pyridyl, 4-(4-chlorophenyl)-3-pyridyl, 2-chloro-5-methoxycarbonyl-6-methyl-4-phenyl-3-pyridyl, 2-chloro-3-pyridyl, 6-(3-trifluoromethylphenoxy)-3-pyridyl, 2-(4-chlorophenoxy)-3-pyridyl, 2,4-dimethoxy-5-pyrimidine, 2-quinolinyl, 3-quinolinyl, 4-quinolinyl, 2-chloro-3-quinolinyl, 2-chloro-6methoxy-3-quinolinyl, 8-hydroxy-2-quinolinyl and 4-isoquinolinyl.

Suitable salts of compounds of the formula 1 are—depending on the substitution—in particular all acid addition salts. Particular mention may be made of the pharmacologically acceptable salts of the inorganic and organic acids customarily used in pharmacy. Those suitable are water-soluble and water-insoluble acid addition salts with acids such as, for example, hydrochloric acid, hydrobromic acid, phosphoric acid, nitric acid, sulfuric acid, acetic acid, citric acid, D-gluconic acid, benzoic acid, 2-(4-hydroxybenzoyl)benzoic acid, butyric acid, sulfosalicylic acid, maleic acid, lauric acid, malic acid, fumaric acid, succinic acid, oxalic acid, tartaric acid, embonic acid, stearic acid, toluenesulfonic acid, methanesulfonic acid or 3-hydroxy-2-naphthoic acid, where the acids are employed in the salt preparation in an equimolar ratio or in a ratio differing therefrom, depending on whether the acid is a mono- or polybasic acid and on which salt is desired.

Pharmacologically unacceptable salts, which can be initially obtained, for example, as process products in the preparation of the compounds according to the invention on an industrial scale, are converted into pharmacologically acceptable salts by processes known to the person skilled in the art.

It is known to the person skilled in the art that the compounds according to the invention and their salts can, for example when they are isolated in crystalline form, comprise varying amounts of solvents. The invention therefore also embraces all solvates and, in particular, all hydrates of the compounds of the formula 1, and all solvates and, in particular, all hydrates of the salts of the compounds of the formula 1.

In particular, the invention relates to compounds of the formula 1 according to the invention and/or their salts being substantially free of compounds of the formula 2 and/or their salts.

Substantially free in the context of the invention means that the compounds of the formula 1 and/or their salts contain less than 10% by weight of compounds of the formula 2 and/or their salts. Preferably, “substantially free” means that compounds of the formula 1 and/or their salts contain less than 5% by weight of compounds compounds of the formula 2 and/or their salts. In the most preferred embodiment, “substantially free” means that compounds of the formula 1 and/or their salts contain less than 2% by weight of compounds of the formula 2 and/or their salts.

Compounds which are to be mentioned are those compounds of the formula 1, where
R1 is 1-4C-alkyl or 3-7C-cycloalkyl
R2 is 1-4C-alkyl, halogen, hydroxy-1-4C-alkyl, 2-4C-alkenyl or 3-7C-cycloalkyl,
R3 is hydroxy-1-2C-alkyl, 1-4C-alkoxy-1-2C-alkyl, 1-4C-alkoxy-1-4C-alkoxy-1-2C-alkyl, 1-4C-alkoxycarbonyl or the radical —CO—NR31R32,
   where
   R31 is hydrogen, 1-7C-alkyl, hydroxy-1-4C-alkyl or 1-4C-alkoxy-1-4C-alkyl and
   R32 is hydrogen, 1-7C-alkyl, hydroxy-1-4C-alkyl or 1-4C-alkoxy-1-4C-alkyl,
   or where
   R31 and R32 together and including the nitrogen atom to which they are attached are a pyrrolidino, piperidino, morpholino radical,
Arom is a R4-, R5-, R6- and R7- substituted mono- or bicyclic aromatic radical selected from the group consisting of phenyl, naphthyl, pyrrolyl, pyrazolyl, imidazolyl, 1,2,3-triazolyl, indolyl, benzimidazolyl, furanyl (furyl), benzofuranyl (benzofuryl), thiophenyl (thienyl), benzothiophenyl (benzothienyl), thiazolyl, isoxazolyl, pyridinyl, pyrimidinyl, quinolinyl and isoquinolinyl,
   where
   R4 is hydrogen, 1-4C-alkyl, hydroxy-1-4C-alkyl, 1-4C-alkoxy, carboxyl, 1-4C-alkoxycarbonyl, carboxy-1-4C-alkyl, 1-4C-alkoxycarbonyl-1-4C-alkyl, halogen, hydroxyl, aryl, aryl-1-4C-alkyl, aryloxy, aryl-1-4C-alkoxy, trifluoromethyl, nitro, amino, mono- or di-1-4C-alkylamino, 1-4C-alkylcarbonylamino, 1-4C-alkoxycarbonylamino, 1-4C-alkoxy-1-4C-alkoxycarbonylamino or sulfonyl,
   R5 is hydrogen, 1-4C-alkyl, 1-4C-alkoxy, 1-4C-alkoxycarbonyl, halogen, trifluoromethyl or hydroxyl,
   R6 is hydrogen, 1-4C-alkyl or halogen and
   R7 is hydrogen, 1-4C-alkyl or halogen,
   where
   aryl is phenyl or substituted phenyl having one, two or three identical or different substituents from the group consisting of 1-4C-alkyl, 1-4C-alkoxy, carboxyl, 1-4C-alkoxycarbonyl, halogen, trifluoromethyl, nitro, trifluoromethoxy, hydroxyl and cyano,
      and the salts of these compounds.

Compounds which are also to be mentioned are those compounds of the formula 1, where
R1 is 1-4C-alkyl or 3-7C-cycloalkyl
R2 is 1-4C-alkyl, halogen, hydroxy-1-4C-alkyl, 2-4C-alkenyl or 3-7C-cycloalkyl,
R3 is the radical —CO—NR31R32,
   where
   R31 is hydrogen, 1-7C-alkyl, hydroxy-1-4C-alkyl or 1-4C-alkoxy-1-4C-alkyl and
   R32 is hydrogen, 1-7C-alkyl, hydroxy-1-4C-alkyl or 1-4C-alkoxy-1-4C-alkyl,
   or where
   R31 and R32 together and including the nitrogen atom to which they are attached are a pyrrolidino, piperidino, morpholino radical,
Arom is a R4-, R5-, R6- and R7- substituted mono- or bicyclic aromatic radical selected from the group consisting of phenyl, naphthyl, pyrrolyl, pyrazolyl, imidazolyl, 1,2,3triazolyl, indolyl, benzimidazolyl, furanyl (furyl), benzofuranyl (benzofuryl), thiophenyl (thienyl), benzothiophenyl (benzothienyl), thiazolyl, isoxazolyl, pyridinyl, pyrimidinyl, quinolinyl and isoquinolinyl,
   where
   R4 is hydrogen, 1-4C-alkyl, hydroxy-1-4C-alkyl, 1-4C-alkoxy, carboxyl, 1-4C-alkoxycarbonyl, carboxy-1-4C-alkyl, 1-4C-alkoxycarbonyl-1-4C-alkyl, halogen, hydroxyl, aryl, aryl-1-4C-alkyl, aryloxy, aryl-1-4C-alkoxy, trifluoromethyl, nitro, amino, mono- or di-1-4C-alkylamino, 1-4C-alkylcarbonylamino, 1-4C-alkoxycarbonylamino, 1-4C-alkoxy-1-4C-alkoxycarbonylamino or sulfonyl,
   R5 is hydrogen, 1-4C-alkyl, 1-4C-alkoxy, 1-4C-alkoxycarbonyl, halogen, trifluoromethyl or hydroxyl,
   R6 is hydrogen, 1-4C-alkyl or halogen and
   R7 is hydrogen, 1-4C-alkyl or halogen,
   where
   aryl is phenyl or substituted phenyl having one, two or three identical or different substituents from the group consisting of 1-4C-alkyl, 1-4C-alkoxy, carboxyl, 1-4C-alkoxycarbonyl, halogen, trifluoromethyl, nitro, trifluoromethoxy, hydroxyl and cyano,
      and the salts of these compounds.

Particular mention is given to compounds of the formula 1, where
R1 is 1-4C-alkyl,
R2 is 1-4C-alkyl, halogen, hydroxy-1-4C-alkyl or 2-4C-alkenyl,
R3 is hydroxy-1-2C-alkyl, 1-4C-alkoxy-1-2C-alkyl, 1-4C-alkoxy-1-4C-alkoxy-1-2C-alkyl or the radical —CO—NR31R32,
   where
   R31 is hydrogen, 1-7C-alkyl,
   R32 is hydrogen, 1-7C-alkyl,
   or where
   R31 and R32 together and including the nitrogen atom to which they are attached are a pyrrolidino, piperidino, morpholino radical,
Arom is a R4- and R5- substituted phenyl, furanyl (furyl), thiophenyl (thienyl), pyrrolyl or pyridinyl,
   where
   R4 is hydrogen, 1-4C-alkyl, hydroxy-1-4C-alkyl, 1-4C-Calkoxy, halogen or hydroxyl,
   R5 is hydrogen, 1-4C-alkyl, 1-4C-alkoxy, halogen or hydroxyl,
      and the salts of these compounds.

Particular mention is also given to compounds of the formula 1, where
R1 is 1-4C-alkyl,
R2 is 1-4C-alkyl, halogen, hydroxy-1-4C-alkyl or 2-4C-alkenyl,
R3 is the radical —CO—NR31R32,
   where
   R31 is hydrogen or 1-7C-alkyl,
   R32 is hydrogen or 1-7C-alkyl,
   or where
   R31 and R32 together and including the nitrogen atom to which they are attached are a pyrrolidino, piperidino, morpholino radical,
Arom is a R4- and R5- substitted phenyl, furanyl (furyl), thiophenyl (thienyl) or pyridinyl,
   where
   R4 is hydrogen, 1-4C-alkyl, hydroxy-1-4C-alkyl, 1-4C-alkoxy, halogen or hydroxyl,
   R5 is hydrogen, 1-4C-alkyl, 1-4C-alkoxy, halogen or hydroxyl,
      and the salts of these compounds.

Emphasis is given to compounds of the formula 1, where
R1 is 1-4C-alkyl,
R2 is 1-4C-alkyl, halogen, hydroxyl-1-4C-alkyl or 2-4C-alkenyl,
R3 is hydroxy-1-2C-alkyl, 1-4C-alkoxy-1-2C-alkyl, 1-4C-alkoxy-1-4C-alkoxy-1-2C-alkyl or the radical —CO—NR31R32,
   where
   R31 is hydrogen or 1-7C-alkyl,
   R32 is hydrogen or 1-7C-alkyl,
   or where
   R31 and R32 together and including the nitrogen atom to which they are attached are a pyrrolidino, piperidino, morpholino radical,
Arom is a R4- and R5- substituted phenyl, furanyl (furyl), thiophenyl (thienyl), pyrrolyl or pyridinyl,
   where
   R4 is hydrogen, 1-4C-alkyl, hydroxy-1-4C-alkyl, 1-4C-alkoxy, halogen or hydroxyl,
   R5 is hydrogen, 1-4C-alkyl, 1-4C-alkoxy, halogen or hydroxyl,
      and the salts of these compounds.

Emphasis is also given to compounds of the formula 1, where
R1 is 1-4C-alkyl,
R2 is 1-4C-alkyl,
R3 is the radical —CO—NR31R32,
   where
   R31 is hydrogen or 1-7C-alkyl,
   R32 is hydrogen or 1-7C-alkyl,
   or where
   R31 and R32 together and including the nitrogen atom to which they are attached are a pyrrolidino, piperidino, morpholino radical,
Arom is a R4- and R5 substituted phenyl, furanyl (furyl), thiophenyl (thienyl) or pyridinyl,
   where
   R4 is hydrogen, 1-4C-alkyl, hydroxy-1-4C-alkyl, 1-4alkoxy, halogen or hydroxyl,
   R5 is hydrogen, 1-4C-alkyl, 1-4C-alkoxy, halogen or hydroxyl,
      and the salts of these compounds.

Emphasis is also given to compounds of the formula 1, where
R1 is 1-4C-alkyl,
R2 halogen, hydroxy-1-4C-alkyl or 2-4C-alkenyl,
R3 is the radical —CO—NR31R32,
   where
   R31 is hydrogen or 1-7C-alkyl,
   R32 is hydrogen or 1-7C-alkyl,
   or where
   R31 and R32 together and including the nitrogen atom to which they are attached are a pyrrolidino, piperidino, morpholino radical,
Arom is a R4- and R5- substituted phenyl, furanyl (furyl), thiophenyl (thienyl) or pyridinyl,
   where
   R4 is hydrogen, 1-4C-alkyl, hydroxy-1-4C-alkyl, 1-4C-alkoxy, halogen or hydroxyl,
   R5 is hydrogen, 1-4C-alkyl, 1-4C-alkoxy, halogen or hydroxyl,
      and the salts of these compounds.

Particular emphasis is given to compounds of the formula 1, where
R1 is 1-4C-alkyl,
R2 is 1-4C-alkyl, halogen or hydroxy-1-4C-alkyl,
R3 is 1-4C-alkoxy-1-2C-alkyl or the radical —CO—NR31R32,
   where
   R31 is hydrogen or 1-7C-alkyl,
   R32 is hydrogen or 1-7C-alkyl,
   or wherein
   R31 and R32 together and including the nitrogen atom to which they are attached are a pyrrolidino radical,
Arom is a R4 substituted phenyl or thiophenyl (thienyl),
   where
   R4 is hydrogen, 1-4C-alkyl or halogen,
      and the salts of these compounds.

Particular emphasis is also given to compounds of the formula 1 where
R1 is 1-4C-alkyl,
R2 is 1-4C-alkyl,
R3 is the radical —CO—NR31R32,
   where
   R31 is hydrogen or 1-7C-alkyl,
   R32 is hydrogen or 1-7C-alkyl,
Arom is phenyl
   and the salts of these compounds.

As particularly preferred examples, the following examplary compounds of the formula 1 can be synthesized according the general procedures outlined in more detail below:

| R1 | R2 | R3 | Arom |
|---|---|---|---|
| CH₃ | CH₃ | —C(O)—N(CH₃)₂ | phenyl |
| CH₃ | —CH₂OH | —C(O)—N(CH₃)₂ | Phenyl |
| CH₃ | Br | —C(O)—N(CH₃)₂ | Phenyl |
| CH₃ | —CH₂CH₃ | —C(O)—N(CH₃)₂ | phenyl |
| CH₃ | CH₃ | —C(O)-pyrrolidino | Phenyl |
| CH₃ | CH₃ | —C(O)—N(H)CH₃ | phenyl |
| CH₃ | CH₃ | —C(O)—NH₂ | phenyl |
| CH₃ | CH₃ | —C(O)—N(CH₃)₂ | 2-methylphenyl |
| CH₃ | CH₃ | —C(O)—N(CH₃)₂ | 2-fluorophenyl |
| CH₃ | CH₃ | —C(O)—N(CH₃)₂ | 4-fluorophenyl |
| CH₃ | CH₃ | —C(O)—N(CH₃)₂ | thiophen-2-yl |
| CH₃ | CH₃ | CH₂OCH₃ | phenyl |

Likewise further compounds of the formula 1, which are not mentioned as examples, can be prepared in a similar manner known to the expert.

The compounds according to the invention can be prepared from the corresponding racemic mixtures by separating the desired compound of the formula 1 from its optical antipode of the formula 2 by techniques known to the expert. The separation can be achieved for example by crystallization of diastereomeric salts after reaction of the racemic mixture of acid free compounds of the formula 1 and of the formula 2 with a suitable, optically pure acid or by preparative chromatography using a chiral column.

The racemic mixtures of compounds of the formula 1 and of the formula 2, preferably those in which R2 is 1-4C-alkyl, for this purpose can be obtained as described for example in WO 03/014123 or by analogous reaction steps (Scheme 1). 1-Aryl-3-(imidazo[1,2-a]pyridin-7-yl)-propan-1-ones of the formula 4 can be prepared by aminomethylation of 8-hydroxyimidazo[1,2-a]pyridines of the formula 3, e. g. with Eschenmoser's salts and subsequent reaction with suitable enamines, e. g. 1-(1-aryl-vinyl)-pyrrolidines. The transformation of ketones of the formula 4 into racemic mixtures of compounds of the formula 1 and of the formula 2 can be accomplished applying a procedure similar to the one described in WO 03/014123 (reduction of the carbonyl function, e. g. with sodium borohydride, and subsequent cyclizabon of the obtained diols of the formula 5, e. g. in the presence of acids like phosphoric acid). Racemic mixtures of compounds of the formula 1 and of the formula 2 bearing for example an 6-amido-substituent can be prepared in a convenient manner starting from esters of 7H-8,9-dihydro-pyrano[2,3-c]-imidazo[1,2-a]pyridine-6-carboxylic acids of the formula 6: Cleavage of the ester function, e. g. by saponification with sodium hydroxide, furnishes the corresponding carboxylic acids of the formula 7, which are then treated with a suitable coupling reagent, e. g. TBTU, followed by addition of the coupling partner, e. g. an amine.

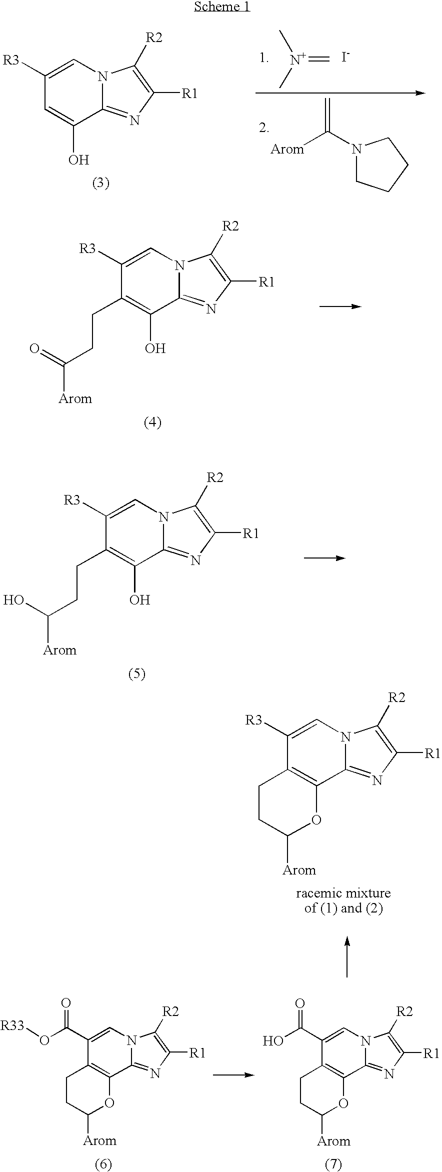

Alternatively, racemic mixtures of compounds of the formula 1 and compounds of the formula 2, preferably those in which R2 is hydrogen, halogen, 1-4C-alkyl, 2-4C-alkenyl, 2-4C-alkynyl, hydroxy-1-4C-alkyl, 3-7C-cycloalkyl or 1-4C-alkoxycarbonyl, can be prepared for example as outlined in the schemes 2, 3 and 4, which follow.

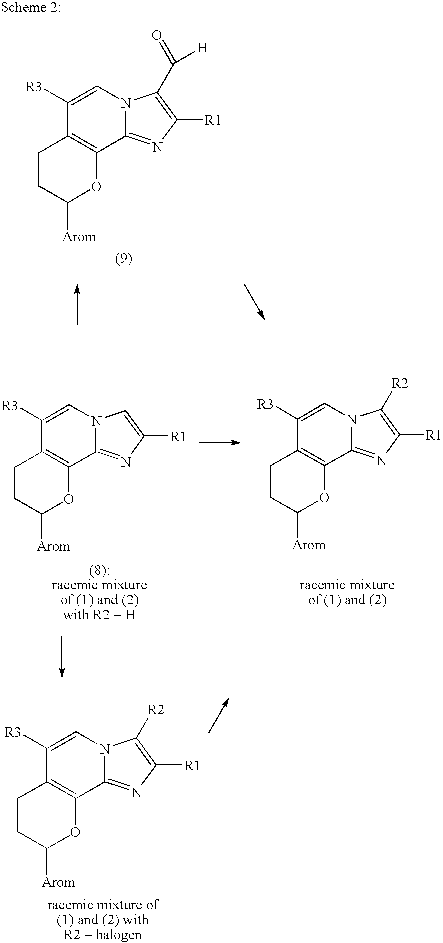

Compounds of the formula 8 can be transformed directly to a racemic mixture of compounds of the formula 1 and compounds of the formula 2, for example by electrophilic aromatic substitution.

Alternatively, compounds of the formula 8 can be first transformed, for example by a Vilsmeier formylation, to compounds of the formula 9, followed by further derivatization reactions, which are known to the expert (for example reduction of the aldehyde group, followed if desired by an etherification, or oxidation of the aldehyde group, followed by esterification, to a racemic mixture of compounds of the formula 1 and compounds of the formula 2.

Another possible access to a racemic mixture of compounds of the formula 1 and compounds of the formula 2 is, for example, offered by the transformation of a racemic mixture of compounds of the formula 1 and compounds of the formula 2 with R2=halogen, for example by C-C-bond forming reactions, like for example Heck-, Suzuki- or Sonogashira-coupling reactions. If desired, the products of these coupling reactions can be further modified, e. g. by reduction of the CC multiple bond. A racemic mixture of compounds of the formula 1 and compounds of the formula 2 with R2=halogen can be prepared from compounds of the formula 8 for example by a halogenation reaction, for example a bromination reaction using a bromination reagent, like for example N-bromosuccinimide.

Compounds of the formula 8 (R2=H)—or racemic mixtures of compounds of the formula 1 and compounds of the formula 2 in general—can be prepared for example according to the reaction sequence outlined in scheme 3.

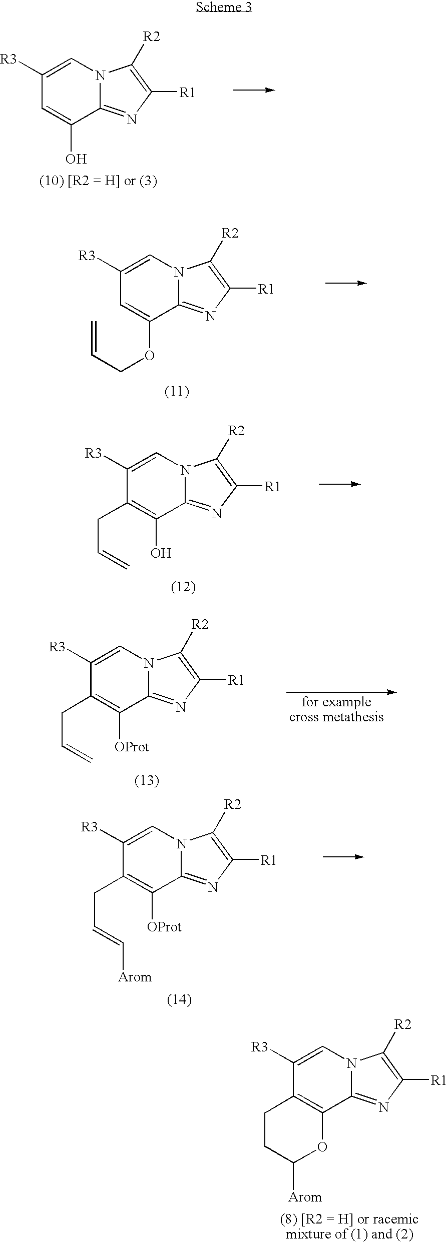

Compounds of the formula 12 can be obtained for example from compounds of the formula 3 by an O-alkylation followed by a thermally induced Claisen-rearrangement reaction of the O-alkylation product of the formula 11. Protection of the alcohol functionality in compounds of the formula 12 with a suitable protection group Prot, for example a pivaloyl group or a dimethyl-(1,1,2-trimethyl-propyl)-silanyloxy group, using standard conditions leads to compounds of the formula 13, which can be subjected in a next reaction step for example to a cross metathesis reaction, for example using a suitable Grubbs catalyst, suitable for the introduction of the Arom residue. The reaction products of the formula 14 can be deprotected and the ring closure can be performed using methods known to the expert, for example under acidic conditions, which leads to the desired compounds of the formula 8 or to racemic mixture of compounds of the formula 1 and compounds of the formula 2.

Compounds of the formula 10 can be prepared in analogy to the procedure described in WO 03/014123, for example as outlined in an exemplary manner in scheme 4.

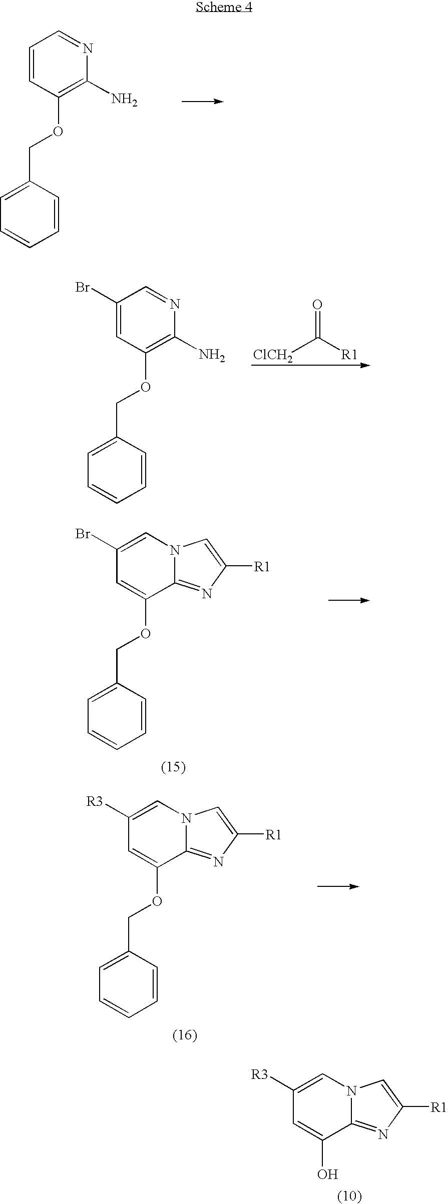

The preparation of compounds of the formula 16 from compounds of the formula 15 is carried out in a manner known per se to the person skilled in the art, for example in analogy to the reactions described in an exemplary manner in the International Patent Application WO 03/014123. Hydrogenation of compounds of the formula 16 to compounds of the formula 10 is carried out in a manner known per se to the person skilled in the art, using standard reaction conditions, like for example using hydrogen/Pd(0).

Altematively, compounds of the formula 1 can be prepared in a stereoselective way following the reaction steps as outlined generally in scheme 5. Compounds of the formula 17 can be prepared by asymmetric reduction of compounds of the formula 4. Numerous methods to perform asymmetric reduction of prochiral ketones are known (see for example E. N. Jacobsen, A. Pfaltz, Y. Yamamoto, Comprehensive Asymmetric Catalysis, Vol. I-III, Springer, Berlin, 1999) which comprise inter alia catalytic hydrogenation, catalytic transfer hydrogenation, chiral reducing agents (e. g. chiral boranes), achiral reducing agents in the presence of a chiral auxiliary or a chiral catalyst, hydrosilylation (achiral silane in combination with a chiral catalyst), and enzymatic reduction. The asymmetric catalytic hydrogenation using chiral hydrogenation catalysts of the Noyori type (RuCl₂[PP][NN]) is the preferred method for the synthesis of enantiopure diols of the formula 17. In the generic formula RuCl₂[PP][NN], PP is used as a general abbreviation for a chiral diphosphine ligand and NN is used as an abbreviation for a chiral diamine ligand. A detailed description of the method and specific examples of hydrogenation catalysts can be found for example in Angew. Chem. 2001, 113, 40-75 and in the literature cited therein. Transformation of derivatives of the formula 17 into enantiopure 7H-8,9-dihydro-pyrano[2,3c]-imidazo[1,2-a]pyridines of the formula 1 can be accomplished by methods which proceed under S_{N}2 conditions. For this purpose, the hydroxyl group in alpha-position to the Arom radical-can be transformed into a suitable leaving group LG, e. g. by esterification with acid halides or sulfonyl chlorides. For the preparation of compounds of the formula 18a, the phenolic hydoxy group can be temporarily protected. Suitable protecting groups are described for example in T. W. Greene, P. G. M. Wuts “Protective Groups in Organic Synthesis” 3^{rd} edition, J. Wiley & Sons, New York, 1999. Alternatively, the phenolic hydroxyl group in compounds of the formula 17 can be transformed into a suitable leaving group LG using for example the reagents mentioned above leading to compounds of the formula 18b. A related procedure is disclosed in the International Patent Application WO 95/27714. Enantiopure compounds of the formula 1 can be obtained, e. g. by heating of solutions of these intermediates 18a or 18b in dipolar aprotic solvents, like DMF or DMSO. The cyclization of compounds of the formula 18b can be carried out for example in the presence of a base, like e. g. sodium hydride. More conveniently, cyclization of the diols of the formula 17 can be accomplished under Mitsunobu conditions, e. g. using diisopropyl azodicarboxylate and triphenylphosphine.

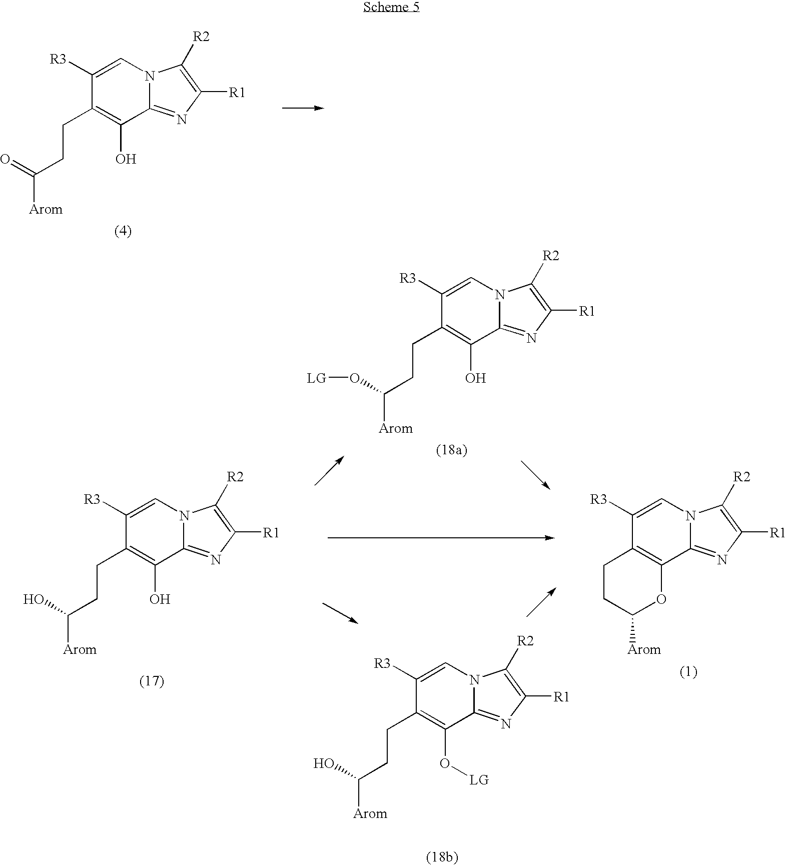

Compounds of the formula 4 are known for example from WO 03/014123, or they can be prepared in a known manner, analogously to known compounds (see for example Scheme 1). The purity of the compounds of the formula 4 has a major impact on the reaction conditions and the outcome of the asymmetric catalytic hydrogenation to compounds of the formula 17. In contrast to WO 03/014123 a further purification step is required, for example a crystallization step in the presence of a suitable organic acid, as described in an exemplary manner in the examples. A convenient method to transform compounds of the formula 4 into other compounds of the formula 4 bearing a different substituent R3 is shown in Scheme 6 and might be illustrated by the following examples: Esters of 7-(3-aryl-3-oxo-propyl)-8-hydroxy-imidazo[1,2-a]pyridine-6-carboxylates of the formula 19, wherein R33 is for example a 1-4C-alkyl radical, can be transformed into acetals of the formula 20, for example by reaction with 2,2-dimethoxypropane in the presence of acids. Cleavage of the ester function, e. g. by saponification with sodium hydroxide, furnishes the corresponding carboxylic acids of the formula 21, which are then treated with a suitable coupling reagent, e. g. TBTU, followed by addition of the coupling partner, e. g. an amine, yielding derivatives of the formula 22. Altematively, esters of the formula 20 can be reduced to the corresponding primary alcohol, e. g. using lithium aluminium hydride, and the hydroxyl group can be activated for example by conversion into a halide or a sulfonate using e. g. thionyl chloride or methanesulfonyl chloride. Interconversion of the substituent R3 can then be accomplished by nucleophilic displacement reactions using nucleophiles like e. g. alkoxides. Finally, ketones of the formula 4 are obtained by cleavage of acetals of the formula 22, e. g. in the presence of acids like hydrochloric acid.

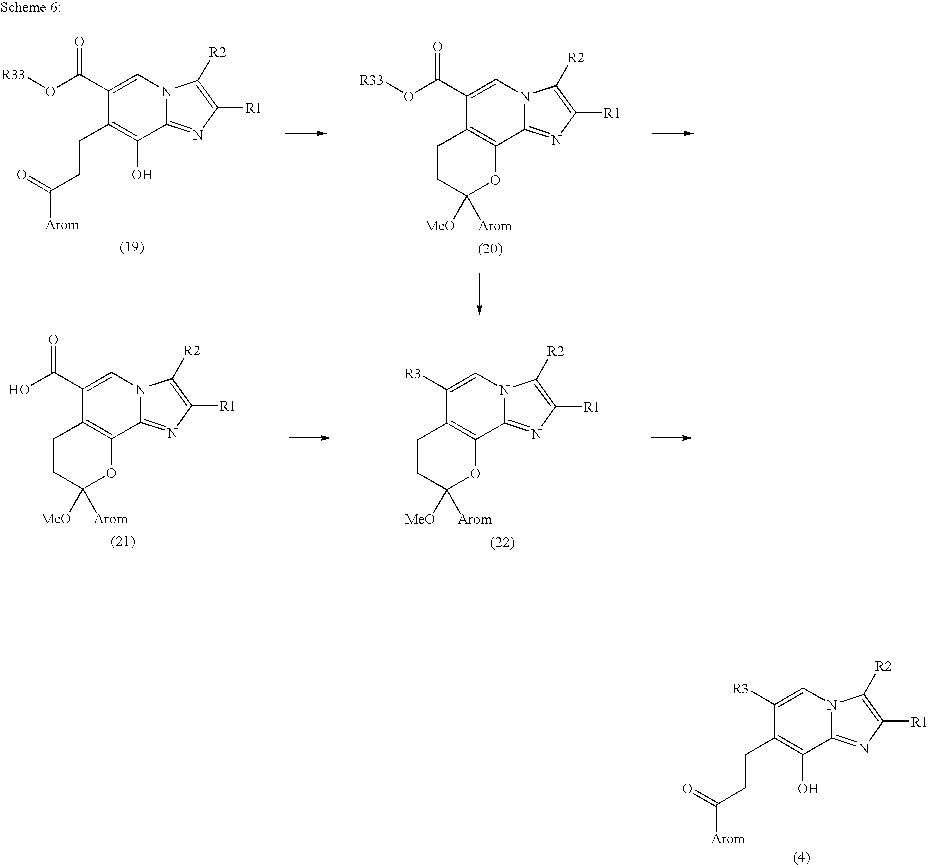

Another method suitable for asymmetric synthesis of compounds of the formula 1 is depicted in Scheme 7. Compounds of the formula 14 (see Scheme 3) can be transformed into chiral diols of the formula 17 by hydroboration of the double bond. Chiral reagents, which are suitable for this transformation, are discussed for example in Aldrichimica Acta 1987, 20(1), p2-4. An example that might be mentioned is isopinocampheylborane. Altematively, achiral hydroboration reagents can be used in combination with a chiral catalyst. The transformation of chiral diols of the formula 17 into compounds of the formula 1 is described above.

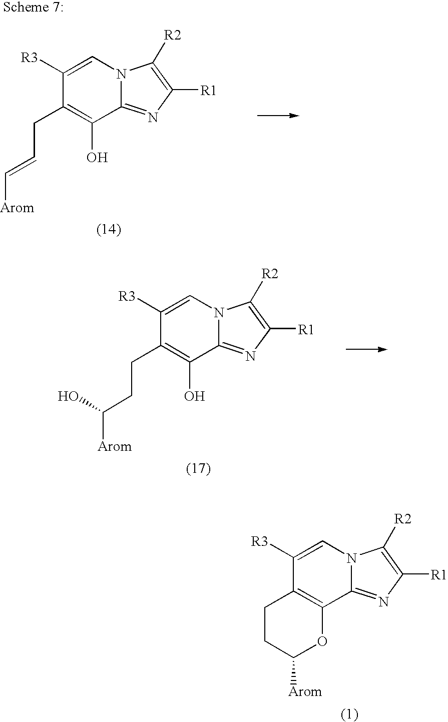

Likewise, the optical antipodes of the formula 2 can be prepared in a stereoselective manner employing the methods, which are described above and illustrated in the Schemes 5 and 7. For this purpose, the transformations have to be conducted using the corresponding enantiomer of the chiral catalyst/chiral reagent, respectively.

The derivatization, if any, of the compounds obtained according to the above Schemes 1 to 7 (e.g. conversion of a group R3 into another group R3 or conversion of a group R2 into another group R2) is likewise carried out in a manner known to the expert. For example, if compounds where R2 and/or R3=—CO-1-4C-alkoxy, or where R3=—CO—NR31R32 are desired, an appropriate derivatization can be performed in a manner known to the expert (e. g. metal catalysed carbonylation of the corresponding halo compound or conversion of an ester into an amide), for example at the stage of the compounds of formula 4, 5, 6, 8 or 19 or more conveniently at a later point in time, for example conversion of a compound of the formula 1 into another compound of the formula 1. Specific examples are given in Scheme 1 (transformation of compounds of the formula 6 into racemic mixtures of the formula 1 and the formula 2) and in Scheme 6 (transformation of ketones of the formula 19 into ketones of the formula 4).

The invention further relates to a process for the synthesis of a compound of the formula 1, which comprises converting a compound of the formula 8, in which R1, R3 and Arom have the meanings as indicated in the outset, 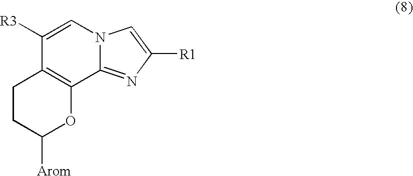
to a racemic mixture of a compound of the formula 1 and its optical antipode of the formula 2 wherein R1, R2, R3 and Arom have the meanings as indicated in the outset, 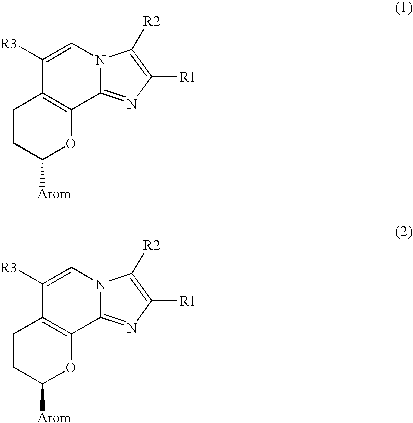
and
separation of the compound of the formula 1 from its optical antipode of the formula 2 and
if desired, further derivatization of the compound the formula 1 either on the stage of the racemic mixture of the compound of the formula 1 and its optical antipode of the formula 2 or after separation of the compound of the formula 1 from its optical antipode of the formula 2.

The invention further relates to a process for the synthesis of a compound of the formula 1, which comprises converting a compound of the formula 13, in which R1, R2 and R3 have the meanings as indicated in the outset, into a compound of the formula 14, in which R1, R2, R3 and Arom have the meanings as indicated in the outset, 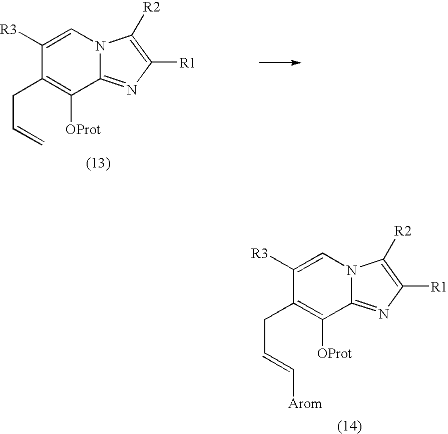
and further conversion of the compound of the formula 14 into a racemic mixture of a compound of the formula 1 and its optical antipode of the formula 2 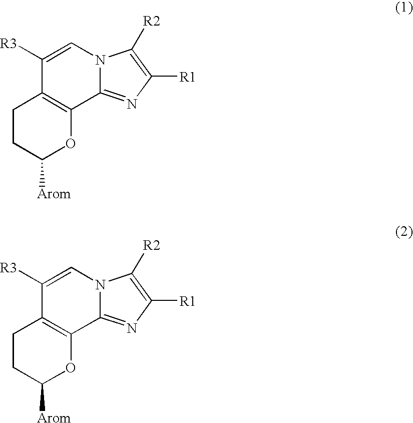
and
separation of the compound of the formula 1 from its optical antipode of the formula 2 and
if desired, further derivatization of the compound the formula 1 either on the stage of the racemic mixture of the compound of the formula 1 and its optical antipode of the formula 2 or after separation of the compound of the formula 1 from its optical antipode of the formula 2.

The invention further relates to a process for the synthesis of a compound of the formula 1 which comprises,
an asymmetric reduction of a compound of the formula 4 to a compound of the formula 17 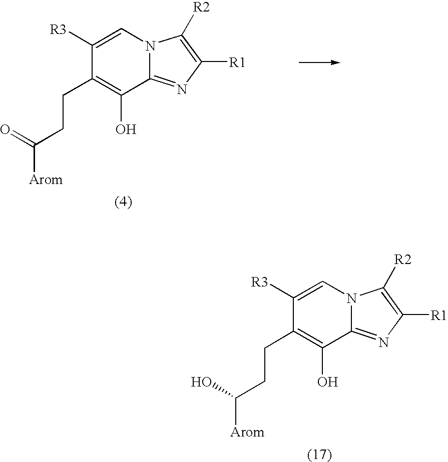
in which
R1, R2, R3 and Arom have the meanings as indicated in the outset
and conversion of a compound of the formula 17 into a compound of the formula 1 or its salts.

The invention further relates to a process for the synthesis of a compound of the formula 1, which comprises
conversion of a compound of the formula 14 to a compound of the formula 17 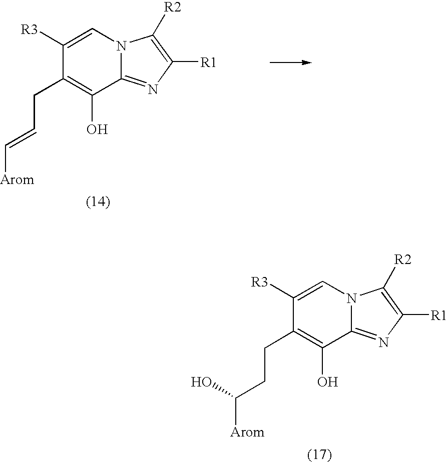
in which
R1, R2, R3 and Arom have the meanings as indicated in the outset
and conversion of a compound of the formula 17 into a compound of the formula 1 or its salts.

The examples below serve to illustrate the invention in more detail without limiting it. Further compounds of the formula 1 whose preparation is not described explicitly can likewise be prepared in an analogous manner or in a manner known per se to the person skilled in the art using customary process techniques. The abbreviation ee stands for enantiomeric excess, RT for retention time, S/C for substrate to catalyst ratio, v for volume. For the assignment of NMR signals, the following abbreviations are used: s (singlet), d (duplet), t (triplet), q (quartet), m_{c} (multiplet centred), b (broad). The following units are used: ml (millilitre), l (litre), nm (nanometer), mm (millimeter), mg (milligramme), g (gramme), mmol (millimol), N (normal), M (molar), min (minute), MHz (megahertz).

Furthermore the following abbreviations are used for the chemical substances indicated:
(S)-BINAP (S)-2,2′-bis-(diphenylphosphino)-1,1′-binaphthyl
(R)-BINAP (R)-2,2′-bis-(diphenylphosphino)-1,1′-binaphthyl
(S)-DAIPEN (2S)-(+)-1,1-bis(4-methoxyphenyl)-3-methyl-1,2-butanediamine
(R)-DAIPEN (2R)-(−)-1,1-bis(4-methoxyphenyl)-3-methyl-1,2-butanediamine
(S,S)-DPEN (1S,2S)-(−)-1,2-diphenylethylene diamine
(S)-(+)-MTPACI (S)-(+)-a-methoxy-a-(trfluormethyl)phenylacetyl chloride
DIAD diisopropyl azodicarboxylate
DMSO dimethylsulfoxide
THF tetrahydrofuran
DMF dimethylformamide
TBTU O-Benzotriazol-1-yl-N,N,N′,N′-tetramethyluronium tetrafluoroborate

The optical purity of the compounds of the formulae 1, 2, and 17 was determined by capillary electrophoresis (CE) and/or high pressure liquid chromatography (HPLC). The experimental conditions for the separation of the enantiomers by HPLC are given for each example in the experimental section.

The separation by CE was performed using one of the following experimental set-ups:
Instrument: Agilent CE-3D
Capillary: Method A: 64.5 cm×50 μm, bubble-cell (Agilent)
   Method B: 64.5 cm×75 μm, bubble-cell (Agilent)
   Buffer: Both methods: 50 mM sodium phosphate, pH 2.5 (Agilent)
Chiral selector: Both methods: 40 mM heptakis(2,3,6-tri-O-methyl)-β-cyclodextrin (Cyclolab)
Voltage: Both methods: 30 kV
Temperature: Both methods: 10° C.

The number of the method employed for the corresponding analysis is given in parentheses in the experimental section.

Also, the purity of the prochiral ketones of the formula 4, which served as substrates for the asymmetric catalytic hydrogenation reaction, was assessed by HPLC. The following experimental procedure was employed:

Column: 150×4.6 mm XTerra RP 18 5 μm; mobile phase: 0.01 M KH₂PO₄ (pH 2.0)/acetonitrile/water 90:10:0 (v/v/v) [0 min] to 15:80:5 (v/v/v) [30 min]; flow rate: 1.0 m/min; 30° C. The retention time of the title compounds (detection at 237-245 nm) is given for each example in the experimental section.

All of the HPLC columns used for preparative and analytical purposes are commercially available:
CHIRALPAK® AD, CHIRALPAK® AD-H, CHIRALPAK® AS-V, CHIRALPAK® AS-H, CHIRALPAK® 50801, CHIRALCEL® OJ, CHIRALCEL® OD-H: DAICEL Chemical Industries Ltd, Tokyo or Chiral Technologies-Europe SARL, likirch, France
Lichrochart® 240 ChiraDex®: Merck KgaA, Darmstadt, Germany
XTerra RP 18: Waters Corporate, Milford, Mass., USA.

If melting points were determined after crystallization of the compound, the solvent/solvent mixture that had been used for the purification is given in parentheses. If NMR (nuclear magnetic resonance) chemical shifts are given without integration, overlay of the signal of the corresponding proton of the compound with signals of the solvent, water, or impurities was observed.

### I. COMPOUNDS OF THE FORMULA 1

### Compounds of the Formula 1 Obtained by Separation of Racemic Mixtures of 7H-8,9-dihydro-pyrano[2,3-c]-imidazo[1,2-a]pyridines

1. (9S)-2,3-Dimethyl-9-phenyl-7H8,9dihydro-pyrano[2,3-c]-imidazo[1,2-a]pyridine-6-carboxylic acid dimethylamide (R,R)-tartrate

By application of heat, racemic 2,3-dimethyl-9-phenyl-7H-8,9-dihydro-pyrano[2,3-c]-imidazo[1,2-a]pyridine-6-carboxylic acid dimethylamide (synthesis described in WO 03/014123, 840 mg, 2.40 mmol) and L-(+)-tartaric acid (358 mg, 2.39 mmol) were dissolved in isopropanol (5 ml) and water (5 ml). The mixture was allowed to crystallize for 2 days at room temperature. The precipitate formed (700 mg) was isolated and the enanbomeric excess was determined by chiral HPLC analysis (cf. below, 21% ee). Recrystallization of the solid from a mixture of isopropanol and water [1:1 (v/v), 14 ml] afforded three crops of crystals: first crop: 30 mg, 73% ee; second crop: 120 mg, 67% ee; third crop: yield and ee not determined. The first two crops were combined and recrystallized from isopropanol/water [1:1 (v/v), 3 ml]. An ee value of 88% was determined for the isolated salt (60 mg). This sample was again crystallized from isopropanol/water [1:1 (v/v), 2 ml] yielding a pure sample of the title compound (4 mg, 0.3% yield, 95% ee). The third crop of the crystallization mentioned above was added to the mother liquor and another 23 mg of the title compound (91% ee) were isolated by crystallization. Recrystallization of this sample from isopropanol/water [1:1 (v/v), 0.4 ml] afforded the title compound with 96% ee (10 mg, 0.8% yield).

The enantiomeric excess was determined by HPLC analysis employing the following conditions: column: Chiralcel OJ; eluant: heptane/ethanol/diethylamine=90:10:0.2 (v/v/v); flow rate: 1.0 ml/min; temperature: 40° C. The (9R)-enantiomer showed a retention time of 15.5 min, the (9S)-enantiomer (title compound) was eluted after 18.4 min.

¹H-NMR (dmso-d₆, 400 MHz): d=2.12 (m,_{c}, 1H), 2.25 (s, bs, 4H), 2.34 (s, 3H), 2.49 (bs), 2.75 (m_{c}, 1H), 2.86, 3.00 (2s, 6H), 4.24 (s, 2H), 5.26 (d, 1H), 7.40 (m_{c}, 5H), 7.80 (s, 1H).

2. (9S)-2,3-Dimethyl-9-phenyl-7H-8,9-dihydro-pyrano[2,3c]-imidazo[1,2-a]pyridine-6-carboxylic acid dimethylamide

Resolution of racemic 2,3-dimethyl-9-phenyl-7H-8,9-dihydro-pyrano[2,3-c]-imidazo[1,2-a]pyridine-6-carboxylic acid dimethylamide (synthesis described in WO 03/014123, 3.00 g, 8.6 mmol) was achieved by preparative chromatography using a 250×110 mm CHIRALPAK® AD 20 μm column. The mobile phase consisted of a mixture of ethanol, methanol, and diethylamine [50:50:0.1 (v/v/v)]. The separation was performed at room temperature with a flow rate of 500 ml/min. The products were detected at a wavelength of 300 nm. The second-eluting enantiomer was identified as the title compound ((9S)-enantiomer) (1.38 g, 46% yield, 98.7% ee).

Melting point: 254° C.

The set-up of the analytical method for the HPLC determination of the optical purity was as follows: column: combination of 250×4.6 mm CHIRALPAK® AD and 250×4.6 mm CHIRALPAK® AD-H; mobile phase: ethanol, methanol, diethylamine [50:50:0.1 (v/v/v)]; flow rate: 1 ml/min; room temperature.

The title compound (detection at 240 nm) was eluted after 9.0 min.

Optical rotation: [a]^{D}₂₀=−53° (c=0.63, dichloromethane).

¹H-NMR (200 MHz, dmso-d₆): δ=2.14 (m_{c}, 2H), 2.26, 2.35 (2s, 6H), 2.42 (m_{c}), 2.75 (m_{c}, 1H), 2.87, 3.01 (2s, 6H), 5.27 (dd, 1H), 7.43 (m_{c}, 5H), 7.79 (s, 1H).

3. (9S)-3-Hydroxymethyl-2-methyl-9-phenyl-7H-8,9-dihydro-pyrano[2,3-c]-imidazo[1,2-a]pyridine-6-carboxylic acid dimethylamide

Resolution of racemic 3-hydroxymethyl-2-methyl-9-phenyl-7H-8,9-dihydro-pyrano[2,3-c]-imidazo[1,2-a]pyridine-6-carboxylic acid dimethylamide (example xii, 194 mg, 0.53 mmol) was achieved by preparative chromatography using a 250×20 mm CHIRALPAK® AD 10 μm column. The mobile phase consisted of a mixture of n-heptane and ethanol [9:1 (v/v)]. The separation was performed at room temperature with a flow rate of 20 ml/min. The products were detected at a wavelength of 330 nm. The second-eluting enantiomer was identified as the title compound ((9S)-enantiomer) (90 mg, 46% yield, 98.5-98.9% ee).

Melting point: 178-181° C.

The set-up of the analytical method for the HPLC determination of the optical purity was as follows: column: 250×4.6 mm CHIRALPAK® AD 10 μm; mobile phase: n-heptane/ethanol [9:1 (v/v)]; flow rate: 2 ml/min; 30° C. The title compound (detection at 220 nm) was eluted after 13.70 min (98.9% ee).

Determination of the optical purity by CE: RT=17.6 min/98.5% ee (A).

Optical rotation: [a]^{D}₂₀=−65° (c=56, chloroform).

¹H-NMR (dmso-d₆, 200 MHz): d=2.13 (m_{c}, 1H), 2.25, 2.30 (m_{c}, s, 4H), 2.44 (m_{c}), 2.80, 2.88 (m_{c}, s, 4H), 3.01 (s, 3H), 4.72 (bs, 2H), 5.06 (bs, 1H), 5.29 (dd, 1H), 7.42 (m_{c}, 5H), 7.89 (s, 1H).

4. (9S)-3Bromo-2-methyl-9-phenyl-7H-8,9-dihydro-pyrano[2,3-c]-imidazo[1,2-a]pyridine-6-carboxylic acid dimethylamide

Resolution of racemic 3-bromo-2-methyl-9-phenyl-7H-8,9-dihydro-pyrano[2,3-c]-imidazo[1,2-a]-pyridine-6-carboxylic acid dimethylamide (example xiii, 186 mg, 0.45 mmol) was achieved by preparative chromatography using a 250×20 mm CHIRALPAK® AD 10 μm column. The mobile phase consisted of a mixture of ethanol and methanol [1:1 (v/v)]. The separation was performed at room temperature with a flow rate of 20 ml/min. The products were detected at a wavelength of 330 nm. The second-eluting enantiomer was identified as the title compound ((9S)-enantiomer) (90 mg, 48% yield, 99.1-99.6% ee).

Melting point: 161-163° C.

The set-up of the analytical method for the HPLC determination of the optical purity was as follows: column: 250×4.6 mm CHIRALPAK® AD 10 μm; mobile phase: ethanol/methanol [1:1 (v/v)]; flow rate: 1 ml/min; 30° C. The title compound (detection at 220 nm) was eluted after 6.24 min (99.1% ee).

Determination of the optical purity by CE: RT=17.7 min/99.6% ee (A).

Optical rotation: [a]^{D}₂₀=−54° (c=0.51, chloroform).

¹H-NMR (dmso-d₆, 200 MHz): d=2.16 (m_{c}, 1H), 2.25, 2.31 (m_{c}, s, 4H), 2.50 (m_{c}), 2.80, 2.87 (m_{c}, s, 4H), 3.02 (s, 3H), 5.31 (dd, 1H), 7.43 (m_{c}, 5H), 7.82 (m_{c}, 1H).

Elemental analysis: calculated for C₂₀H₂₀BrN₃O₂ (414.31): C 57.98, H 4.87, N 10.14, Br 19.29; found: C 57.21, H 4.92, N 9.90, Br 18.49.

5. (9S)-3-Ethyl-2-methyl-9-phenyl-7H-8,9-dihydro-pyrano[2,3c]-imidazo[1,2-a]pyridine-6-carboxylic acid dimethylamide

Resolution of racemic 3-ethyl-2-methyl-9-phenyl-7H-8,9-dihydro-pyrano[2,3-c]-imidazo[1,2-a]pyridine-6-carboxylic acid dimethylamide (example xv, 188 mg, 0.52 mmol) was achieved by preparative chromatography using a 250×50 mm CHIRALPAK® 50801 20 μm column. The mobile phase consisted of ethanol. The separation was performed at room temperature with a flow rate of 120 ml/min. The products were detected at a wavelength of 250 nm. The first-eluting enantiomer was identified as the title compound ((9S)-enantiomer) (90 mg, 48% yield, 98.6-99.3% ee).

Melting point: 211-213° C.

The set-up of the analytical method for the HPLC determination of the optical purity was as follows: column: 250×4.6 mm CHIRALPAK® 50801 20 μm; mobile phase: ethanol; flow rate: 1 ml/min; 30° C.

The title compound (detection at 220 nm) was eluted after 9.06 min (99.3% ee).

Determination of the optical purity by CE: RT=18.0 min/98.6% ee (A).

Optical rotation: [a]^{D}₂₀=−82° (c=0.54, chloroform).

¹H-NMR (dmso-d₆, 200 MHz): d=1.10 (t, 3H), 2.14, 2.26 (m_{c}, s, 5H), 2.40 (m_{c}), 2.77, 2.87, 2.88 (m_{c}, q, s, 6H), 3.01 (s, 3H), 5.26 (dd, 1H), 7.42 (m_{c}, 5H), 7.88 (s, 1H).

Elemental analysis: calculated for C₂₂H₂₅N₃O₂H₂O (363.46+18): C 69.27, H 7.13, N 11.01; found: C 69.95, H 6.76, N 10.69.

6. (9S)-(2,3-Dimethyl-9-phenyl-7H-8,9-dihydro-pyrano[2,3c]-imidazo[1,2-a]pyridin-6-yl)-pyrrolidin-1-yl methanone

Resolution of racemic (2,3-dimethyl-9-phenyl-7H-8,9-dihydro-pyrano[2,3-c]-imidazo[1,2-a]pyridin-6-yl)-pyrrolidin-1-yl methanone (example xxv, 198 mg, 0.53 mmol) was achieved by preparative chromatography using a 250×50 mm CHIRALPAK® 50801 20 μm column. The mobile phase consisted of ethanol. The separation was performed at room temperature with a flow rate of 120 m/min. The products were detected at a wavelength of 250 nm. The first-eluting enantiomer was identified as the title compound ((9S)-enantiomer) (90 mg, 45% yield, 98.1-98.8% ee).

Melting point: 269-271° C.

The set-up of the analytical method for the HPLC determination of the optical purity was as follows: column: 250×4.6 mm CHIRALPAK® 50801 20 μm; mobile phase: ethanol; flow rate: 1 ml/min; 30° C.

The title compound (detection at 220 nm) was eluted after 11.93 min (98.1% ee).

Determination of the optical purity by CE: RT=18.8 min/98.8% ee (A).

Optical rotation: [a]^{D}₂₀=−60° (c=0.55, chloroform).

¹H-NMR (dmso-d₆, 200 MHz): δ=1.85 (m_{c}, 4H), 2.14, 2.25, 2.35 (m_{c}, 2s, 8H), 2.56 (m_{c}), 2.81 (m_{c}, 1H), 3.24 (m_{c}), 3.48 (t, 2H), 5.26 (dd, 1H), 7.42 (m_{c}, 5H), 7.84 (s, 1H).

Elemental analysis: calculated for C₂₃H₂₅N₃O₂H₂O (375.47+18): C 70.21, H 6.92, N 10.68; found: C 71.10, H 6.55, N 10.51.

7. (9S)-2,3-Dimethyl-9-phenyl-7H-8,9-dihydro-pyrano[2,3-c]-imidazo[1,2-a]pyridine-6-carboxylic acid methylamide

Resolution of racemic 2,3-dimethyl-9-phenyl-7H-8,9-dihydro-pyrano[2,3-c]-imidazo[1,2-a]pyridine-6-carboxylic acid methylamide (example xxvi, 196 mg, 0.58 mmol) was achieved by preparative chromatography using a 250×110 mm CHIRALPAK® ASV 20 μm column. The mobile phase consisted of a mixture of acetonitrile and dimethylamine [100:0.1 (v/v)]. The separation was performed at room temperature with a flow rate of 520 ml/min. The products were detected at a wavelength of 300 nm. The first-eluting enantomer was identified as the title compound ((9S)-enantiomer) (85 mg, 43% yield, 98.7-100% ee).

Melting point: 253° C.

The set-up of the analytical method for the HPLC determination of the optical purity was as follows: column: 250×4.6 mm CHIRALPAK® ASH; mobile phase: acetonitrile/dimethylamine [100:0.1 (v/v)]; flow rate: 0.7 ml/min; 25° C. The title compound (detection at 220 nm) was eluted after 5.34 min (98.7% ee).

Determination of the optical purity by CE: RT=18.5 min/100.0% ee (A).

Optical rotation: [a]^{D}₂₀=−56° (c=0.53, chloroform).

¹H-NMR (dmso-d₆, 200 MHz): δ=2.09 (m_{c}, s), 2.26 (m_{c}, s, 4H), 2.37 (s, 3H), 2.78 (m, d, 4H), 3.00 (m_{c}, 1H), 5.24 (dd, 1H), 7.41 (m_{c}, 5H), 7.92 (s, 1H), 8.32 (q, 1H).

8. (9S)-2,3-Dimethyl-9-phenyl-7H-8,9-dihydro-pyrano[2,3c]-imidazo[1,2-a]pyridine-6-carboxylic acid amide

Resolution of racemic 2,3-dimethyl-9-phenyl-7H-8,9-dihydro-pyrano[2,3-c]-imidazo[1,2-a]pyridine-6-carboxylic acid amide (example xxvii, 189 mg, 0.59 mmol) was achieved by preparative chromatography using a 250×110 mm CHIRALPAK® AD 20 μm column. The mobile phase consisted of a mixture of n-heptane and ethanol [1:1 (v/v)]. The separation was performed at room temperature with a flow rate of 520 ml/min. The products were detected at a wavelength of 300 nm. The second-eluting enantiomer was identified as the title compound ((9S)-enantiomer) (85 mg, 45% yield, 98.2-98.6% ee).

Melting point: 349-350° C.

The set-up of the analytical method for the HPLC determination of the optical purity was as follows: column: 250×4.6 mm CHIRALPAK® AD 10 μm; mobile phase: n-heptane/ethanol [7:3(v/v)]; flow rate: 1.0 ml/min; 25° C. The title compound (detection at 220 nm) was eluted after 6.38 min (98.2% ee).

Determination of the optical purity by CE: RT=18.8 min/98.6% ee (A).

¹H-NMR (dmso-d₆, 200 MHz): δ=2.09 (m_{c}, 1H), 2.26 (m_{c}, s, 4H), 2.38 (s, 3H), 2.97 (m_{c}, 2H), 5.24 (dd, 1H), 7.41 (bs, m_{c}, 6H), 7.85 (bs, 1H), 7.98 (s, 1H).

9. (9S)-2,3-Dimethyl-9-(2-methylphenyl)-7H-8,9-dihydro-pyrano[2,3-c]-imidazo[1,2-a]pyridine-6-carboxylic acid dimethylamide

Resolution of racemic 2,3-dimethyl-9-(2-methylphenyl)-7H-8,9-dihydro-pyrano[2,3-c]-imidazo[1,2-a]pyridine-6-carboxylic acid dimethylamide (example xxix, 208 mg, 0.57 mmol) was achieved by preparative chromatography using a 250×20 mm CHIRALPAK® AD-H 5 μm column. The mobile phase consisted of a mixture of n-heptane and ethanol [85:15 (v/v)]. The separation was performed at room temperature with a flow rate of 20 ml/min. The products were detected at a wavelength of 300 nm. The second-eluting enantiomer was identified as the title compound ((9S)-enantiomer) (100 mg of a foamy solid, 48% yield, >99.5% ee).

The set-up of the analytical method for the HPLC determination of the optical purity was as follows: column: 250×4.6 mm CHIRALPAK® AD 10 μm; mobile phase: n-heptane/ethanol [85:15 (v/v)]; flow rate: 1.0 ml/min; 25° C. The title compound (detection at 220 nm) was eluted after 15.96 min (>99.5% ee).

Optical rotation: [a]^{D}₂₀=−49° (c=0.45, chloroform).

¹H-NMR (dmso-d₆, 200 MHz): δ=2.05 (m_{c}, 1H), 2.25 (m_{c}, s, 4H), 2.35, 2.39 (2s, 6H), 2.56 (m_{c}), 2.86, 2.91 (m_{c}, s, 4H), 3.02 (s, 3H), 5.37 (dd, 1H), 7.28 (m_{c}, 3H), 7.47 (m_{c}, 1H), 7.79 (s, 1H).

10. (9S)-9-(2-Fluorophenyl)-2,3-dimethyl-7H-8,9-dihydro-pyrano[2,3-c]-imidazo[1,2-a]pyridine-6-carboxylic acid dimethylamide

Resolution of racemic 9-(2-fluorophenyl)-2,3-dimethyl-7H-8,9-dihydro-pyrano[2,3-c]-imidazo[1,2-a]pyridine-6-carboxylic acid dimethylamide (example xxxi, 247 mg, 0.67 mmol) was achieved by preparative chromatography using a 250×20 mm CHIRALPAK® AD-H 5 μm column. The mobile phase consisted of a mixture of n-heptane and ethanol [85:15 (v/v)]. The separation was performed at room temperature with a flow rate of 20 ml/min. The products were detected at a wavelength of 300 nm. The second-eluting enantiomer was identified as the title compound ((9S)-enantiomer) (116 mg, 47% yield, >99.5% ee).

Melting point: 210° C.

The set-up of the analytical method for the HPLC determination of the optical purity was as follows: column: 250×4.6 mm CHIRALPAK® AD 10 μm; mobile phase: n-heptane/ethanol [85:15 (v/v)]; flow rate: 1.5 ml/min; 25° C. The title compound (detection at 220 nm) was eluted after 11.22 min (>99.5% ee).

Determination of the optical purity by CE: RT=14.5 min/99.8% ee (B).

Optical rotation: [a]^{D}₂₀=−84° (c=0.47, chloroform).

¹H-NMR (dmso-d₆, 200 MHz): δ=2.24, 2.25 (m_{c}, s, 5H), 2.35 (s, 3H), 2.54 (m_{c}), 2.84, 2.90 (m_{c}, s, 4H), 3.02 (s, 3H), 5.48 (dd, 1H), 7.29 (m_{c}, 2H), 7.44 (m_{c}, 1H), 7.58 (m_{c}, 1H), 7.81 (s, 1H).

11. (9S)-9-(4-Fluorophenyl)-2,3-dimethyl-7H-8,9-dihydro-pyrano[2,3-c]-imidazo[1,2-a]pyridine-6-carboxylic acid dimethylamide

Resolution of racemic 9-(4-fluorophenyl)-2,3-dimethyl-7H-8,9-dihydro-pyrano[2,3-c]-imidazo[1,2-a]pyridine-6-carboxylic acid dimethylamide (example xxxiii, 210 mg, 0.57 mmol) was achieved by preparative chromatography using a 250×20 mm CHIRALPAK® AD-H 5 μm column. The mobile phase consisted of a mixture of n-heptane and ethanol [85:15 (v/v)]. The separation was performed at room temperature with a flow rate of 20 ml/min. The products were detected at a wavelength of 300 nm. The second-eluting enantiomer was identified as the title compound ((9S)-enantiomer) (105 mg, 50% yield, >99.5% ee).

Melting point: 255° C.

The set-up of the analytical method for the HPLC determination of the optical purity was as follows: column: 250×4.6 mm CHIRALPAK® AD 10 μm; mobile phase: n-heptane/ethanol [85:15 (v/v)]; flow rate: 1.5 ml/min; 35° C. The title compound (detection at 220 nm) was eluted after 18.79 min (>99.5% ee).

Determination of the optical purity by CE: RT=14.8 min/99.8% ee (B).

Optical rotation: [a]^{D}₂₀=−72° (c=0.47, chloroform).

¹H-NMR (dmso-d₆, 200 MHz): δ=2.16, 2.25 (m_{c}, s, 5H), 2.35 (s, 3H), 2.48 (m_{c}), 2.79, 2.88 (m_{c}, s, 4H), 3.01 (s, 3H), 5.27 (dd, 1H), 7.26 (m_{c}, 2H), 7.54 (m_{c}, 2H), 7.79 (s, 1H).

12. (9S)-2,3-Dimethyl-9-thiophen-2-yl-7H-8,9-dihydro-pyrano[2,3-c]-imidazo[1,2-a]pyridine-6-carboxylic acid dimethylamide

The title compound can be obtained by resolution of racemic 2,3-dimethyl-9-thiophen-2-yl-7H-8,9-dihydro-pyrano[2,3-c]-imidazo[1,2-a]pyridine-6-carboxylic acid dimethylamide (example xxxv) in analogy to the examples described above.

Melting point: 237-238° C. (acetone/diethyl ether)

Determination of the optical purity by CE: RT [(9R)-enantiomer]=15.7 min/8.0 area-%; RT [(9S)-enantiomer]=16.1 min/92.0 area-%; 84.0% ee (A).

Optical rotation: [a]^{D}₂₀=−18° (c=0.61, chloroform).

¹H-NMR (dmso-d₆, 200 MHz): d=2.25, 2.26, 2.34 (s, m_{c}, s, 8H), 2.53 (m_{c}), 2.73, 2.87 (m_{c}, s, 4H), 3.01 (s, 3H), 5.56 (dd, 1H), 7.08 (dd, 1H), 7.23 (bd, 1H), 7.57 (dd, 1H), 7.79 (s, 1H).

13. (9S)-6-Methoxymethyl-2,3-dimethyl-9-phenyl-7H-8,9-dihydro-pyrano[2,3-c]-imidazo[1,2-a]pyridine

The title compound can be obtained by resolution of racemic 6-methoxymethyl-2,3-dimethyl-9-phenyl-7H-8,9-dihydro-pyrano[2,3-c]-imidazo[1,2-a]pyridine in analogy to the examples described above. The corresponding racemate can be prepared by reduction of 3-(8-Hydroxy-6-methoxymethyl-2,3-dimethyl-imidazo[1,2-a]pyridin-7-yl)-1-phenyl-propan-1-one (example li) with sodium borohydride and subsequent cyclization of 7-(3-Hydroxy-3-phenyl-propyl)-6-methoxymethyl-2,3-dimethyl-imidazo[1,2-a]pyridin-8-ol using one of the methods described below.

Melting point: 146-148° C. (diethyl ether)

The set-up of the analytical method for the HPLC determination of the optical purity was as follows: column: 250×4.6 mm CHIRALPAK® AD-H 5 μm; mobile phase: isopropanol/n-hexane=1:9 (v/v) with 0.1% of diethylamine; flow rate: 1 ml/min; 35° C., detection at 237 nm. The (9R)-enantiomer (0.7 area-%) was eluted after 12.9 min, the title compound was eluted after 19.3 min (99.3 area-%). Optical purity: 98.6% ee.

Optical rotation: [a]^{D}₂₀=−98° (c=0.61, chloroform).

¹H-NMR (dmso-d₆, 200 MHz): d=2.15, 2.25, 2.35 (m_{c}, 2s, 8H), 2.83 (m_{c}, 2H), 3.30 (s), 4.42 (s, 2H), 5.20 (dd, 1H), 7.43 (m_{c}, 5H), 7.76 (s, 1H).

### Compounds of the Formula 1 Obtained by Asymmetric Synthesis

14. (9S)-2,3-Dimethyl-9-phenyl-7H-8,9-dihydro-pyrano[2,3c]-imidazo[1,2-a]pyriding-6-carboxylic acid dimethylamide

In a flame-dried flask filled with argon, (3R)-8-hydroxy-7-(3-hydroxy-3-phenyl-propyl)-2,3-dimethyl-imidazo[1,2-a]pyridine-6-carboxylic acid dimethylamide (example liii, 9.10 g, 24.8 mmol, 85.9% ee) was suspended in dry THF (330 ml). After addition of triphenylphosphine (19.50 g, 74.3 mmol) and dropwise addition of DIAD (15.20 g, 75.1 mmol) a dark-green solution was obtained, which was stirred for 80 minutes at room temperature. The reaction mixture was concentrated under reduced pressure and the residue (50 g of a green oil) was purified by flash chromatography [250 g of silica gel, eluant: ethyl acetate, then ethyl acetate/methanol=20:1 (v/v)]. A colourless solid (6.5 g) was obtained which was suspended in diethyl ether (30 ml). The precipitate was isolated by filtration, washed with diethyl ether (20 ml), and dried in vacuo yielding 5.0 g of the title compound (58% yield, optical purity: 85.2-85.4% ee).

Melting point: 258-260° C. (diethyl ether)

The set-up of the analytical method for the HPLC determination of the optical purity was as follows: column: 250×4.6 mm CHIRALPAK® AD-H 5 μm; mobile phase: ethanol/methanol=1:1 (v/v) with 0.1% of diethylamine; flow rate: 1 ml/min; 35° C., detection at 243 nm. The (9R)-enantiomer (7.3 area-%) was eluted after 4.0 min, the title compound was eluted after 4.4 min (92.7 area-%). Optical purity: 85.4% ee.

Determination of the optical purity by CE: RT [(9S)-enantiomer]=19.5 min/92.6 area-%; RT [(9R)-enantiomer]=20.3 min/7.4 area-%; 85.2% ee (A).

The optical purity of the title compound can be increased by crystallization in the presence of L-(+)-tartaric acid: (9S)-2,3-Dimethyl-9-phenyl-7H-8,9-dihydro-pyrano[2,3-c]-imidazo[1,2-a]pyridin-6-carboxylic acid dimethylamide (0.88 g, 2.5 mmol, 85% ee) and L-(+)-tartaric acid (0.37 g, 2.5 mmol) were dissolved in a hot mixture of isopropanol (5 ml) and water (5 ml). A crystalline solid (950 mg) was formed, which was removed by filtration, analysed by HPLC (91.5% ee), and recrystallized from a mixture of isopropanol (8 ml) and water (8 ml). This afforded approximately 500 mg of the salt of the title compound with L-(+)-tartaric acid with an optical purity of 96% ee, which again was dissolved in a mixture of isopropanol (4 ml) and water (4 ml). Crystals of the salt of the title compound with L-(+)-tartaric acid were formed, which were isolated by filtration (approximately 150 mg, 12% yield). The optical purity was determined by HPLC (>99% ee).

In another experiment, the title compound (0.50 g, 1.4 mmol, 85% ee) was crystallized from a mixture of ethanol (4 ml) and water (15 ml) in the presence of L-(+)-tartaric acid (0.21 g, 1.5 mmol). This afforded approximately 200 mg of the salt of the title compound with L-(+)-tartaric acid (29% yield) with an optical purity of 96% ee.

The enantiomeric excess was determined by HPLC analysis employing the following conditions: column: Chiralcel OJ; eluant: heptane/ethanol/diethylamine=90:10:0.2 (v/v/v); flow rate: 1.0 ml/min; temperature: 40° C. The (9R)-enantiomer showed a retention time of 15.5 min, the (9S)-enantiomer (title compound) was eluted after 18.4 min.

¹H-NMR (dmso-d₆, 400 MHz): d=2.12 (m_{c}, 1H), 2.25 (s, bs, 4H), 2.34 (s, 3H), 2.49 (bs), 2.75 (m_{c}, 1H), 2.86, 3.00 (2s, 6H), 4.24 (s, 2H), 5.26 (d, 1H), 7.40 (m_{c}, 5H), 7.80 (s, 1H).

15. (9S)-(2,3-Dimethyl-9-phenyl-7H-8,9-dihydro-pyrano[2,3c]-imidazo[1,2-a]pyridin-6-yl)-pyrrolidin-1-yl methanone

In a flame-dried flask filled with argon, (3R)-[8-hydroxy-7-(3-hydroxy-3-phenyl-propyl)-2,3-dimethyl-imidazo[1,2-a]pyridin-6-yl]-pyrrolidin-1-yl methanone (example liv, 750 mg, 1.90 mmol, 87.4% ee) was dissolved in dry THF (20 ml). Triphenylphosphine (1.50 g, 5.7 mmol) was added and the suspension was stirred for 10 minutes at room temperature. After dropwise addition of DIAD (1.20 g, 5.9 mmol) a yellow solution was obtained, which was stirred for 1 hour at room temperature. The reaction mixture was concentrated under reduced pressure and the residue (5 g) was purified by flash chromatography [80 g of silica gel, eluant: ethyl acetate). A colourless solid (410 mg) was obtained which was suspended in diethyl ether (5 ml). The precipitate was isolated by filtration, washed with diethyl ether (3 ml), and dried in vacuo yielding 360 mg of the title compound (50% yield, optical purity: 87.1-87.5% ee).

Melting point: 268-270° C. (diethyl ether)

The set-up of the analytical method for the HPLC determination of the optical purity was as follows: column: 250×4.6 mm CHIRALPAK® OD-H 5 μm; mobile phase: n-hexane/isopropanol=9:1 (v/v), flow rate: 1 ml/min; 35° C., detection at 220 and 240 nm. The (9R)-enantiomer (6.3/6.3 area-%) was eluted after 35.5 min, the title compound was eluted after 43.1 min (93.6/93.7 area-%). Optical purity: 87.4-87.5% ee.

Determination of the optical purity by CE: RT [(9S)-enantiomer]=19.7 min/93.6 area-%; RT [(9R)-enantomer]=20.4 min/6.4 area-%; 87.2% ee (A).

¹H-NMR (dmso-d₆, 200 MHz): d=1.85 (m_{c}, 4H), 2.13 (m_{c}, 1H), 2.25 (s, m_{c}, 4H), 2.35 (s, 3H), 2.50 (m_{c}), 2.81 (m_{c}, 1H), 3.26 (m, 2H), 3.48 (t, 2H), 5.25 (dd, 1H), 7.42 (m_{c}, 5H), 7.84 (s, 1H).

16. (9S)-2,3-Dimethyl-9-phenyl-7H-8,9-dihydro-pyrano[2,3-c]-imidazo[1,2-a]pyridine-6-carboxylic acid methylamide

In a flame-dried flask filled with argon, (3R)-8-hydroxy-7-(3-hydroxy-3-phenyl-propyl)-2,3-dimethylimidazo[1,2-a]pyridine-6-carboxylic acid methylamide (example lv, 900 mg, 2.55 mmol, 92.0% ee) was suspended in dry THF (55 ml). After addition of triphenylphosphine (2.00 g, 7.6 mmol) and dropwise addition of DIAD (1.55 g, 7.6 mmol) a brown solution was obtained, which was stirred for 1 hour at room temperature. The reaction mixture was concentrated under reduced pressure and the residue (6 g) was purified by flash chromatography [150 g of silica gel, eluant: dichloromethane/methanol=100:1 (v/v)]. A colourless solid was obtained which was suspended in diethyl ether. The precipitate was isolated by filtration and dried in vacuo yielding 120 mg of the title compound (14% yield, optical purity: 94.2% ee).

Melting point: 261-263° C. (diethyl ether)

The set-up of the analytical method for the HPLC determination of the optical purity was as follows: column: 250×4.6 mm CHIRALPAK® AD-H 5 μm; mobile phase: ethanol/methanol=1:1 (v/v) with 0.1% of diethylamine; flow rate: 0.8 ml/min; 35° C., detection at 245 nm. The (9R)-enantiomer (2.9 area-%) was eluted after 4.1 min, the title compound was eluted after 4.4 min (97.1 area-%). Optical purity: 94.2% ee.

Determination of the optical purity by CE: RT [(9S)-enantiomer]=18.6 min/97.1 area-%; RT [(9R)-enantiomer]=19.9 min/2.9 area-%; 94.2% ee (A).

¹H-NMR (dmso-d₆, 200 MHz): d=2.07 (m_{c}, 1H), 2.26 (s, m_{c}, 4H), 2.37 (s, 3H), 2.74, 2.77.(m_{c}, d, 4H), 3.00 (m_{c}, 1H), 5.24 (dd, 1H), 7.42 (m_{c}, 5H), 7.91 (s, 1H), 8.32 (bq, 1H).

### II. COMPOUNDS OF THE FORMULA 2

### Compounds of the Formula 2 Obtained by Separation of Racemic Mixtures of 7H-8,9-dihydro-pyrano[2,3-c]-imidazo[1,2-a]pyridines

A. (9R)2,3-Dimethyl-9-phenyl-7H-8,9-dihydro-pyrano[2,3-c]-imidazo[1,2-a]pyridine-6-carboxylic acid dimethylamide (S,S)-tartrate

By application of heat, racemic 2,3-dimethyl-9-phenyl-7H-8,9-dihydro-pyrano[2,3-c]-imidazo[1,2-a]pyridine-6-carboxylic acid dimethylamide (synthesis described in WO 03/014123, 840 mg, 2.40 mmol) and L-(+)-tartaric acid (358 mg, 2.39 mmol) were dissolved in isopropanol (5 ml) and water (5 ml). The mixture was allowed to crystallize for 2 days at room temperature. After removal of the precipitate, the mother liquor was concentrated, treated with 1 N NaOH (40 ml), and extracted with a mixture of ethyl acetate/methanol [95:5 (v/v), 3×150 ml]. The combined organic phases were washed with brine (75 ml), dried over sodium sulfate and concentrated under reduced pressure. Thus, a sample of 2,3-dimethyl-9-phenyl-7H-8,9-dihydro-pyrano[2,3-c]-imidazo[1,2-a]pyridine-6-carboxylic acid dimethylamide containing an excess of the (9R)-enantiomer (250 mg, 31% ee) was isolated which was dissolved in isopropanol (4 ml) and water (4 ml). D-(−)-tartaric acid (107 mg, 0.71 mmol) was added and the mixture was allowed to crystallize. The precipitate was isolated (75 mg, 79% ee) and recrystallized from isopropanol/water [1:1 (v/v), 2 ml]. This afforded 14 mg (1.1%) of the title compound (enantiomeric excess >90%).

The enantiomeric excess was determined by HPLC analysis employing the following conditions: column: Chiralcel OJ; eluant: heptane/ethanol/diethylamine=90:10:0.2 (v/v/v); flow rate: 1.0 ml/min; temperature: 40° C. The (9R)-enantiomer (title compound) showed a retention time of 15.5 min, the (9S)-enantiomer (example 1) was eluted after 19.1 min.

¹H-NMR (dmso-d₆, 400 MHz): d=2.12 (m_{c}, 1H), 2.25 (s, bs, 4H), 2.34 (s, 3H), 2.49 (bs), 2.75 (m_{c}, 1H), 2.86, 3.00 (2s, 6H), 4.23 (s, 2H), 5.26 (d, 1H), 7.41 (m_{c}, 5H), 7.80 (s, 1H).

B. (9R)-2,3-Dimethyl-9-phenyl-7H-8,9-dihydro-pyrano[2,3-c]-imidazo[1,2-a]pyridine-6-carboxylic acid dimethylamide

Resolution of racemic 2,3dimethyl-9-phenyl-7H-8,9-dihydro-pyrano[2,3-c]-imidazo[1,2-a]pyridine-6-carboxylic acid dimethylamide (synthesis described in WO 03/014123, 3.00 g, 8.6 mmol) was performed as described in example 2. The first-eluting enantiomer was identified as the title compound ((9R-enantomer) (1.40 g, 47% yield, 98.2% ee).

Melting point: 254° C.

The analytical method for the HPLC determination of the optical purity is described in example 2. The title compound (detection at 240 nm) was eluted after 8.0 min (98.2% ee).

Optical rotation: [a]^{D}₂₀=53° (c=0.61, dichloromethane).

¹H-NMR (200 MHz, dmso-d₆): δ=2.14 (m_{c}, 2H), 2.26, 2.35 (2s, 6H), 2.42 (m_{c}), 2.75 (m_{c}, 1H), 2.87, 3.01 (2s, 6H), 5.27 (dd, 1H), 7.43 (m_{c}, 5H), 7.79 (s, 1H).

C. (9R)-3-Hydroxymethyl-2-methyl-9-phenyl-7H-8,9-dihydro-pyrano[2,3c]-imidazo[1,2-a]pyridine-6-carboxylic acid dimethylamide

Resolution of racemic 3-hydroxymethyl-2-methyl-9-phenyl-7H-8,9-dihydro-pyrano[2,3-c]-imidazo[1,2-a]pyridine-6-carboxylic acid dimethylamide (example xii, 194 mg, 0.53 mmol) was performed as described in example 3. The first-eluting enantiomer was identified as the title compound ((9R)-enantiomer) (90 mg, 46% yield, 99.6-100% ee).

Melting point: 178-181° C.

The analytical method for the HPLC determination of the optical purity is described in example 3. The title compound (detection at 220 nm) was eluted after 9.50 min (99.6% ee).

Determination of the optical purity by CE: RT=18.0 min/100% ee (A).

Optical rotation: [a]^{D}₂₀=62° (c=0.53, chloroform).

¹H-NMR (dmso-d₆, 200 MHz): d=2.13 (m_{c}, 1H), 2.25, 2.30 (m_{c}, s, 4H), 2.44 (m_{c}), 2.80, 2.88 (m_{c}, s, 4H), 3.01 (s, 3H), 4.72 (bs, 2H), 5.06 (bs, 1H), 5.29 (dd, 1H), 7.42 (m_{c}, 5H), 7.89 (s, 1H).

D. (9R)-3-Bromo-2-methyl-9-phenyl-7H-8,9-dihydro-pyrano[2,3-c]-imidazo[1,2-a]pyridine-6-carboxylic acid dimethylamide

Resolution of racemic 3-bromo-2-methyl-9-phenyl-7H-8,9-dihydro-pyrano[2,3-c-imidazo[1,2-a]pyridine-6-carboxylic acid dimethylamide (example xiii, 186 mg, 0.45 mmol) was performed as described in example 4. The first-eluting enantiomer was identified as the title compound ((9R)-enantiomer) (90 mg, 48% yield, 99.7-99.8% ee).

Melting point: 162-164° C.

The analytical method for the HPLC determination of the optical purity is described in example 4. The title compound (detection at 220 nm) was eluted after 4.76 min (99.8% ee).

Determination of the optical purity by CE: RT=18.0 min/99.7% ee (A).

Optical rotation: [a]^{D}₂₀=64° (c=0.45, chloroform, sample was filtered over a pad of silica gel prior to determination of the optical rotation).

¹H-NMR (dmso-d₆, 200 MHz): d=2.16 (m_{c}, 1H), 2.25, 2.31 (m_{c}, s, 4H), 2.50 (m_{c}), 2.80, 2.87 (m_{c}, s, 4H), 3.02 (s, 3H), 5.31 (dd, 1H), 7.43 (m_{c}, 5H), 7.82 (m_{c}, 1H).

Elemental analysis: calculated for C₂₀H₂₀BrN₃O₂ (414.31): C 57.98, H 4.87, N 10.14, Br 19.29; found: C 57.09, H 4.91, N 9.85, Br 18.78.

E. (9R)-3-Ethyl-2-methyl-9-phenyl-7H-8,9-dihydro-pyrano[2,3-c]-imidazo[1,2-a]pyridine-6-carboxylic acid dimethylamide

Resolution of racemic 3-ethyl-2-methyl-9-phenyl-7H-8,9-dihydro-pyrano[2,3-c]-imidazo[1,2-a]pyridine-6-carboxylic acid dimethylamide (example xv, 188 mg, 0.52 mmol) was performed as described in example 5. The second-eluting enantiomer was identified as the title compound ((9R)-enantiomer) (90 mg, 48% yield, 99.4-100% ee).

Melting point: 212-214° C.

The analytical method for the HPLC determination of the optical purity is described in example 5. The title compound (detection at 220 nm) was eluted after 13.99 min (99.4% ee).

Determination of the optical purity by CE: RT=18.7 min/100.0% ee (A). Optical rotation: [a]^{D}₂₀=58° (c=0.52, chloroform).

¹H-NMR (dmso-d₆, 200 MHz): d=1.10 (t, 3H), 2.14, 2.26 (m_{c}, s, 5H), 2.40 (m_{c}), 2.77, 2.87, 2.88 (m_{c}, q, s, 6H), 3.01 (s, 3H), 5.26 (dd, 1H), 7.42 (m_{c}, 5H), 7.88 (s, 1H).

Elemental analysis: calculated for C₂₂H₂₅N₃O₂H₂O (363.46+18): C 69.27, H 7.13 N 11.01; found: C 69.52, H 6.74, N 10.45.

F. (9R)-(2,3-Dimethyl-9-phenyl-7H-8,9-dihydro-pyrano[2,3-c]-imidazo[1,2-a]pyridin-6-yl)-pyrrolidin-1-yl methanone

Resolution of racemic (2,3-dimethyl-9-phenyl-7H-8,9-dihydro-pyrano[2,3-c]-imidazo[1,2-a]pyridin-6-yl)-pyrrolidin-1-yl methanone (example xxv, 198 mg, 0.53 mmol) was performed as described in example 6. The second-eluting enantiomer was identified as the title compound ((9R)-enantiomer) (90 mg, 45% yield, 98.6-98.9% ee).

Melting point: 246° C.

The analytical method for the HPLC determination of the optical purity is described in example 6. The title compound (detection at 220 nm) was eluted after 18.26 min (98.9% ee).

Determination of the optical purity by CE: RT=18.8 min/98.6% ee (A).

Optical rotation: [a]^{D}₂₀=45° (c=0.55, chloroform).

¹H-NMR (dmso-d₆, 200 MHz): δ=1.85 (m_{c}, 4H), 2.14, 2.25, 2.35 (m_{c}, 2s, 8H), 2.56 (m_{c}), 2.81 (m_{c}, 1H), 3.24 (m_{c}), 3.48 (t, 2H), 5.26 (dd, 1H), 7.42 (m_{c}, 5H), 7.84 (s, 1H).

Elemental analysis: calculated for C₂₃H₂₅N₃O₂H₂O (375.47+18): C 70.21, H 6.92, N 10.68; found: C 70.77, H 6.58, N 10.31.

G. (9R)-2,3-Dimethyl-9-phenyl-7H-8,9-dihydro-pyrano[2,3-c]-imidazo[1,2-a]pyridine-6-carboxylic acid methylamide

Resolution of racemic 2,3-dimethyl-9-phenyl-7H-8,9-dihydro-pyrano[2,3-c]-imidazo[1,2-a]pyridine-6-carboxylic acid methylamide (example xxvi, 196 mg, 0.58 mmol) was performed as described in example 7. The second-eluting enantiomer was identified as the title compound ((9R)-enantiomer) (85 mg, 43% yield, 96.5-97.0% ee).

Melting point: 250-253° C.

The analytical method for the HPLC determination of the optical purity is described in example 7. The title compound (detection at 220 nm) was eluted after 6.11 min (96.5% ee).

Determination of the optical purity by CE: RT=19.4 min/97.0% ee (A). Optical rotation: [a]^{D}₂₀=56° (c=0.53, chloroform).

¹H-NMR (dmso-d₆, 200 MHz): δ=2.09 (m_{c}, s), 2.26 (m_{c}, s, 4H), 2.37 (s, 3H), 2.78 (m_{c}, d, 4H), 3.00 (m_{c}, 1H), 5.24 (dd, 1H), 7.41 (m_{c}, 5H), 7.92 (s, 1H), 8.32 (q, 1H).

H. (9R)-2,3-Dimethyl-9-phenyl-7H-8,9-dihydro-pyrano[2,3-c]-imidazo[1,2-a]pyridine-6-carboxylic acid amide

Resolution of racemic 2,3-dimethyl-9-phenyl-7H-8,9-dihydro-pyrano[2,3-c]-imidazo[1,2-a]pyridine-6-carboxylic acid amide (example xxvii, 189 mg, 0.59 mmol) was performed as described in example 8. The first-eluting enantiomer was identified as the title compound ((9R)-enantiomer) (85 mg, 45% yield, 98.5-100.0% ee).

Melting point: 349-350° C.

The analytical method for the HPLC determination of the optical purity is described in example 8. The title compound (detection at 220 nm) was eluted after 4.90 min (98.5% ee).

Determination of the optical purity by CE: RT=18.8 min/100.0% ee (A).

¹H-NMR (dmso-d_{6, 200} MHz): δ=2.09 (m_{c}, 1H), 2.26 (m_{c}, s, 4H), 2.38 (s, 3H), 2.97 (m_{c}, 2H), 5.24 (dd, 1H), 7.41 (bs, m_{c}, 6H), 7.85 (bs, 1H), 7.98 (s, 1H).

I. (9R)-2,3-Dimethyl-9-(2-methylphenyl)-7H-8,9-dihydro-pyrano[2,3-c]-Imidazo[1,2-a]pyridine-6-carboxylic acid dimethylamide

Resolution of racemic 2-3-dimethyl-9-(2-methylphenyl)-7H-8,9-dihydro-pyrano[2,3-c]-imidazo[1,2-a]pyridine-6-carboxylic acid dimethylamide (example mix, 208 mg, 0.57 mmol) was performed as described in example 9. The first-eluting enantiomer was identified as the title compound ((9R)-enantiomer) (100 mg of a foamy solid, 48% yield, >99.5% ee).

The set-up of the analytical method for the HPLC determination of the optical purity is described in example 9. The title compound (detection at 220 nm) was eluted after 10.84 min (>99.5% ee).

Optical rotation: [a]^{D}₂₀=39° (c=0.42, chloroform).

¹H-NMR (dmso-d₆, 200 MHz): δ=2.05 (m_{c}, 1H), 2.25 (m_{c}, s, 4H), 2.35, 2.39 (2s, 6H), 2.56 (m_{c}), 2.86, 2.91 (m_{c}, s, 4H), 3.02 (s, 3H), 5.37 (dd, 1H), 7.28 (m_{c}, 3H), 7.47 (m_{c}, 1H), 7.79 (s, 1H).

J. (9R)-9-(2-Fluorophenyl)-2,3-dimethyl-7H-8,9-dihydro-pyrano[2,3c]-imidazo[1,2-a]pyridine-6-carboxylic acid dimethylamide

Resolution of racemic 9-(2-fluorophenyl)-2,3-dimethyl-7H-8,9-dihydro-pyrano[2,3c]-imidazo[1,2-a]pyridine-6-carboxylic acid dimethylamide (example xxxi, 247 mg, 0.67 mmol) was performed as described in example 10. The first-eluting enantiomer was identified as the title compound ((9R)-enantomer) (117 mg, 47% yield, >99.5% ee).

Melting point: 210° C. The

set-up of the analytical method for the HPLC determination of the optical purity is described in example 10. The title compound (detection at 220 nm) was eluted after 8.41 min (>99.5% ee).

Determination of the optical purity by CE: RT=15.1 min/99.8% ee (B).

Optical rotation: [a]^{D}₂₀=75° (c=0.47, chloroform).

¹H-NMR (dmso-c6, 200 MHz): δ=2.24, 2.25 (m_{c}, s, 5H), 2.35 (s, 3H), 2.54 (m_{c}), 2.84, 2.90 (m_{c}, s, 4H), 3.02 (s, 3H), 5.48 (dd, 1H), 7.29 (m_{c}, 2H), 7.44 (m_{c}, 1H), 7.58 (m_{c}, 1H), 7.81 (s, 1H).

K. (9R)-9-(4-Fluorophenyl)-2,3dimethyl-7H-8,9-dihydro-pyrano[2,3-c]-imidazo[1,2-a]pyridine-6-carboxylic acid dimethylamide

Resolution of racemic 9-(4-fluorophenyl)-2,3-dimethyl-7H-8,9-dihydro-pyrano[2,3-c]-imidazo[1,2-a]pyridine-6-carboxylic acid dimethylamide (example xxxiii, 210 mg, 0.57 mmol) was performed as described in example 11. The first-eluting enantiomer was identified as the title compound ((9R)-enantiomer) (105 mg, 50% yield, >99.5% ee).

Melting point: 255° C.

The set-up of the analytical method for the HPLC determination of the optical purity is described in example 11. The title compound (detection at 220 nm) was eluted after 10.59 min (>99.5% ee).

Determination of the optical purity by CE: RT=15.1 min/98.2% ee (B).

Optical rotation: [a]^{D}₂₀=60° (c=0.39, chloroform).

¹H-NMR (dmso-d₆, 200 MHz): δ=2.16, 2.25 (m_{c}, s, 5H), 2.35 (s, 3H), 2.48 (m_{c}), 2.79, 2.88 (m_{c}, s, 4H), 3.01 (s, 3H), 5.27 (dd, 1H), 7.26 (m_{c}, 2H), 7.54 (m_{c}, 2H), 7.79 (s, 1H).

### Compounds of the Formula 2 Obtained by Asymmetric Synthesis

L . (9R)-2,3-Dimethyl-9-phenyl-7H-8,9-dihydro-pyrano[2,3-c]-imidazo[1,2-a]pyridine-6-carboxylic acid dimethylamide

In a flame-dried flask filled with argon, (3S)-8-hydroxy-7-(3-hydroxy-3-phenyl-propyl)-2,3-dimethyl-imidazo[1,2-a]pyridine-6-carboxylic acid dimethylamide (example lii, 4.00 g, 10.9 mmol, 95.4% ee) was dissolved in dry dichloromethane (80 ml) and triphenylphosphine (4.30 g, 16.4 mmol) was added. DIAD (3.40 g, 16.8 mmol) was added over a period of 3 minutes, at which point a yellow-green solution was obtained. Immediately after the addition, the reaction mixture was concentrated under reduced pressure and the residue was purified by flash chromatography [100 g of silica gel, eluant: di-chloromethane/methanol=100:1, then 20:1 (v/v)]. A solid (4 g) was obtained which was suspended in acetone (20 ml). The precipitate was isolated by filtration, washed with acetone (5 ml) and diethyl ether (10 ml), and dried in vacuo yielding 1.6 g of the title compound (42% yield, optical purity: 95.6-95.8% ee).

Melting point: 257-259° C. (acetone)

The set-up of the analytical method for the HPLC determination of the optical purity was as follows: column: 250×4.6 mm CHIRALPAK® AD-H 5 μm; mobile phase: ethanol/methanol=1:1 (v/v) with 0.1% of diethylamine; flow rate: 1 ml/min; 35° C., detection at 243 nm. The title compound (97.8 area-%) was eluted after 3.9 min, the (9S) enantiomer was eluted after 4.4 min (2.2 area-%). Optical purity: 95.6%ee.

Determination of the optical purity by CE: RT [(9S)-enantiomer]=18.3 min/2.1 area-%; RT [(9R)-enantiomer]=18.6 min/97.9 area-%; 95.8% ee (A).

¹H-NMR (dmso-d₆, 200 MHz): d=2.14 (m_{c}, 1H), 2.26 (s, m_{c}, 4H), 2.35 (s, 3H), 2.47 (m_{c}), 2.78, 2.87 (m_{c}, s, 4H), 3.01 (s, 3H), 5.26 (dd, 1H), 7.42 (m_{c}, 5H), 7.79 (s, 1H).

### III. STARTING MATERIALS AND INTERMEDIATES

### Synthesis of Racemic 7H-8,9-dihydro-pyrano[2,3c]-imidazo[1,2-a]pyridines Via Cross Metathesis

I. 2-Amino-3-benzyloxy-5-bromo-pyridine

2-Amino-3-benzyloxypyridine (85.0 g, 0.42 mol) was dissolved in a 10% aqueous solution of sulphuric acid (1000 ml). The yellow solution was cooled to 0 to 4° C. and a solution of bromine (80.5 g, 0.50 mol) in acetic acid (276 g, 4.6 mol) was added dropwise over a period of 2 hours. A red suspension was obtained which was stirred for 2.5 hours at 0° C. and was then poured onto a mixture of ice water (500 ml) and dichloromethane (1000 ml). A pH-value of 8 was adjusted by addition of 25% aqueous ammonia solution (approx. 600 ml) to the well-stirred biphasic mixture. The phases were separated and the aqueous phase was extracted with dichloromethane (3×500 ml). The combined organic phases were washed with water (400 ml) and dried over sodium sulfate. The solvent was removed under reduced pressure and the residue was purified by flash chromatography [1 kg of silica gel, eluant: petrol ether/ethyl acetate=7:3 (v/v)]. Thus, 96.0 g of the title compound were isolated in form of a brown solid (81% yield).

Melting point: 109-110° C.

¹H-NMR (CDCl₃, 200 MHz): δ=4.73 (bs, 2H), 5.04 (s, 2H), 7.08 (d, 1H), 7.40 (m_{c}, 5H), 7.73 (d, 1H).

ii. 8-Benzyloxy-6-bromo-2-methyl-imidazo[1,2-a]pyridine

A well-stirred solution of 2-amino-3-benzyloxy-5-bromo-pyridine (96.0 g, 0.34 mol) and chloroacetone (50 ml, 58.0 g, 0.63 mol) in dry THF (300 ml) was heated to 60° C. After 3.5 days, the precipitate formed in the course of the reaction was removed by filtration, washed with THF (30 ml), and dried in vacuo. The mother liquor was treated with more chloroacetone (50 ml, 58.0 g, 0.63 mol) and the reaction mixture was stirred at 60° C. for another 8 days. More precipitate was formed which was again isolated by filtration, washed with THF (30 ml), and dried in vacuo. The two crops (55+48 g), were combined and were crystallized from hot isopropanol (800 ml). The obtained colourless crystals (55 g) were dissolved in a biphasic mixture of water and dichloromethane. The mixture was neutralized by addition of a 6 N aqueous solution of sodium hydroxide. The phases were separated and the aqueous phase was extracted with dichloromethane (2×50 ml). The combined organic phases were dried over sodium sulfate and concentrated under reduced pressure. The obtained solid was purified by flash chromatography [1.7 kg of silica gel, eluant: petrol ether/ethyl acetate=8:2 (v/v)]. The mother liquor of the crystallization step was concentrated and the residue (48 g) was purified as described above. A total amount of 63.7 g (59% yield) of a sticky yellow solid was isolated, which was the pure title compound as indicated by ¹H-NMR analysis.

¹H-NMR (CDCl₃, 200 MHz): δ=2.43 (s, 3H), 5.28 (s, 2H), 6.52 (d, 1H), 7.37 (m_{c}, 6H), 7.79 (d, 1H).

iii. 8-Benzyloxy-2-methyl-imidazo[1,2-a]pyridine-6-carboxylic acid dimethylamide

A solution of 8-benzyloxy-6-bromo-2-methyl-imidazo[1,2-a]pyridine (146.0 g, 0.46 mol) in dry THF (3 l) was transferred into an autoclave. After addition of palladium acetate (11.5 g, 0.05 mol), triphenyl-phosphine (71.0 g, 0.27 mol), triethylamine (132 ml, 0.94 mol), and a 2 M solution of dimethylamine in THF (12 l, 2.4 mol), the autoclave was pressurized with carbon monoxide (6 bar) and was heated to 120° C. After a reaction time of 18 hours the reaction mixture was cooled, filtered, and concentrated in vacuo. The residue was dissolved in dichloromethane (700 ml) and water (300 ml). The phases were separated and the aqueous phase was extracted with dichloromethane (100 ml). The combined organic phases were dried over sodium sulfate and concentrated under reduced pressure. A sticky brown residue (219 g) remained which was purified by flash chromatography (4.4 kg of silica gel, eluant: ethyl acetate, then ethyl acetate/methanol=9:1). The title compound was isolated as a beige solid (110 g, 77% yield), pure by means of ¹H-NMR spectroscopy.

¹H-NMR (CDCl₃, 200 MHz): δ=2.47 (s, 3H), 2.95 (bs, 6H), 5.35 (s, 2H), 6.43 (d, 1H), 7.40 (m_{c}, 6H), 7.88 (d, 1H).

iv. 8-Hydroxy-2-methyl-imidazo[1,2-a]pyridine-6-carboxylic acid dimethylamide

A solution of 8-benzyloxy-2-methyl-imidazo[1,2-a]pyridine-6-carboxylic acid dimethylamide (58.0 g, 0.19 mol) in methanol (500 ml) was treated with the hydrogenation catalyst (10% palladium on charcoal, 7 g) and a hydrogen pressure of 1 bar was applied. After the suspension had been stirred for 18 hours at room temperature, the catalyst was removed by filtration and the filtrate was concentrated in vacuo. The title compound (40.1 g, 98% yield) was isolated as a beige solid.

¹H-NMR (CDCl₃, 200 MHz): δ=2.44 (s, 3H), 3.10 (bs, 6H), 6.74 (d, 1H), 7.31 (s, 1H), 7.89 (d, 1H), 8.96 (bs, 1H).

v. 8-Allyloxy-2-methyl-imidazo[1,2-a]pyridine-6-carboxylic acid dimethylamide

The alcohol 8-hydroxy-2-methyl-imidazo[1,2-a]pyridine-6-carboxylic acid dimethylamide (4.74 g, 21.6 mmol) was dissolved in dry DMF (50 ml). Potassium carbonate (2.98 g, 21.6 mmol) and allyl bromide (3.14 g, 25.9 mmol) was added and the reaction mixture was stirred at room temperature for 18.5 hours. The solvent was removed under reduced pressure and the residue was dissolved in saturated ammonium chloride solution (100 ml) and chloroform (150 ml). The phases were separated and the aqueous phase was extracted with chloroform (2×150 ml). The combined organic phases were dried over sodium sulfate and concentrated under reduced pressure. The obtained dark-brown liquid (8.5 g) was purified by flash chromatography [250 g of silica gel, eluant: ethyl acetate/methanol=4:1 (v/v)]. The title compound was isolated in 70% yield (5.05 g) in form of a yellowish oil. Traces of impurities (approximately 5 mol-%/o) were visible in the ¹H-NMR spectrum.

¹H-NMR (CDCl₃, 200 MHz): δ=2.46 (s, 3H), 3.09 (s, 6H), 4.79 (dt, 2H), 5.33 (dd, 1H), 5.45 (dd, 1H), 6.15 (ddt, 1H), 6.48 (d, 1H), 7.33 (s, 1H), 7.87 (d, 1H).

vi. 7-Allyl-8-hydroxy-2-methyl-imidazo[1,2-a]pyridine-6-carboxylic acid dimethylamide

A flask containing neat 8-allyloxy-2-methyl-4-imidazo[1,2-a]pyridine-6-carboxylic acid dimethylamide (3.93 g, 15.2 mmol) was put into an oil-bath, which had been preheated to 160° C. After a period of 50 minutes at 160° C., the reaction mixture solidified forming a dark brown solid. The crude product was cooled to room temperature and was treated with a mixture of acetone and diethyl ether [1:1 (v/v), 20 ml]. A colourless solid precipitated, which was removed by filtration, washed with diethyl ether (10 ml), and dried in vacuo. Thus, 2.10 g of the pure title compound were isolated. The mother liquor was concentrated under reduced pressure and purified by flash chromatography (70 g of silica gel, eluant: ethyl acetate/methanol=9:1 then 4:1 (v/v)] yielding another 0.48 g of the title compound (2.58 g, 66% overall yield).

¹H-NMR (CDCl₃, 200 MHz): δ=2.43 (s, 3H), 2.88 (s, 3H), 3.11 (s, 3H), 3.55 (bd, 2H), 5.00, 5.07 (2 dd, 2H), 5.98 (m_{c}, 1H), 7.22 (s, 1H), 7.53 (s, 1H), 9.57 (bs, 1H).

vii. Pivaloic acid (7-allyl-6-dimethylcarbamoyl-2-methyl-imidazo[1,2-a]pyridin-8-yl) ester

To a suspension of the alcohol 7-allyl-8-hydroxy-2-methyl-imidazo[1,2-a]pyridine-6-carboxylic acid dimethylamide (1.00 g, 3.9 mmol) in acetone (30 ml), potassium carbonate (0.53 g, 3.9 mmol) and pivaloyl chloride (0.93 g, 7.7 mmol) was added. The yellow suspension was stirred for 3 hours at room temperature. After addition of saturated ammonium chloride solution (20 ml) and water (10 ml) the reaction mixture was extracted with dichloromethane (3×50 ml). The combined organic phases were dried over sodium sulfate and concentrated under reduced pressure. The crude product (1.46 g of a colourless solid) was purified by flash chromatography (30 g of silica gel, eluant: ethyl acetate). The title compound was obtained in 72% yield (0.96 g of colourless solid).

Melting point: 178-180° C.

¹H-NMR (CDCl₃, 200 MHz): δ=1.48 (s, 9H), 2.41 (s, 3H), 2.89 (s, 3H), 3.08 (s, 3H), 3.35 (d, 2H), 5.04 (m_{c}, 2H), 5.78 (m_{c}, 1H), 7.28 (s, 1H), 7.82 (s, 1H).

viii. (E)-Pivaloic acid [6-dimethylcarbamoyl-2-methyl-7-(3-phenyl-allyl)-imidazo[1,2-a]pyridin-8-yl] ester

The olefin pivaloic acid (7-allyl-6-dimethylcarbamoyl-2-methyl-imidazo[1,2-a]pyridin-8-yl) ester (9.30 g, 27.1 mmol) was dissolved in dichloromethane (140 ml, which had been degassed with argon. After addition of trans-stilbene (19.53 g, 108.4 mmol) and second-generation Grubbs catalyst (CAS 246047-72-3, 920 mg, 1.08 mmol, 4 mol-%) a red solution was obtained. The reaction mixture was heated to 40° C. and was stirred for 18 hours at this temperature. The crude product obtained on concentration of the green solution was purified by flash chromatography [1.2 kg of silica gel, eluant: petrolether (to remove excess trans-stilbene), then ethyl acetate]. A slightly green solid (6.6 g) was isolated which consisted of the title compound (90 mol-%, 53% yield) and untransformed pivaloic acid (7-allyl-6-dimethylcarbamoyl-2-methyl-imidazo[1,2-a]pyridin-8-yl) ester (10 mol-%, ratio determined by ¹H-NMR analysis).

¹H-NMR data of the title compound, derived from a 9:1 mixture with untransformed starting material (CDCl₃, 200 MHz): δ=1.49 (s, 9H), 2.42 (s, 3H), 2.79 (s, 3H), 3.01 (s, 3H), 3.53 (d, 2H), 6.12 (dt, 1H), 6.43 (d, 1H), 7.24 (m_{c}, 6H), 7.81 (s, 1H). The NMR signals of the starting material are reported above.

ix. 2-Methyl-9-phenyl-7H-8,9-dihydro-pyrano[2,3c]-imidazo[1,2-a]pyridine-6-carboxylic acid dimethylamide

The product of the cross-metathesis reaction (6.6 g), containing (E)-pivaloic acid [6-dimethylcarbamoyl-2-methyl-7-(3-phenyl-allyl)-imidazo[1,2-a]pyridin-8-yl] ester (6.05 g, 14.4 mmol) and pivaloic acid (7-allyl-6-dimethylcarbamoyl-2-methyl-imidazo[1,2-a]pyridin-8-yl) ester (0.55 g, 1.6 mmol) was treated with 200 ml of orthophosphoric acid (85%). The resulting green solution was heated for 50 minutes to 80° C. The reaction mixture was cooled to room temperature, diluted with dichloromethane (200 ml), and neutralized with a 6 N solution of sodium hydroxide at 0° C. The phases were separated and the aqueous phase was extracted with dichloromethane (2×200 ml). The combined organic phases were dried over sodium sulfate and concentrated under reduced pressure. The crude product was purified by flash chromatography [210 g of silica gel, eluant: ethyl acetate/methanol=9:1 (v/v)]. A colourless solid (4.4 g, 91% yield) was obtained, which was the pure title compound as indicated by ¹H-NMR analysis.

Melting point: 189° C.

¹H-NMR (CDCl₃, 200 MHz): δ=2.26 (m_{c}, 2H), 2.41 (s, 3H), 2.58, 2.77 (2m_{c}, 2H), 2.94 (s, 3H), 3.12 (s, 3H), 5.31 (dd, 1H), 7.40 (m_{c}, 6H), 7.67 (s, 1H).

x. 2-Methyl-9-phenyl-7H-8,9-dihydro-pyrano[2,3c]-imidazo[1,2-a]pyridine-6-carboxylic acid dimethylamide prepared by one-pot synthesis

The title compound can also be obtained by application of a one-pot procedure: In a flame-dried flask filled with argon, pivaloic acid (7-allyl-6-dimethylcarbamoyl-2-methyl-imidazo[1,2-a]pyridin-8-yl) ester (4.80 g, 14.0 mmol) was dissolved in dichloromethane (100 ml) which had been degassed with argon. After addition of trans-stilbene (10.10 g, 56.0 mmol) and second-generation Grubbs catalyst (CAS 246047-72-3, 475 mg, 0.56 mmol, 4 mol-%/o) the solution was heated to 40° C. The reaction mixture was stirred for 18 hours at this temperature and was then concentrated under reduced pressure. A green solid was obtained which was treated with 100 ml of orthophosphoric acid (85%). The suspension was heated to 80° C. After a period of 1 hour, a clear solution was obtained which was cooled to room temperature and poured onto a mixture of ice water (50 ml) and dichloromethane (50 ml). A pH-value of 8 was adjusted by addition of 6 N sodium hydroxide solution. The phases were separated and the aqueous phase was extracted with dichloromethane (2×20 ml). The combined organic phases were dried over sodium sulfate and concentrated under reduced pressure. The residue, 16 g of a green solid, was purified by flash chromatography [320 g of silica gel, eluant: petrol ether (to remove excess trans-stilbene), then ethyl acetate/methanol=100:2 (v/v)]. The title compound (3.0 g, 64% yield) was isolated as a green foamy solid, pure by means of ¹H-NMR spectroscopy.

¹H-NMR (CDCl₃, 200 MHz): δ=2.26 (m_{c}, 2H), 2.41 (s, 3H), 2.58, 2.77 (2m_{c}, 2H), 2.94 (s, 3H), 3.12 (s, 3H), 5.31 (dd, 1H), 7.40 (m_{c}, 6H), 7.67 (s, 1H).

xi. 3-Formyl-2-methyl-9-phenyl-7H-8,9-dihydro-pyrano[2,3-c]imidazo[1,2-a]pyridine-6-carboxylic acid dimethylamide

A flask containing dry DMF (10 ml) was cooled to 0° C. and phosphorus oxychloride (1.14 g, 7.4 mmol) was added. The cooling bath was removed and the solution was stirred for 1 hour at room temperature. The red reaction mixture was treated with a solution of 2-methyl-9-phenyl-7H-8,9-dihydro-pyrano[2,3-c]imidazo[1,2-a]pyridine-6-carboxylic acid dimethylamide (1.00 g, 3.0 mmol) in dry DMF (10 ml) and was heated to 60° C. After a period of 3 hours, the reaction mixture was poured on ice water (50 ml), neutralized by addition of 2 N sodium hydroxide solution, and was then extracted with dichloromethane (3×40 ml). The combined organic phases were dried over sodium sulfate and concentrated in vacuo. The title compound (1.0 g, 92% yield) was obtained as a brown solid, almost pure by means of ¹H-NMR spectroscopy.

¹H-NMR (CDCl₃, 200 MHz): δ=2.31 (m_{c}, 2H), 2.72 (s, m_{c}, 4H), 2.89, 2.95 (m_{c}, s, 4H), 3.15 (s, 3H), 5.34 (dd, 1H), 7.39 (m_{c}, 5H), 9.09 (s, 1H), 9.99 (s, 1H).

xii. 3-Hydroxymethyl-2-methyl-9-phenyl-7H-8,9-dihydro-pyrano[2,3-c]-imidazo[1,2-a]pyridine-6-carboxylic acid dimethylamide

A suspension of 3-formyl-2-methyl-9-phenyl-7H-8,9-dihydro-pyrano[2,3-c]-imidazo[1,2-a]pyridine-6-carboxylic acid dimethylamide (1.00 g, 2.8 mmol) in dry ethanol (30 ml) was treated with sodium borohydride (52 mg, 1.37 mmol). The reaction mixture was stirred for 40 minutes at room temperature. A clear solution was obtained which was poured on water (20 ml) and dichloromethane (50 ml). The phases were separated and the aqueous phase was extracted with dichloromethane (2×20 ml). The combined organic phases were dried over sodium sulfate and concentrated under reduced pressure. A yellowish, foamy solid remained which was crystallized from acetone (5 ml). The colourless precipitate was isolated by filtration and dried in vacuo yielding 420 mg of the pure title compound (42% yield). The mother liquor was concentrated and the residue was purified by flash chromatography [silica gel, eluant: ethyl acetate/methanol=10:1 (v/v)]. This furnished further 160 mg of the title compound (16% yield, yellow solid pure by means of ¹H-NMR spectroscopy).

Melting point: 186° C. (acetone)

¹H-NMR (CDCl₃, 200 MHz): δ=2.30, 2.37 (m_{c}, s, 5H), 2.68 (m_{c}, 2H), 2.90, 3.10 (2s, 6H), 4.85 (s, 2H), 5.30 (dd, 1H), 7.38 (m_{c}, 5H), 7.81 (s, 1H).

xiii. 3-Bromo-2-methyl-9-phenyl-7H-8,9-dihydro-pyrano[2,3c]-imidazo[1,2-a]pyridine-6-carboxylic acid dimethylamide

2-Methyl-9-phenyl-7H-8,9-dihydro-pyrano[2,3-c]-imidazo[1,2-a]pyridine-6-carboxylic acid dimethylamide (example ix/x, 2.00 g, 6.0 mmol) was dissolved in a mixture of chloroform (10 ml) and dichloromethane (10 ml). The solution was cooled to −78° C. and N-bromosuccinimide (1.06 g, 6.0 mmol) was added. The reaction mixture was stirred for 45 minutes at −78° C. The cooling bath was removed and saturated sodium bicarbonate solution (15 ml) was added. The phases were separated and the aqueous phase was extracted with dichloromethane (10 ml). The combined organic phases were dried over sodium sulfate and concentrated under reduced pressure. A light green foamy solid (2.7 g) was isolated, which was purified by flash chromatography [80 g of silica gel, eluant: ethyl acetate/petrolether=6:4 (v/v)]. The title compound was isolated as a beige solid (1.75 g, 71% yield), pure by means of ¹H-NMR spectroscopy. Furthermore, 0.5 g of a mixture of the title compound (96 weight-%/o) and succinimide (4 weight-%) was isolated (19% yield).

Melting point: 167-168° C.

¹H-NMR (CDCl₃, 200 MHz): δ=2.28 (m_{c}, 2H), 2.45 (s, 3H), 2.69 (m_{c}, 2H), 2.93, 3.14 (2s, 6H), 5.32 (dd, 1H), 7.38 (m_{c}, 5H), 7.65 (s, 1H).

xiv. 2-Methyl-9-phenyl-3-vinyl-7H-8,9-dihydro-pyrano[2,3-c]-imidazo[1,2-a]pyridine-6-carboxylic acid dimethylamide

In a flame-dried flask filled with argon, 3-bromo-2-methyl-9-phenyl-7H-8,9-dihydro-pyrano[2,3-c]-imidazo[1,2-a]pyridine-6-carboxylic acid dimethylamide (1.60 g, 3.9 mmol) was dissolved in dry 1,4-dioxane (50 ml). The solution was treated with tributyl(vinyl)stannane (1.48 g, 4.7 mmol) and bis(triphenylphosphino)palladium chloride (270 mg, 0.38 mmol) and was stirred at a temperature of 100° C. (pre-heated oil bath). After 2 hours, another portion of tributyl(vinyl)stannane (0.70 g, 2.2 mmol) and bis(triphenylphosphino)palladium chloride (140 mg, 0.20 mmol) was added. The reaction was continued for 1 hour at 100° C. The reaction mixture was cooled to room temperature and concentrated in the presence of silica gel (3 g). The crude product was purified by flash chromatography [120 g of silica gel, eluant: petrol ether, then petrol ether/ethyl acetate=1:1 (v/v), then petrol ether/ethyl acetate=2:8 (v(v)]. In order to achieve further purification, the title compound obtained after chromatography (1.3 g) was dissolved in ethyl acetate (20 ml) and water (15 ml). A pH-value of 1.5 was adjusted by addition of 2 N hydrochloric acid. The phases were separated and the aqueous phase was extracted with ethyl acetate (10 ml). The organic phase was discarded and dichloromethane (20 ml) was added to the aqueous phase. A pH-value of 8 was adjusted by addition of 2 N sodium hydroxide solution. The phases were separated and the aqueous phase was extracted with dichloromethane (2×10 ml). The combined organic phases were dried over sodium sulfate and concentrated under reduced pressure. The residue, 1.0 g of a yellow solid, was dried in vacuo and was characterized as the pure title compound (72% yield).

¹H-NMR (CDCl₃, 200 MHz): δ=2.30 (m_{c}, 2H), 2.54, 2.63 (s, m_{c}, 4H), 2.79 (m_{c}, 1H), 2.92, 3.13 (2s, 6H), 5.34 (dd, 1H), 5.42 (d, 1H), 5.56 (d, 1H), 6.78 (dd, 1H), 7.38 (m_{c}, 5H), 7.75 (s, 1H).

xv. 3-Ethyl-2-methyl-9-phenyl-7H-8,9-dihydro-pyrano[2,3c]-imidazo[1,2-a]pyridine-6-carboxylic acid dimethylamide

2-Methyl-9-phenyl-3-vinyl-7H-8,9-dihydro-pyrano[2,3-c]-imidazo[1,2-a]pyridine-6-carboxylic acid dimethylamide (0.280 g, 0.77 mmol) was dissolved in dry methanol (20 ml). After addition of Lindlar catalyst (Pd/CaCO₃/Pb, Aldrich 20, 573-7, 56 mg, 20 weight-%/o), a hydrogen pressure of 1 bar was applied. The reaction mixture was stirred for 2 hours at room temperature and another 28 mg (10 weight-%) of catalyst was added. The hydrogenation was continued for 2 hours. The catalyst was removed by filtration, the filtrate was concentrated, and the remaining yellow solid was dried in vacuo. The title compound was isolated in 89% yield (250 mg).

Melting point: 230° C.

¹H-NMR (CDCl₃, 200 MHz): δ=1.20 (t, 3H), 2.26 (m_{c}, 2H), 2.41 (s, 3H), 2.57 (m_{c}, 1H), 2.73, 2.84, 2.92 (m_{c}, q, s, 6H), 3.13 (s, 3H), 5.32 (dd, 1H), 7.38 (m_{c}, 6H).

Elemental analysis: calculated for C₂₂H₂₅N₃O₂ (363.46): C 72.70, H 6.93, N 11.56; found: C 71.71, H 6.86, N 11.21.

xvi. 2,3-Dimethyl-9-(2-methylphenyl)-7H-8,9-dihydro-pyrano[2,3c]-imidazo[1,2-a]pyridine-6-carboxylic acid dimethylamide

In a flame-dried flask filled with argon, 7-allyl-2,3-dimethyl-8-[dimethyl-(1,1,2-trimethyl-propyl)-silanyloxy]-imidazo[1,2-a]pyridine-6-carboxylic acid dimethylamide (example xxi, 1.50 g, 3.6 mmol) was dissolved in dichloromethane (50 ml) which had been degassed with argon. After addition of o-methyl-styrene (2.13 g, 18.0 mmol) and second-generation Grubbs catalyst (CAS 246047-72-3, 122 mg, 0.14 mmol, 4 mol-%) the solution was heated to 40° C. The reaction mixture was stirred for 4 days at this temperature and was then concentrated under reduced pressure. A suspension of the residue in 80 ml of orthophosphoric acid (85%) was stirred at 80° C. (pre-heated oil bath). After a period of 1.5 hours, a clear solution was obtained which was poured onto ice water (100 ml). A pH-value of 8 was adjusted by addition of 6 N sodium hydroxide solution. The aqueous phase was extracted with dichloromethane (3×80 ml). The combined organic phases were dried over sodium sulfate and concentrated under reduced pressure. The solid residue (3.7 g) was purified by flash chromatography [120 g of silica gel, eluant: petrol ether (to remove 2,2′-dimethylstilbene), then ethyl acetate/triethylamine=100:1 (v/v)]. After removal of the solvent, two samples were obtained: (a) pure title compound (280 mg of a foamy solid, 21% yield); (b) mixture of the title compound with 2,3,8-trimethyl-7,8-dihydro-furo[2,3-c]-imidazo[1,2-a]pyridine-6-carboxylic acid dimethylamide (formed by cyclization of deprotected starting material, 240 mg of a foamy solid). The mixture was further purified by preparative HPLC yielding another 111 mg of the pure title compound (overall yield: 29%).

¹H-NMR (CDCl₃, 200 MHz): δ=2.18 (m_{c}, 2H), 2.36, 2.37, 2.40 (3s, 9H), 2.78, 2.99 (m_{c}, s, 5H), 3.15 (s, 3H), 5.42 (dd, 1H), 7.20 (m_{c}, 3H), 7.43 (s, 1H), 7.56 (m_{c}, 1H).

xvii. 9-(2-Fluorophenyl)-2,3-dimethyl-7H-8,9-dihydro-pyrano[2,3c]-imidazo[1,2-a]pyridine-6-carboxylic acid dimethylamide

In a flame-dried flask filled with argon, 7-allyl-2,3-dimethyl-8-[dimethyl-(1,1,2-trimethyl-propyl)-silanyloxy]-imidazo[1,2-a]pyridine-6-carboxylic acid dimethylamide (example xxi, 2.00 g, 4.8 mmol) was dissolved in dichloromethane (50 ml) which had been degassed with argon. After addition of 2-fluoro-styrene (2.94 g, 24.1 mmol) and second-generation Grubbs catalyst (CAS 246047-72-3, 162 mg, 0.19 mmol, 4 mol-%) the solution was heated to 40° C. The reaction mixture was stirred for 17 hours at this temperature and was then concentrated under reduced pressure. A suspension of the residue in 25 ml of orthophosphoric acid (85%) was stirred at 100° C. (pre-heated oil bath). After a period of 2 hours, a clear solution was obtained which was poured onto ice water (70 ml) and dichloromethane (100 ml). A pH value of 8 was adjusted by addition of 6 N sodium hydroxide solution. The phases were separated and the aqueous phase was extracted with dichloromethane (2×50 ml). The combined organic phases were dried over sodium sulfate and concentrated under reduced pressure. The black solid residue (5.6 g) was purified by flash chromatography [225 g of silica gel, eluant: ethyl acetate/triethylamine=100:1 (v/v)]. After removal of the solvent, the pure title compound (1.0 g of a colourless solid, 56% yield) was obtained.

Melting point: 202° C.

¹H-NMR (CDCl₃, 200 MHz): δ=2.27 (m_{c}, 2H), 2.36, 2.41 (2s, 6H), 2.61 (m_{c}, 1H), 2.82 (m_{c}, 1H), 2.95, 3.14 (2s, 6H), 5.60 (dd, 1H), 7.09 (m_{c}, 2H), 7.27 (m_{c}), 7.44 (s, 1H), 7.60 (dt, 1H).

xviii. 9-(4-Fluorophenyl)-2,3-dimethyl-7H-8,9-dihydro-pyrano[2,3c]-imidazo[1,2-a]pyridine-6-carboxylic acid dimethylamide

In a flame-dried flask filled with argon, 7-allyl-2,3-dimethyl-8-[dimethyl-(1,1,2-trimethyl-propyl)-silanyloxy]-imidazo[1,2-a]pyridine-6-carboxylic acid dimethylamide (example xxi, 1.50 g, 3.6 mmol) was dissolved in dichloromethane (50 ml) which had been degassed with argon. After addition of p-fluoro-styrene (2.20 g, 18.0 mmol) and second-generation Grubbs catalyst (CAS 246047-72-3, 122 mg, 0.14 mmol, 4 mol-%) the solution was heated to 40° C. The reaction mixture was stirred for 5 days at this temperature and was then concentrated under reduced pressure. A suspension of the residue in 80 ml of orthophosphoric acid (85%) was stirred at 80° C. (pre-heated oil bath). After a period of 2 hours, the reaction mixture was poured onto ice water (100 ml). A pH-value of 8 was adjusted by addition of 6 N sodium hydroxide solution. The aqueous phase was extracted with dichloromethane (3×100 ml). The combined organic phases were dried over sodium sulfate and concentrated under reduced pressure. The residue was purified by flash chromatography [100 g of silica gel, eluant: petrol ether (to remove 4,4′-difluorostilbene), then ethyl acetate, then ethyl acetate/methanol=10:1 (v/v)]. After removal of the solvent, the pure title compound was isolated in the form of a slightly green solid (280 mg, 21% yield).

¹H-NMR (CDCl₃, 200 MHz): δ=2.24 (m_{c}, 2H), 2.36, 2.41 (2s, 6H), 2.68 (m_{c}, 2H), 2.93, 3.13 (2s, 6H), 5.27 (dd, 1H), 7.04 (t, 2H), 7.43 (m_{c}, 3H).

### Synthesis of Intermediates for Asymmetric Hydroboration Via Cross Metathesis

xix. 8-Allyloxy-2,3-dimethyl-imidazo[1,2-a]pyridine-6-carboxylic acid dimethylamide

The alcohol 8-hydroxy-2,3-dimethyl-imidazo[1,2-a]pyridine-6-carboxylic acid dimethylamide (synthesis described in WO 03/014123, 50.0 g, 0.22 mol) was dissolved in dry DMF (1 l). Potassium carbonate (29.7 g, 0.22 mol) and allyl bromide (31.2 g, 0.26 mol) was added and the reaction mixture was stirred at room temperature for 18.5 hours. The solvent was removed under reduced pressure and the residue was dissolved in saturated ammonium chloride solution (250 ml) and chloroform (500 ml). The phases were separated and the aqueous phase was extracted with chloroform (2×). The combined organic phases were dried over sodium sulfate and concentrated under reduced pressure. The residue was purified by flash chromatography [800 g of silica gel, eluant: ethyl acetate/methanol=9:1 (v/v)]. The tide compound was isolated in 67% yield (40.0 g) in form of a yellow solid. Traces of impurities (approximately 14 mol-%/o) were visible in the ¹H-NMR spectrum.

¹H-NMR (CDCl₃, 400 MHz): δ=2.39, 2.46 (2s, 6H), 3.10 (s, 6H), 4.80 (dt, 2H), 5.33 (dd, 1H), 5.47 (dd, 1H), 6.14 (ddt, 1H), 6.53 (d, 1H), 7.69 (d, 1H).

xx. 7-Allyl-2,3-dimethyl-8-hydroxy-imidazo[1,2-a]pyridine-6-carboxylic acid dimethylamide

A flask containing neat 8-allyloxy-2,3-dimethyl-imidazo[1,2-a]pyridine-6-carboxylic acid dimethylamide (40.0 g, 0.15 mol) was put into an oil-bath, which had been pre-heated to 160° C. After a period of 50 min at 160° C., the reaction mixture solidified forming a dark brown solid. The crude product was cooled to room temperature and was treated with a mixture of acetone and diethyl ether [1:1 (v/v), 200 ml] at which point a beige solid precipitated. After a period of 20 minutes, the precipitate was removed by filtration, washed with diethyl ether, and dried in vacuo. Thus, 28.0 g of the pure title compound were isolated. The mother liquor was concentrated under reduced pressure and the residue (10 g of a brown solid) was purified by flash chromatography (300 g of silica gel, eluant: ethyl acetate/methanol=9:1 (v/v)] yielding another 2.2 g of the title compound (30.2 g, 76% overall yield).

¹H-NMR (CDCl₃, 200 MHz): δ=2.35, 2.44 (2s, 6H), 2.87, 3.13 (2s, 3H), 3.55 (d, 2H), 5.02, 5.07 (2dd, 2H), 5.97 (m_{c}, 1H), 7.36 (s, 1H), 10.76 (bs, 1H).

xxi. 7-Allyl-2,3-dimethyl-8-[dimethyl-(1,1,2-trimethyl-propyl)-silanyloxyl-imidazo[1,2-a]pyridine-6-carboxylic acid dimethylamide

In a flame-dried flask filled with argon, a suspension of 7-allyl-2,3-dimethyl-8-hydroxy-imidazo[1,2-a]pyridine-6-carboxylic acid dimethylamide (3.60 g, 13.2 mmol) in dry DMF (50 ml) was treated with imidazole (1.52 g, 22.3 mmol) and chloro(dimethyl)thexylsilane (slow addition of 4.40 ml, 4.00 g, 22.4 mmol). A brown solution was obtained which was stirred for 1 hour at room temperature. The reaction mixture was poured onto a mixture of ice (20 g), saturated ammonium chloride solution (30 ml), and dichloromethane (50 ml). The biphasic mixture was stirred for several minutes, the phases were separated, and the aqueous phase was extracted with dichloromethane (2×15 ml). The combined organic phases were washed with water (20 ml), dried over sodium sulfate, and concentrated under reduced pressure. The residue, 7.5 g of a yellow-brown oil, was purified by flash chromatography [150 g of silica gel, eluant: petrol ether/ethyl acetate=8:2 (v/v)]. A colourless solid (5.10 g) was isolated, the pure title compound as confirmed by ¹H-NMR spectroscopy (93% yield).

Melting point, 93-95° C.

¹H-NMR (CDCl₃, 200 MHz): δ=0.41 (s, 6H), 0.96 (d, 6H), 1.02 (s, 6H), 1.83 (septet, 1H), 2.31, 2.36 (2s, 6H), 2.84, 3.08 (2s, 6H), 3.50 (m_{c}, 2H), 4.96 (m_{c}, 2H), 5.84 (m_{c}, 1H), 7.36 (s, 1H).

xxii. (E)-2,3-Dimethyl-8-[dimethyl-(1,1,2-trimethyl-propyl)-silanyloxyl-7-(3-phenyl-allyl)-imidazo[1,2-a]pyridine-6-carboxylic acid dimethylamide

In a flame dried flask filled with argon, 7-allyl-2,3-dimethyl-8-[dimethyl-(1,1,2-trimethyl-propyl)-silanyloxy]-imidazo[1,2-a]pyridine-6-carboxylic acid dimethylamide (5.00 g, 12.0 mmol) was dissolved in dry dichloromethane (200 ml), which had been degassed with argon. Trans-stilbene (8.70 g, 48.3 mmol) and second-generation Grubbs catalyst (CAS 246047-72-3, 0.40 g, 0.5 mmol, 3.9 mol-%) was added and the obtained red solution was heated to reflux for 19 hours. The dark-brown reaction mixture was concentrated to a volume of 80 ml, and was loaded onto a column filled with 200 g of silica gel. The title compound was eluted using a mixture of petrol ether and ethyl acetate [7:3 (v/v)]. The solvent was removed and the oily residue was dried in vacuo. A slightly red foam (3.70 g) was obtained, which was analyzed to be a mixture of the title compound (93 weight-%, 58% yield) and dimethyl-(1,1,2-trimethyl-propyl)-silanol (7 weight-%). Also, 400 mg (8% yield) of starting material were recovered from the column.

¹H-NMR (CDCl₃, 200 MHz): δ=0.44 (s, 6H), 0.97 (d, 6H), 1.03 (s, 6H), 1.88 (septet, 1H), 2.31, 2.37 (2s, 6H), 2.75, 3.03 (2s, 6H), 3.69 (bs, 2H), 6.20 (dt, 1H), 6.37 (d, J=15.8 Hz, 1H), 7.22 (m_{c}, 5H), 7.34 (s, 1H), dimethyl-(1,1,2-trimethyl-propyl)-silanol: δ=0.13 (s, 6H), 0.87 (s, 6H), 0.90 (d, 6H), 1.64 (m_{c}).

xxiii. (E)-8-Hydroxy-2,3-dimethyl-7-(3-phenyl-allyl)-imidazo[1,2-a]pyridine-6-carboxylic acid dimethylamide

In a flask filled with argon, (E)-2,3-dimethyl-8-[dimethyl-(1,1,2-trimethyl-propyl)-silanyloxy]-7-(3-phenyl-allyl)-imidazo[1,2-a]pyridine-6-carboxylic acid dimethylamide (1.10 g, 2.2 mmol) was dissolved in dry THF (20 ml). After slow addition of a 1 M solution of tetrabutylammonium fluoride in THF (3.30 ml, 3.3 mmol) a dark-green solution was obtained, which was stirred for 30 minutes at room temperature. The reaction mixture was poured onto a mixture of ice (10 g), saturated ammonium chloride solution (15 ml) and dichloromethane (30 ml). The biphasic mixture was stirred for several minutes, the phases were separated, and the aqueous phase was extracted with dichloromethane (3×10 ml). The combined organic phases were washed with water (20 ml), dried over sodium sulfate, and concentrated under reduced pressure. The oily residue (1.5 g) was purified by flash chromatography [15 g of silica gel, eluant: dichloromethane, then dichloromethane/methanol=20:1 (v/v)]. A green solid (900 mg) was obtained, which was suspended in diethyl ether (10 ml), isolated by filtration, washed with diethyl ether (10 ml), and dried in vacuo. The pure title compound (630 mg of a slightly grey solid) was isolated in 81% yield.

Melting point: 183-185° C. (diethyl ether)

¹H-NMR (CDCl₃, 200 MHz): δ=2.32, 2.35 (2s, 6H), 2.76, 2.96 (2s, 6H), 3.48 (d, 2H), 5.26 (bs), 6.23, 6.34 (m_{c}, d, 2H), 7.27 (m_{c}, 5H), 7.69 (s, 1H),

Elemental analysis: calculated for C₂₁H₂₃N₃O₂ (349.43): C 72.18, H 6.63, N 12.03; found: C 71.54, H 6.53, N 11.77.

### Synthesis of Racemic 7H-8,9-dihydro-pyrano[2,3-c]-imidazo[1,2-a]pyridines via saponification of ethyl 2,3-dimethyl-9-phenyl-7H-8,9-dihydro-pyrano[2,3-c]-imidazo[1,2-a]pyridine-6-carboxylic acid

xxiv. 2,3-Dimethyl-9-phenyl-7H-8,9-dihydro-pyrano[2,3c]-imidazo1,2-a]pyridine-6-carboxylic acid

A suspension of ethyl 2,3-dimethyl-9-phenyl-7H-8,9-dihydro-pyrano[2,3-c]-imidazo[1,2-a]pyridine-6-carboxylate (synthesis described in WO 03/014123, 16.7 g, 48 mmol) in methanol (170 ml) and water (35 ml) was treated with potassium hydroxide (4.5 g, 80 mmol) and was heated to 50° C. After a reaction time of 2 hours, the methanol was removed in vacuo. Water (400 ml) and dichloromethane (300 ml) was added, a pH-value of 4.8 (isoelectric point of the title compound) was adjusted by addition of 6 N hydrochloric acid, and stirring was continued for 30 minutes. A precipitate was formed which slowly dissolved after addition of dichloromethane (100 ml) and methanol (100 ml). The phases were separated and the aqueous phase was extracted with dichloromethane (2×50 ml). The combined organic phases were dried over sodium sulfate and concentrated to a volume of 50 ml. Upon addition of diethyl ether (100 ml) a colourless precipitate was formed. Stirring was continued for 30 minutes at 0° C. The precipitate was removed by filtration and dried in vacuo yielding 9.1 g of the pure title compound (58% yield). The aqueous phase was saturated with sodium chloride and extracted with chloroform (1×400 ml, 2×100 ml). The combined organic phases were dried over sodium sulfate and concentrated in vacuo. The residue (2.0 g, 13% yield) was pure title compound as judged by ¹H-NMR spectroscopy.

Melting point: 318-320° C. (diethyl ether)

¹H-NMR (dmso-d₆, 200 MHz): δ=2.09 (m_{c}, 1H), 2.28 (s, m_{c}, 4H), 2.40 (s, 3H), 3.10 (m_{c}, 2H), 5.25 (dd, 1H), 7.43 (m_{c}, 5H), 8.32 (s, 1H), exchangeable protons not visible.

Elemental analysis: calculated for C₁₉H₁₈N₂O₃ (H₂O)_{0.5} (322.37+9.0): C 68.87, H 5.78, N 8.45; found: C 68.95, H 5.49, N 8.40.

xxv. (2,3-Dimethyl-9-phenyl-7H-8,9-dihydro-pyrano[2,3-c]-imidazo[1,2a]pyridin-6-yl)-pyrrolidin-1-yl methanone

A suspension of 2,3-dimethyl-9-phenyl-7H-8,9-dihydro-pyrano[2,3-c]-imidazo[1,2-a]pyridine-6-carboxylic acid (1.00 g, 3.1 mmol) in dichloromethane (50 ml) was treated with TBTU (1.08 g, 3.4 mmol). After a reaction time of 45 minutes at room temperature, pyrrolidine (219 mg, 253 μd, 3.08 mmol) was added. A clear solution was obtained, which was stirred for 2.5 hours at room temperature. The reaction mixture was poured onto saturated sodium bicarbonate solution (50 ml), the phases were separated, and the aqueous phase was extracted with dichloromethane (2×20 ml). The combined organic phases were dried over sodium sulfate and concentrated in vacuo. The residue (1.8 g) was treated with hot acetone (10 ml). The suspension was allowed to cool to room temperature and was stirred for 1 hour. The precipitate was isolated by filtration (730 mg) and was further purified by flash chromatography [silica gel, eluant: ethyl acetate/methanol=90:3 (v/v)]. The residue obtained after evaporation of the corresponding fractions was washed with diethyl ether (15 ml) and was isolated by filtration. The title compound was obtained in 45% yield (524 mg).

Melting point: 274° C. (diethyl ether)

¹H-NMR (CDCl₃, 200 MHz): δ=1.97 (m_{c}, 4H), 2.26, 2.36, 2.41 (m_{c}, 2s, 8H), 2.62 (m_{c}, 1H), 2.84 (m_{c}, 1H), 3.24 (m_{c}, 2H), 3.65 (t, 2H), 5.31 (dd, 1H), 7.38 (m_{c}, 6H).

Elemental analysis: calculated for C₂₃H₂₅N₃O₂ (375.47): C 73.58, H 6.71, N 11.19; found: C 73.43, H 6.74, N 11.19.

xxvi. 2,3-Dimethyl-9-phenyl-7H-8,9-dihydro-pyrano[2,3-c]-imidazo[1,2-a]pyridine-6-carboxylic acid methylamide

2,3-Dimethyl-9-phenyl-7H-8,9-dihydro-pyrano[2,3-c]-imidazo[1,2-a]pyridine-6-carboxylic acid (example xxiv, 1.50 g, 4.6 mmol) and TBTU (1.40 g, 4.4 mmol) was suspended in dichloromethane (50 ml). After a reaction time of 1 hour at room temperature, methylamine (8.0 M solution in ethanol, 2 ml, 16 mmol) was added. Within 30 minutes a clear solution was obtained, which was stirred for 2 hours at room temperature. The reaction mixture was poured onto water (20 ml), the phases were separated, and the aqueous phase was extracted with dichloromethane (10 ml). The combined organic phases were washed with water (10 ml), dried over sodium sulfate and concentrated in vacuo. The residue (1.1 g) was purified by flash chromatography [silica gel, eluant: dichloromethane/methanol=15:1 (v/v)]. After evaporation of the corresponding fractions a colourless solid was obtained which was dried in vacuo. The title compound was obtained in 58% yield (0.90 g).

Melting point: 234° C.

¹H-NMR (dmso-d₆, 200 MHz): δ=2.09 (m_{c}, s), 2.26 (m_{c}, s, 4H), 2.37 (s, 3H), 2.78 (m_{c}, d, 4H), 3.00 (m_{c}, 1H), 5.24 (dd, 1H), 7.41 (m_{c}, 5H), 7.92 (s, 1H), 8.32 (q, 1H).

xxvii. 2,3-Dimethyl-9-phenyl-7H-8,9-dihydro-pyrano[2,3-c]-imidazo[1,2-a]pyriding-6-carboxylic acid amide

A suspension of 2,3-dimethyl-9-phenyl-7H-8,9-dihydro-pyrano[2,3-c]-imidazo[1,2-a]pyridine-6-carboxylic acid (example xxiv, 500 mg, 1.54 mmol) in dichloromethane (20 ml) was treated with TBTU (504 mg, 1.57 mmol). The reaction mixture was heated for 1 hour at 40° C. and was then allowed to cool to room temperature. Ammonia gas was bubbled through the suspension over a period of 30 minutes. The reaction mixture was poured onto water (20 ml), dichloromethane (30 ml) was added, and a pH-value of 6 was adjusted by addition of 2 N hydrochloric acid. In order to facilitate the separation of the phases, a 10 ml portion of methanol was added. The phases were separated, and the aqueous phase was extracted with dichloromethane (2×10 ml). The combined organic phases were dried over sodium sulfate and concentrated in vacuo. The title compound (310 mg, 64% yield) was isolated in the form of a colourless solid, pure by means of ¹H-NMR spectroscopy.

Melting point: 303-305° C.

¹H-NMR (dmso-d₆, 200 MHz): δ=2.09 (m_{c}, 1H), 2.26 (m_{c}, s, 4H), 2.38 (s, 3H), 2.97 (m_{c}, 2H), 5.24 (dd, 1H), 7.41 (bs, m_{c}, 6H), 7.85 (bs, 1H), 7.98 (s, 1H).

### Synthesis of Racemic 7H-8,9-dihydro-pyrano[2,3-c]-imidazo[1,2-a]pyridines Via Ketone Reduction and Acid-catalyzed Cyclization/Mitsunobu Cyclization

xxviii. 8-Hydroxy-7-[3-hydroxy-3-(2-methylphenyl)-propyl]-2,3-dimethyl-imidazo[1,2-a]pyridine-6-carboxylic acid dimethylamide

8-Hydroxy-2,3-dimethyl-7-[3-(2-methylphenyl)-3-oxo-propyl]-imidazo[1,2-a]pyridine-6-carboxylic acid dimethylamide (example xxxvii, 2.00 g, 5.3 mmol) was dissolved in dry ethanol (20 ml) and sodium borohydride (240 mg, 6.34 mmol) was added in small portions. The reaction mixture was stirred for 1 hour at room temperature and was treated with another portion of sodium borohydride (120 mg, 3.17 mmol). Stirring was continued for 30 minutes and the reaction mixture was poured onto a mixture of ice (50 g), saturated ammonium chloride solution (50 ml), and dichloromethane (100 ml). The biphasic mixture was stirred for 20 minutes. The phases were separated and the aqueous phase was extracted with dichloromethane (2×10 ml). The combined organic phases were dried over sodium sulfate and concentrated under reduced pressure. The crude title compound (3.2 g) was isolated in the form of a yellow foam which was directly used as starting material for example xxix.

¹H-NMR (CDCl₃+traces of MeOD, 200 MHz): δ=2.00 (bm_{c}, 2H), 2.16 (s, 3H), 2.35 (s, 3H), 2.55 (s, 3H), 2.91, 3.05, 3.12 (s, bm_{c}, s, 8H), 4.81 (dd, 1H), 7.07 (m_{c}, 4H), 7.51 (d, 1H).

xxix. 2,3-Dimethyl-9-(2-methylphenyl)-7H-8,9-dihydro-pyrano[2,3-c]-imidazo[1,2-a]pyridine-6-carboxylic acid dimethylamide

Orthophosphoric acid (85 weight-%, 15 ml) was heated to 80° C. and 8-hydroxy-7-[3-hydroxy-3-(2-methylphenyl)-propyl]-2,3-dimethyl-imidazo[1,2-a]pyridine-6-carboxylic acid dimethylamide (3.2 g, crude product from example xxviii) was added portionwise. After a reaction time of 25 minutes, the hot solution was poured onto ice water (100 ml) and dichloromethane (100 ml). The pH-value of the biphasic mixture was adjusted to 6.5 by addition of 6 N sodium hydroxide solution. The phases were separated and the aqueous phase was extracted with dichloromethane (2×50 ml). The combined organic phases were dried over sodium sulfate and concentrated under reduced pressure. The crude product was purified by flash chromatography [silica gel, eluant: ethyl acetate/methanol=9:1 (v/v)] and 888 mg of the title compound were isolated (46% yield over two steps).

Melting point: 198° C.

¹H-NMR (CDCl₃, 200 MHz): δ=2.18 (m_{c}, 2H), 2.36, 2.37, 2.40 (3s, 9H), 2.78, 2.99 (m_{c}, s, 5H), 3.15 (s, 3H), 5.42 (dd, 1H), 7.20 (m_{c}, 3H), 7.43 (s, 1H), 7.56 (m_{c}, 1H).

xxx. 7-[3-(2-Fluorophenyl-3-hydroxy-propyl]-8-hydroxy-2,3-dimethyl-imidazo[1,2-a]pyridine-6-carboxylic acid dimethylamide

7-[3-(2-Fluorophenyl)-3-oxo-propyl]-8-hydroxy-2,3-dimethyl-imidazo[1,2-a]pyridine-6-carboxylic acid dimethylamide (example xxxviii, 2.00 g, 5.2 mmol) was suspended in dry ethanol (70 ml) and sodium borohydride (200 mg, 5.3 mmol) was added in small portions. The reaction mixture, a yellow solution, was stirred for 30 minutes at room temperature and was then poured onto a mixture of saturated ammonium chloride solution (50 ml) and dichloromethane (100 ml). The phases were separated and the aqueous phase was extracted with dichloromethane (30 ml). The combined organic phases were dried over sodium sulfate and concentrated under reduced pressure. The crude title compound was dried in vacuo (2.1 g of a colourless solid) and was directly used as starting material for example xxxi.

¹H-NMR (CDCl₃, 200 MHz): δ=1.90 (m_{c}, 2H), 2.35, 2.56 (2s, 6H), 2.80, 2.95 (bs, s, 4H), 3.14 (s, 3H), 3.35 (m_{c}, 1H), 4.90 (dd, 1H), 6.88 (m_{c}, 1H), 7.09, 7.14 (m_{c}, s, 3H), 7.59 (m_{c}, 1H).

xxxi. 9-2-Fluorophenyl)-2,3-dimethyl-7H-8,9-dihydro-pyrano[2,3-c]-imidazo[1,2-a]pyridine-6-carboxylic acid dimethylamide

7-[3-(2-Fluorophenyl)-3-hydroxy-propyl]-8-hydroxy-2,3-dimethyl-imidazo[1,2-a]pyridine-6-carboxylic acid dimethylamide (2.1 g, crude product from example xxx) was dissolved in orthophosphoric acid (85 weight-%, 20 ml). The suspension was heated at 80° C. (pre-heated oil bath). After a period of 30 minutes a clear solution was obtained. After a reaction time of 1 hour, the hot solution was poured onto ice water (100 ml) and dichloromethane (100 ml). The pH-value of the biphasic mixture was adjusted to 8 by addition of 6 N sodium hydroxide solution. The phases were separated and the aqueous phase was extracted with dichloromethane (2×40 ml). The combined organic phases were dried over sodium sulfate and concentrated under reduced pressure. A slightly yellow foamy solid remained which was dried in vacuo. The title compound was obtained in 94% yield (1.94 g).

Melting point: 203° C.

¹H-NMR (CDCl₃, 200 MHz): δ=2.23, 2.36, 2.41 (m_{c}, 2 s, 8H), 2.61 (m_{c}, 1H), 2.83, 2.95 (m_{c}, s, 4H), 3.14 (s, 3H), 5.60 (dd, 1H), 7.09 (m_{c}, 2H), 7.27 (m_{c}), 7.44 (s, 1H), 7.60 (dt, 1H).

xxxii. 7-[3-(4-Fluorophenyl)-3-hydroxy-propyl]-8-hydroxy-2,3-dimethyl-imidazo[1,2-a]pyridine carboxylic acid dimethylamide

7-[3-(4-Fluorophenyl)-3-oxo-propyl]-8-hydroxy-2,3-dimethyl-imidazo[1,2-a]pyridine-6-carboxylic acid dimethylamide (example xxxix, 2.24 g, 5.8 mmol) was dissolved in dry ethanol (70 ml) and sodium borohydride (220 mg, 5.8 mmol) was added in small portions. The reaction mixture was stirred for 45 minutes at room temperature and was then poured onto a mixture of saturated ammonium chloride solution (50 ml) and dichloromethane (100 ml). The phases were separated and the aqueous phase was extracted with dichloromethane (50 ml). The combined organic phases were dried over sodium sulfate and concentrated under reduced pressure. The crude title compound was dried in vacuo (2.4 g of a colourless solid) and was directly used as starting material for example xxxiii.

¹H-NMR (CDCl₃+traces of MeOD, 200 MHz): δ=1.97 (bm_{c}, 2H), 2.35 (s, 3H), 2.56 (s, 3H), 2.92, 3.14, 3.20 (2s, bm_{c}, 8H), 4.55 (dd, 1H), 6.92 (t, 2H), 7.17 (s, 1H), 7.29 (m_{c}, 2H).

xxxiii. 9-(4-Fluorophenyl)-2,3-dimethyl-7H-8,9-dihydro-pyrano[2,3-c]-imidazo[1,2-a]pyridine-6-carboxylic acid dimethylamide

7-[3-(4-Fluorophenyl)-3-hydroxy-propyl]-8-hydroxy-2,3-dimethyl-imidazo[1,2-a]pyridine-6-carboxylic acid dimethylamide (2.4 g, crude product from example xxxii) was dissolved in orthophosphoric acid (85 weight-%, 20 ml). The suspension was heated at 80° C. (pre-heated oil bath). After a period of 30 minutes a clear solution was obtained. After a reaction time of 1 hour, the hot solution was poured onto ice water (100 ml) and dichloromethane (100 ml). The pH-value of the biphasic mixture was adjusted to 8 by addition of 6 N sodium hydroxide solution. The phases were separated and the aqueous phase was extracted with dichloromethane (2×40 ml). The combined organic phases were dried over sodium sulfate and concentrated under reduced pressure. A colourless solid remained which was dried in vacuo. The title compound was obtained in 85% yield (1.94 g).

Melting point: 260° C.

¹H-NMR (CDCl₃, 200 MHz): δ=2.24 (m_{c}, 2H), 2.36, 2.41 (2s, 6H), 2.68 (m_{c}, 2H), 2.93, 3.13 (2s, 6H), 5.27 (dd, 1H), 7.04 (t, 2H), 7.43 (m_{c}, 3H).

xxxiv. 8-Hydroxy-7-(3-hydroxy-3-thiophen-2-yl-propyl)-2,3-dimethyl-imidazo[1,2-a]pyridine-6-carboxylic acid dimethylamide

8-Hydroxy-2,3-dimethyl-7-[3-oxo-3-thiophen-2-yl-propyl]-imidazo[1,2-a]pyridine-6-carboxylic acid dimethylamide (example xl, 2.00 g, 5.4 mmol) was suspended in dry ethanol (70 ml) and sodium borohydride (250 mg, 6.6 mmol) was added in small portions. A brown solution was obtained which was stirred for 2 hours at room temperature and was then poured onto a mixture of saturated ammonium chloride solution (50 ml) and dichloromethane (100 ml). The phases were separated and the aqueous phase was extracted with dichloromethane (30 ml). The combined organic phases were dried over sodium sulfate and concentrated under reduced pressure. The crude title compound was dried in vacuo (2.0 g of a beige solid) and was directly used as starting material for example xxxv.

¹H-NMR (CDCl₃, 200 MHz): δ=2.09 (bs, 2H), 2.31 (s, 3H), 2.48 (bs, 4H), 2.91, 3.14 (2s, 6H), 3.33 (bs, 1H), 4.80 (t, 1H), 6.70 (bs), 6.89 (m_{c}, 2H), 7.11 (m_{c}, 2H).

xxxv. 2,3-Dimethyl-9-thiophen-2-yl-7H-8,9-dihydro-pyrano[2,3-c]-imidazo[1,2-a]pyridine-6-carboxylic acid dimethylamide

In a flame-dried flask filled with argon, 8-Hydroxy-7-(3-hydroxy-3-thiophen-2-yl-propyl)-2,3-dimethyl-imidazo[1,2-a]pyridine-6-carboxylic acid dimethylamide (2.0 g, crude product from example xxxiv) was suspended in dry THF (25 ml). After addition of triphenylphosphine (2.80 g, 10.7 mmol) and dropwise addition of DIAD (1.63 g, 8.1 mmol) a brown solution was obtained, which was stirred for 15 minutes at room temperature. The reaction mixture was concentrated under reduced pressure and the residue (8 g of a brown oil) was purified by flash chromatography [260 g of silica gel, eluant: ethyl acetate, then ethyl acetate/methanol=100:1 and 100:2 (v/v)]. A colourless solid was obtained (661 mg of the pure title compound, 35% yield)

Melting point: 241° C.

¹H-NMR (dmso-d₆, 200 MHz): d=2.25, 2.26, 2.34 (s, m_{c}, s, 8H), 2.53 (m_{c}), 2.73, 2.87 (m_{c}, s, 4H), 3.01 (s, 3H), 5.56 (dd, 1H), 7.08 (dd, 1H), 7.23 (bd, 1H), 7.57 (dd, 1H), 7.79 (s, 1H).

### Synthesis of Prochiral Ketones

xxxvi. 8-Hydroxy-2,3-dimethyl-7-(3-oxo-3-phenyl-propyl)-imidazo[1,2-a]pyridine-6-carboxylic acid dimethylamide

(a) In a flame-dried flask filled with argon, a suspension of the alcohol 8-hydroxy-2,3-dimethyl-imidazo[1,2-a]pyridine-6-carboxylic acid dimethylamide (synthesis described in WO 03/014123, 50.0 g, 214 mmol) in dry dichloromethane (1.2 l) was treated with N,N-dimethylmethyleneiminium iodide (40.3 g, 218 mmol). The reaction mixture was stirred for 1 hour at room temperature. In the beginning, a clear solution was obtained, within 10 minutes the formation of a precipitate was observed. The solvent was then removed under reduced pressure.

(b) The rotary evaporator was filled with argon, the colourless solid (7-dimethylaminomethyl-6-dimethylcarbamoyl-8-hydroxy-2,3-dimethyl-imidazo[1,2-a]pyridin-1-ium iodide) was dried in vacuo, and was dissolved in dry DMF (1.1 l) which had been pre-heated to 50° C. An almost clear solution was obtained, which was treated with potassium carbonate (30.4 g, 220 mmol) and 1-(1-phenyl-vinyl)-pyrrolidine (CAS 3433-56-5, 82.5 g, purity: 90 weight-%, 428 mmol). In a pre-heated oil bath, the brown solution was stirred for 30 minutes at 50° C. and was then poured onto a stirred mixture of ammonium chloride (130 g), water (200 ml), ice (300 g), and dichloromethane (600 ml). Stirring was continued for several minutes and the pH-value was adjusted to pH=8 by addition of 6 N hydrochloric acid. The phases were separated and the aqueous phase was extracted with dichloromethane (3×100 ml). The combined organic phases were washed with water (2×100 ml), dried over sodium sulfate and concentrated under reduced pressure (DMF was removed at a temperature of 60° C). A darkbrown oily residue (80 g) was obtained which was dried in vacuo.

(c) The residue (crude title compound) was purified by filtration over silica gel [500 g, eluant: ethyl acetate (removal of acetophenone formed by cleavage of excess enamine), then ethyl acetate/methanol=8:2 (v/v)]. A red-brown solid was isolated (60 g of crude title compound, HPLC-purity: 88.08%) which was dried in vacuo, dissolved in methanol (200 ml), and treated with fumaric acid (25.5 g, 220 mmol). The brown suspension was stirred for 20 minutes at 40° C., at which point a clear solution was obtained. The solution was concentrated under reduced pressure until a dense suspension was formed. Acetone (120 ml) was added and the mixture was concentrated again until a dense suspension was formed. The slurry was diluted with acetone (150 ml) and was stirred at 40° C. (30 minutes), room temperature (19 hours), and at 0° C. (2 hours). The precipitate, which was formed, was removed by filtration, washed with acetone (20 ml) and diethyl ether (50 ml), and dried in vacuo. A colourless solid (51 g, 49% yield, melting point: 196-198° C.) was obtained which was characterized by ¹H-NMR spectroscopy as the salt of the title compound and fumaric acid in a molar ratio of 1:1.

(d) The salt of the title compound and fumaric acid (50 g, 104 mmol) was added portionwise to a mixture of sodium bicarbonate (42 g, 500 mmol), water (400 ml), and dichloromethane (400 ml). The biphasic mixture was stirred for 5 minutes. The phases were separated and the aqueous phase was extracted with dichloromethane (2×50 ml). The organic phases were washed with water (2×100 ml), dried over sodium sulfate, and concentrated under reduced pressure. A colourless, foamy solid was isolated, which was characterized as the title compound (37.7 g, 99% yield, 49% overall yield). The sample was pure by means of ¹H-NMR spectroscopy and showed an HPLC purity of 99.07% (RT=9.4 min). It was dried in vacuo (phosphorus pentoxide, 1 day).

Melting point: 115-117° C.

¹H-NMR (CDCl₃, 200 MHz): δ=2.32, 2.37 (2s, 6H), 2.95 (s), 3.05 (bs), 3.14 (s, Σ8H), 3.42 (m_{c}, 2H), 7.29 (s, 1H), 7.47 (m_{c}, 3H), 8.00 (m_{c}, 2H).

xxvii. 8-Hydroxy-2,3-dimethyl-7-[3-(2-mothylphenyl)-3-oxo-propyl]-imidazo[1,2-a]pyridine-6-carboxylic acid dimethylamide

(a) In a flame-dried flask filled with argon, a suspension of the alcohol 8-hydroxy-2,3-dimethyl-imidazo[1,2-a]pyridine-6-carboxylic acid dimethylamide (15.0 g, 64 mmol) in dry dichloromethane (500 ml) was treated with N,N-dimethylmethyleneiminium iodide (11.9 g, 64 mmol). The reaction mixture was stirred for 1.5 hours at room temperature. The solvent was removed under reduced pressure and a yellow solid was isolated.

(b) The crude 7-dimethylaminomethyl-6-dimethylcarbamoyl-8-hydroxy-2,3-dimethyl-imidazo[1,2-a]pyridin-1-ium iodide prepared in (a) was dissolved in dry DMF (300 ml). After addition of potassium carbonate (8.9 g, 64 mmol) a clear solution was obtained, which was treated with 1-[1-(2-methylphenyl)-vinyl]-pyrrolidine (CAS 156004-72-7, 36.5 g, 195 mmol). In a pre-heated oil bath, the brown solution was stirred for 4 hours at 50° C. and was then poured onto a mixture of ice water (400 ml) and dichloromethane (400 ml). The pH-value was adjusted to pH 7 by addition of 6 N hydrochloric acid. The phases were separated and the aqueous phase was extracted with dichloromethane (2×200 ml). The combined organic phases were dried over sodium sulfate and concentrated under reduced pressure (DMF was removed at a temperature of 60° C.). A dark-brown oily residue (45 g) was obtained.

(c) The residue (crude title compound) was purified by filtration over silica gel [600 g, eluant: ethyl acetate (removal of o-methyl-acetophenone formed by cleavage of excess enamine), then ethyl acetate/methanol=8:2 (v/v)]. Two batches of the title compound were isolated (8.65 g of a brown oil/19.81 g of a brown foamy solid) which were purified separately. The substances were dissolved in methanol (100 ml/200 ml) and stirred at 50° C. until a clear solution was obtained (approximately 10 minutes). Solutions of fumaric acid (4.76 g, 41.0 mmol/10.90 g, 94.0 mmol) in methanol (100 ml/200 ml) were added and stirring was continued for 10 minutes. The solutions were concentrated under reduced pressure, acetone (50 ml/100 ml) was added to the brown crystalline residues and the mixtures were stirred for 19 hours at room temperature. The precipitates, which were formed, were removed by filtration, washed with diethyl ether (20 ml/50 ml), and dried in vacuo. Beige solids (6.10 g/19.87 g, 51+29% yield) were obtained which were characterized by ¹H-NMR spectroscopy as the salt of the title compound and fumaric acid in a molar ratio of 1:2.

(d) The salts of the title compound and fumaric acid (6.10, 18.8 mmol/19.87 g, 32.5 mmol) were added portionwise to mixtures of saturated sodium bicarbonate solution (100 ml/200 ml) and dichloromethane (100 ml/200 ml). The phases were separated and the aqueous phase was extracted with dichloromethane (50 ml/100 ml). The organic phases were dried over sodium sulfate, and concentrated under reduced pressure. Foamy solids were isolated, which were suspended in diethyl ether (50 ml/100 ml). After a period of 30 minutes/15 minutes, the precipitates were isolated by filtration, washed with diethyl ether (20 ml/50 ml) and dried in vacuo. Two batches of the tide compound were isolated: 2.63 g of a colourless solid [11% yield, HPLC purity: 97.3% (RT=10.7 min)] and 10.4 g of a colourless solid [43% yield, HPLC purity: 99.6% (RT=10.7 min)].

Melting point: 179-180° C./182-183° C. (diethyl ether)

¹H-NMR (dmso-d₆, 200 MHz): δ=2.32, 2.35, 2.41 (3s, 9H), 2.79, 2.88 (m_{c}, s, 5H), 3.01, 3.08 (s, m_{c}, 5H), 5.45 (bs), 7.37 (m_{c}, 3H), 7.71 (m_{c}, 2H).

xxxviii. 7-[3-(2-Fluorophenyl)-3-oxo-propyl]-8-hydroxy-2,3-dimethyl-imidazo1,2-a]pyridine-6-carboxylic acid dimethylamide

(a) In a flame-dried flask filled with argon, a suspension of the alcohol 8-hydroxy-2,3-dimethyl-imidazo[1,2-a]pyridine-6-carboxylic acid dimethylamide (25.0 g, 107 mmol) in dry dichloromethane (1 l) was treated with N,N-dimethylmethyleneiminium iodide (19.8 g, 107 mmol). The reaction mixture was stirred for 1.5 hours at room temperature. In the beginning, a clear solution was obtained, after 30 minutes the formation of a precipitate was observed. The solvent was then removed under reduced pressure.

(b) The rotary evaporator was filled with argon and the slightly yellow solid (7-dimethylaminomethyl-6-dimethylcarbamoyl-8-hydroxy-2,3-dimethyl-imidazo[1,2-a]pyridin-1-ium iodide) was dissolved in dry DMF (600 ml) which had been pre-heated to 50° C. After addition of potassium carbonate (5.9 g, 107 mmol) a clear solution was obtained, which was treated with 1-[1-(2-fluorophenyl)-vinyl]-pyrrolidine (CAS 237436-15-6, 53.2 g, 278 mmol, purity: 80 mol-%). In a pre-heated oil bath, the brown solution was stirred for 2 hours at 50° C. and was then poured onto a mixture of ice water (600 ml) and dichloromethane (500 ml). The pH-value was adjusted to pH=7 by addition of 6 N hydrochloric acid. The phases were separated and the aqueous phase was extracted with dichloromethane (2×300 ml). The combined organic phases were dried over sodium sulfate and concentrated under reduced pressure (DMF was removed at a temperature of 60° C.). A dark-brown oily residue (72 g) was obtained.

(c) The residue (crude title compound) was purified by filtration over silica gel [800 g, eluant: ethyl acetate (removal of o-fluoro-acetophenone formed by cleavage of excess enamine), then ethyl acetate/methanol=8:2 (v/v)]. A brown solid was isolated (39 g of crude tide compound) which was dissolved in methanol (800 ml), and treated with a solution of fumaric acid (21.3 g, 183 mmol) in methanol (500 ml). The brown solution was stirred for 10 minutes at 50° C. The solvent was evaporated, acetone (120 ml) was added to the brown solid residue, and the mixture was stirred for 19 hours at room temperature and for 2 hours at 0° C. The precipitate, which was formed, was removed by filtration, washed with diethyl ether (50 ml), and dried in vacuo. A colourless solid (45.9 g, 59% yield) was obtained which was characterized by ¹H-NMR spectroscopy as the salt of the title compound and fumaric acid in a molar ratio of 1:3.

(d) The salt of the title compound and fumaric acid (45.9 g, 63 mmol) was added portionwise to a stirred mixture of dichloromethane (500 ml) and saturated sodium bicarbonate solution (400 ml). The biphasic mixture was stirred until the solid had completely dissolved (approximately 15 minutes). The phases were separated and the aqueous phase was extracted with dichloromethane (100 ml). The organic phases were dried over sodium sulfate, and concentrated under reduced pressure. A slightly green foamy solid was isolated (23 g), which was suspended in diethyl ether (200 ml). After the suspension had been stirred for 2 hours at room temperature, the precipitate was isolated by filtration and dried in vacuo. The title compound was isolated in the form of a beige solid (21.0 g, 51% overall yield). The sample was pure by means of ¹H-NMR spectroscopy and showed an HPLC purity of 98.12% (RT=9.4 min).

Melting point: 196° C.

¹H-NMR (dmso-d₆, 200 MHz): δ=2.32, 2.35 (2s, 6H), 2.89 (bm_{c}, s, 5H), 2.99 (s, 3H), 3.18 (bm_{c}, 2H), 5.48 (bs), 7.33 (m_{c}, 2H), 7.65, 7.69 (m_{c}, s, 2H), 7.81 (dt, 1H).

xxxix. 7-[3-(4-Fluorophenyl)-3-oxo-propyl]-8-hydroxy-2,3-dimethyl-imidazo[1,2-a]pyridine-6-carboxylic acid dimethylamide

(a) In a flame-dried flask filled with argon, a suspension of the alcohol 8-hydroxy-2,3-dimethyl-imidazo[1,2-a]pyridine-6-carboxylic acid dimethylamide (10.0 g, 43 mmol) in dry dichloromethane (500 ml) was treated with N,N-dimethylmethyleneiminium iodide (7.9 g, 43 mmol). The reaction mixture was stirred for 1.5 hours at room temperature. In the beginning, a clear solution was obtained, after 30 minutes the formation of a precipitate was observed. The solvent was then removed under reduced pressure.

(b) The rotary evaporator was filled with argon and the slightly yellow solid (7-dimethylaminomethyl-6-dimethylcarbamoyl-8-hydroxy-2,3-dimethyl-imidazo[1,2-a]pyridin-1-ium iodide) was dissolved in dry DMF (300 ml) which had been pre-heated to 50° C. After addition of potassium carbonate (5.9 g, 43 mmol) a clear solution was obtained, which was treated with 1-[1-(4-fluorophenyl)-vinyl]-pyrrolidine (CAS 237436-54-3, 18.9 g, 99 mmol). In a pre-heated oil bath, the brown solution was stirred for 2 hours at 50° C. and was then poured onto a mixture of ice water (300 ml) and dichloromethane (300 ml). The pH-value was adjusted to pH=7 by addition of 6 N hydrochloric acid. The phases were separated and the aqueous phase was extracted with dichloromethane (2×200 ml). The combined organic phases were dried over sodium sulfate and concentrated under reduced pressure (DMF was removed at a temperature of 60° C.). A dark-brown oily residue (28.8 g) was obtained.

(c) The residue (crude title compound) was purified by filtration over silica gel [600 g, eluant: ethyl acetate (removal of p-fluoro-acetophenone formed by cleavage of excess enamine), then ethyl acetate/methanol=7:3 (v/v)]. A brown solid was isolated (152 g of crude title compound) which was dissolved in methanol (400 ml), and treated with fumaric acid (8.3 g, 72 mmol). The brown suspension was stirred for 15 minutes at 50° C. and more methanol (400 ml) was added. Stirring was continued for 30 minutes at 50° C., at which point a clear solution was obtained. The solvent was evaporated, acetone (80 ml) was added to the brown solid residue, and the mixture was stirred for 19 hours at room temperature and for 2 hours at 0° C. The precipitate, which was formed, was removed by filtration, washed with diethyl ether (30 ml), and dried in vacuo. A colourless solid (16.2 g, 52% yield) was obtained which was characterized by ¹H-NMR spectroscopy as the salt of the title compound and fumaric acid in a molar ratio of 1:3.

(d) The salt of the title compound and fumaric acid (16.2 g, 22 mmol) was treated with a mixture of dichloromethane (200 ml) and saturated sodium bicarbonate solution (200 ml). The biphasic mixture was stirred until the solid had completely dissolved (approximately 15 minutes). The phases were separated and the aqueous phase was extracted with dichloromethane (2×30 ml). The organic phases were dried over sodium sulfate and concentrated under reduced pressure. A beige foamy solid was isolated (8.4 g), which was suspended in diethyl ether (100 ml). After the suspension had been stirred for 1 hour at room temperature, the precipitate was isolated by filtration and dried in vacuo. The title compound was isolated in the form of a beige solid (7.53 g, 46% overall yield). The sample was pure by means of ¹H-NMR spectroscopy and showed an HPLC purity of 97.83% (RT=9.9 min).

Melting point: 221° C.

¹H-NMR (dmso-d₆, 200 MHz): δ=2.32, 2.35 (2s, 6H), 2.85, 2.88 (m_{c}, s, 5H), 3.00 (s, 3H), 3.19 t, 2H), 6.42 (bs, 1H), 7.34 (t, 2H), 7.70 (s, 1H), 8.05 (q, 2H).

xl. 8-Hydroxy-2,3-dimethyl-7-(3-oxo-3-thiophen-2-yl-propyl)-imidazo[1,2-a]pyridine-6-carboxylic acid dimethylamide

(a) 7-Dimethylaminomethyl-8-hydroxy-2,3-dimethyl-imidazo[1,2-a]pyridine-6-carboxylic acid dimethylamide can be prepared by reaction of 8-hydroxy-2,3-dimethyl-imidazo[1,2-a]pyridine-6-carboxylic acid dimethylamide with N,N-dimethylmethyleneiminium iodide in dichloromethane as described above if the reaction mixture is quenched with saturated sodium bicarbonate solution rather than evaporated to dryness.

(a) Crude 7-dimethylaminomethyl-8-hydroxy-2,3-dimethyl-imidazo[1,2-a]pyridine-6-carboxylic acid dimethylamide (18.8 g, 65 mmol) was dissolved in dry DMF (400 ml). After addition of potassium carbonate (8.9 g, 64 mmol) a clear solution was obtained, which was treated with 1-[1-thiophen-2-yl-vinyl]-pyrrolidine (prepared from 2-acetylthiophene and pyrrolidine by titanium tetrachloride-mediated condensation, see J. Org. Chem. 1967, 32, 213-214, 27.1 g, 151 mmol). In a pre-heated oil bath, the brown solution was stirred for 4 hours at 50° C. and was then poured onto a mixture of ice water (500 ml) and dichloromethane (400 ml). The pH-value was adjusted to pH=7 by addition of 6 N hydrochloric acid. The phases were separated and the aqueous phase was extracted with dichloromethane (3×200 ml). The combined organic phases were washed with water (200 ml), dried over sodium sulfate, and concentrated under reduced pressure (DMF was removed at a temperature of 60° C.). An oily residue (30 g) was obtained.

(b) The residue (crude title compound) was purified by filtration over silica gel [600 g, eluant: ethyl acetate (removal of 2-acetylthiophene formed by cleavage of excess enamine), then ethyl acetate/methanol=82 (v/v)]. A light-brown solid was isolated (14.5 g of crude title compound) which was dissolved in hot methanol (300 ml). After a period of 10 minutes, a solution of fumaric acid (8.2 g, 70 mmol) in methanol (200 ml) was added. Stirring was continued for 10 minutes at 50° C. and the solvent was evaporated. The solid residue was suspended in acetone (100 ml) and the mixture was stirred for 17 hours at room temperature. The precipitate was removed by filtration, washed with diethyl ether (30 ml), and dried in vacuo. A colourless solid (18.7 g, 53% yield) was obtained which was characterized by ¹H-NMR spectroscopy as the salt of the title compound and fumaric acid in a molar ratio of 1:1.5.

(c) The salt of the title compound and fumaric acid (18.7 g, 34 mmol) was added portionwise to a mixture of dichloromethane (250 ml) and saturated sodium bicarbonate solution (100 ml). The biphasic mixture was stirred until the solid had completely dissolved. The phases were separated and the aqueous phase was extracted with dichloromethane (50 ml). The organic phases were dried over sodium sulfate, and concentrated under reduced pressure. A slightly brown solid was isolated (11 g), which was suspended in diethyl ether (60 ml). After the suspension had been stirred for 2 hours at room temperature, the precipitate was isolated by filtration and dried in vacuo. The title compound was isolated in the form of a beige solid (10.7 g, 45% overall yield). The sample was pure by means of ¹H-NMR spectroscopy and showed an HPLC purity of 99.04% (RT=8.3 min).

Melting point: 234° C.(diethyl ether)

¹H-NMR (dmso-d₆, 200 MHz): δ=2.32, 2.36 (2s, 6H), 2.81, 2.89 (m_{c}, s, 5H), 3.01 (s, 3H), 3.14 (t, 2H), 5.85 (bs), 7.24 (dd, 1H), 7.71 (s, 1H), 7.93 (dd, 1H), 8.00 (dd, 1H).

xli. Ethyl 8-hydroxy-2,3-dimethyl-7-(3-oxo-3-phenyl-propyl)-imidazo[1,2-a]pyridine-6-carboxylate

(a) In a flame-dried flask filled with argon, a suspension of the alcohol ethyl 8-hydroxy-2,3-dimethyl-imidazo[1,2-a]pyridine-6-carboxylate (17.0 g, 73 mmol) in dry dichloromethane (550 ml) was treated with N,N-dimethylmethyleneiminium iodide (13.5 g, 73 mmol). The reaction mixture was stirred for 70 minutes at room temperature. In the beginning, a clear solution was obtained, within 30 minutes the formation of a precipitate was observed. The solvent was then removed under reduced pressure.

(b) The rotary evaporator was filled with argon, the colourless solid (7-dimethylaminomethyl-6-ethoxycarbonyl-8-hydroxy-2,3-dimethyl-imidazo[1,2-a]pyridin-1-ium iodide) was dissolved in dry DMF (350 ml) which had been pre-heated to 50° C. After addition of potassium carbonate (10.0 g, 72 mmol) and 1-(1-phenyl-vinyl)-pyrrolidine (CAS 3433-56-5, 28.0 g, purity: 90 weight-%, 145 mmol) gradually an almost clear solution was obtained. In a pre-heated oil bath, the reaction mixture was stirred for 90 minutes at 50° C. and was then poured onto a stirred mixture of ice water (200 ml) and dichloromethane (350 ml). The pH-value was adjusted to pH=7 by addition of 6 N hydrochloric acid. The phases were separated and the aqueous phase was extracted with dichloromethane (3×40 ml). The combined organic phases were washed with water (2×50 ml), dried over sodium sulfate, and concentrated under reduced pressure (DMF was removed at a temperature of 70° C.). A dark-brown oily residue (40 g) was obtained.

(c) The residue (crude title compound) was purified by filtration over silica gel [400 g, eluant: ethyl acetate (removal of acetophenone formed by cleavage of excess enamine), then ethyl acetate/methanol=8:2 (v/v)]. A brown solid was isolated (31 g of crude title compound, HPLC-purity: 74.05%) which was dried in vacuo, dissolved in methanol (300 ml), and treated with fumaric acid (16.0 g, 138 mmol). The brown suspension was stirred for at 40° C. and gradually a clear solution was obtained which was concentrated under reduced pressure to a volume of 20 ml. Acetone (200 ml) was added and the mixture was concentrated again to a volume of 20 ml. The slurry was diluted with acetone (120 ml) and was stirred at room temperature (19 hours) and 0° C. (2 hours). The precipitate, which was formed, was removed by filtration, washed with acetone (20 ml) and diethyl ether (25 ml), and dried in vacuo. A colourless solid (20.0 g, 65% yield, melting point: 192-194° C., HPLC-purity: 93.92%) was obtained which was characterized by ¹H-NMR spectroscopy as the salt of the title compound and fumaric acid in a molar ratio of 2:1.

(d) The salt of the title compound and fumaric acid (19.5 g, 46 mmol) was added portionwise to a mixture of water (200 ml), sodium bicarbonate (20.0 g, 238 mmol), and dichloromethane (250 ml). The biphasic mixture was stirred for 5 minutes. The phases were separated and the aqueous phase was extracted with dichloromethane (2×20 ml). The organic phases were washed with water (2×30 ml), dried over sodium sulfate, and concentrated under reduced pressure. A colourless solid was isolated, which was characterized as the title compound (16.5 g, 98% yield, 64% overall yield). The sample (HPLC purity: 94.26%) contained untransformed starting material and was further purified by flash chromatography [400 g of silica gel, eluant: dichloromethane/methanol=100:2 (v/v)]. The title compound (14.5 g, 55% yield) was obtained in the form of an almost colourless solid, which showed an HPLC purity of 98.33% (RT=14.1 min).

Melting point: 172-174° C.

¹H-NMR (dmso-d₆, 200 MHz): δ=1.29 (t, 3H), 2.34, 2.41 (2s, 6H), 3.23 (s, 4H), 4.29 (q, 2H), 6.30 (bs, 1H), 7.51 (t, 2H), 7.64 (t, 1H), 7.98 (d, 2H), 8.19 (s, 1H).

xlii. Ethyl 9-methoxy-2,3-dimethyl-9-phenyl-7H-8,9-dihydro-pyrano[2,3-c]-imidazo[1,2-a]pyridine-6-carboxylate

2,2-Dimethoxypropane (8.6 g, 10.1 ml, 83 mmol) was added to a solution of ethyl 8-hydroxy-2,3-dimethyl-7-(3-oxo-3-phenyl-propyl)-imidazo[1,2-a]pyridine-6-carboxylate (2.00 g, 5.5 mmol) in dry dichloromethane (25 ml). After slow addition of methanesulfonic acid (0.68 g, 0.46 ml, 7.1 mmol) a dark brown solution was obtained, which was refluxed for 6 hours. The reaction mixture was cooled and poured onto a stirred mixture of saturated sodium bicarbonate solution (25 ml) and dichloromethane (20 ml). The biphasic mixture was stirred for several minutes and the phases were separated. The aqueous phase was extracted with dichloromethane (2×15 ml). The combined organic phase were washed with water (20 ml), dried over sodium sulfate, and concentrated under reduced pressure. The brown residue (3 g) was treated with diethyl ether (15 ml) and the resulting slurry was stirred for 15 minutes. The precipitate was isolated by filtration, washed with diethyl ether (5 ml) and dried in vacuo. The title compound (1.85 g of a colourless solid) was isolated in 88% yield.

Melting point: 184-186° C.

¹H-NMR (dmso-d₆, 200 MHz): δ=1.35 (t, 3H), 1.90 (m_{c}, 1H), 2.34, 2.37, 2.43 (s, m_{c}, s, 7H), 2.99, 3.12 (s, m_{c}, 5H), 4.33 (q, 2H), 7.49 (m, 3H), 7.63 (m_{c}, 2H), 8.36 (s, 1H).

xliii. 9-Methoxy-2,3-dimethyl-9-phenyl-7H-8,9-dihydro-pyrano[2,3-c]-imidazo[1,2-a]pyridine-6-carboxylic acid

To a suspension of ethyl 9-methoxy-2,3-dimethyl-9-phenyl-7H-8,9-dihydro-pyrano[2,3-c]-imidazo[1,2-a]pyridine-6-carboxylate (1.80 g, 4.7 mmol) in methanol (40 ml), an aqueous solution of potassium hydroxide (0.56 g, 10.0 mmol, in 5 ml of water) was added. The resulting red suspension was heated to 55° C. After 30 minutes, a clear solution was obtained which was kept at 55° C. for 90 minutes. The reaction mixture was cooled and concentrated under reduced pressure. The wet residue was dissolved in water (40 ml) and 2 N hydrochloric acid was added to the stirred solution until a pH value of 2 was obtained. Stirring was continued for 1 hour at room temperature and the precipitate, which had been formed, was removed by filtration. The filter cake was washed with water (until the filtrate showed a neutral pH value) and acetone (5 ml) and was dried in vacuo. The title compound was isolated in 97% yield (1.6 g of colourless solid).

Melting point: 240-242° C.

¹H-NMR (dmso-d₆+traces of MeOD, 200 MHz): δ=1.99 (m_{c}, 1H), 2.51 (m_{c}), 3.06 (s, 3H), 3.23 (m_{c}, 2H), 7.52 (m_{c}, 3H), 7.74 (m_{c}, 2H), 8.68 (s, 1H).

xliv. (9-Methoxy-2,3-dimethyl-9-phenyl-7H-8,9-dihydro-pyrano[2,3-c]imidazo[1,2-a]pyridin-6-yl)-pyrrolidin-1-yl methanone

In a flask filled with argon, a suspension of 9-methoxy-2,3-dimethyl-9-phenyl-7H-8,9-dihydro-pyrano[2,3-c]-imidazo[1,2-a]pyridine-6-carboxylic acid (2.00 g, 5.7 mmol) in dry dichloromethane (35 ml) was treated with TBTU (2.10 g, 6.5 mmol). The reaction mixture was refluxed for 2 hours and was then allowed to cool to room temperature. After addition of pyrrolidine (0.43 g, 0.50 ml, 6.0 mmol) a yellow solution was obtained, which was stirred for 1 hour at room temperature. The reaction mixture was poured onto ice water (30 ml) and the stirred biphasic mixture was neutralized by addition of saturated sodium bicarbonate solution. The phases were separated and the aqueous phase was extracted with dichloromethane (2×10 ml). The combined organic phases were washed with water (20 ml), dried over sodium sulfate, and concentrated under reduced pressure. The residue (4 g of a yellow oil) was purified by flash chromatography [90 g of silica gel, eluant: dichloromethane/methanol=100:2 (v/v)]. A colourless foamy solid (1.9 g, 83% yield) was isolated, which was a mixture of the title compound (67 mol-%), benzotriazol-1-ol (22 mol-%), and tetramethylurea (11 weight-%) [as judged from the ¹H-NMR spectrum].

¹H-NMR (dmso-d₆, 200 MHz): δ=1.87, 2.07 (2m_{c}, 5H), 2.36, 2.42 (2s, 6H), 2.55 (m_{c}), 2.69 (tetramethylurea), 2.86, 3.02 (m_{c}, s, 4H), 3.26 (m_{c}), 3.50 (t, 2H), 7.48 (m_{c}, 3H [title compound], 2H [benzotriazol-1-ol]), 7.64, 7.72 (2m_{c}, 2H [title compound], 1H [benzotriazol-1-ol]), 7.98 (d, 1H [benzotriazol-1-ol), 8.11 (s, 1H).

xlv. [8-Hydroxy-2,3-dimethyl-7-(3-oxo-3-phenyl-propyl)-imidazo[1,2-a]pyridin-6-yl]-pyrrolidin-1-yl methanone

A solution of (9-methoxy-2,3-dimethyl-9-phenyl-7H-8,9-dihydro-pyrano[2,3-c]-imidazo[1,2-a]pyridin-6-yl)-pyrrolidin-1-yl methanone (1.80 g, crude product from experiment xliv) in THF (25 ml) was treated with 1 N hydrochloric acid (10 ml) and was heated to 50° C. for 5 hours. The reaction mixture was allowed to cool to room temperature, poured onto a mixture of ice water (25 ml) and dichloromethane (30 ml), and neutralized by addition of 2 N sodium hydroxide solution. The phases were separated and the aqueous phase was extracted with dichloromethane (2×15 ml). The combined organic phases were washed with water (20 ml), dried over sodium sulfate, and concentrated in vacuo. The title compound (1.2 g, HPLC purity: 98.42%) was further purified by flash chromatography [50 g of silica gel, eluant: ethyl acetate/methanol=10:1 (v/v)]. A colourless solid was isolated which was dried in vacuo and identified as the pure title compound (1.03 g, 46% overall yield), HPLC purity: 99.55% (RT=10.9 min).

Melting point: 257-258° C.

¹H-NMR (dmso-d₆, 200 MHz): δ=1.84 (m_{c}, 4H), 2.32, 2.36 (2s, 6H), 2.87 (m_{c}, 2H), 3.24 (m_{c}, 4H), 3.46 (m_{c}, 2H), 6.85 (bs, 1H), 7.52 (t, 2H), 7.64 (t, 1H), 7.77 (s, 1H), 7.96 (d, 2H).

xlvi. 9-Methoxy-2,3-dimethyl-9-phenyl-7H-8,9-dihydro-pyrano[2,3-c]-imidazo[1,2-a]pyridine-6-carboxylic acid methylamide

In a flask filled with argon, a suspension of 9-methoxy-2,3-dimethyl-9-pheryl-7H-8,9-dihydro-pyrano[2,3-c]-imidazo[1,2-a]pyridine-6-carboxylic acid (example xliii, 2.00 g, 5.7 mmol) in dry dichloromethane (35 ml) was treated with TBTU (2.10 g, 6.5 mmol). The reaction mixture was refluxed for 2 hours and was then allowed to cool to room temperature. After addition of methylamine (0.80 ml of a 8 M solution in ethanol, 6.4 mmol) gradually a yellow solution was obtained, which was stirred for 1 hour at room temperature. The reaction mixture was poured onto a mixture of ice water (30 ml) and dichloromethane (10 ml) and the stirred biphasic mixture was neutralized by addition of saturated sodium bicarbonate solution. Stirring was continued for several minutes, the phases were separated, and the aqueous phase was extracted with dichloromethane (2×10 ml). The combined organic phases were washed with water (20 ml), dried over sodium sulfate, and concentrated under reduced pressure. The residue (5 g of a solid) was purified by flash chromatography 100 g of silica gel, eluant: dichloromethane/methanol=100:2 (v/v)]. A colourless foamy solid (2.2 g) was isolated, which was a mixture of the title compound (53 mol-%), benzotriazol-1-ol (39 mol-%) and tetramethylurea (8 mol-%) [as judged from the ¹H-NMR spectrum].

¹H-NMR (dmso-d₆, 200 MHz): δ=1.92 (m_{c}, 1H), 2.39, 2.45 (2s, m_{c}, 7H), 2.69 (tetramethylurea), 2.80 (d, m_{c}, 4H), 3.03, 3.05 (s, m_{c}, 4H), 7.48 (m_{c}, 3H [title compound], 2H [benzotriazol-1-ol]), 7.67, 7.72 (2m_{c}, 2H [title compound], 1H [benzotriazol-1-ol]), 7.99 (d, 1H [benzotriazol-1-ol]), 8.21 (s, 1H), 8.47 (bq, 1H).

xlvii. 8-Hydroxy-2,3-dimethyl-7-(3-oxo-3-phenyl-propyl)-imidazo[1,2-a]pyridine-6-carboxylic acid methylamide

A solution of 9-methoxy-2,3-dimethyl-9-phenyl-7H-8,9-dihydro-pyrano[2,3-c]-imidazo[1,2-a]pyridine-6-carboxylic acid methylamide (2.10 g, crude product from example xlvi) in THF (25 ml) was treated with 1 N hydrochloric acid (10 ml) and was heated to 50° C. for 7 hours. The reaction mixture was stirred at room temperature for 18 hours and was then neutralized by addition of saturated sodium bicarbonate solution. A yellow suspension was obtained which was stirred for 1 hour at room temperature. The precipitate was isolated by filtration, washed with water (20 ml), and dried in vacuo. The pure title compound was isolated in an overall yield of 73% yield (1.45 g of yellow solid), HPLC purity: 99.57% (RT=8.8 min).

Melting point: 284-286° C.(water)

¹H-NMR (dmso-d₆, 200 MHz): δ=2.32, 2.38 (2s, 6H), 2.76 (d, 3H), 2.98 (m_{c}, 2H), 3.25 (m_{c}, 2H), 5.95 (bs, 1H), 7.52 (t, 2H), 7.64 (t, 1H), 7.82 (s, 1H), 7.98 (d, 2H), 8.34 (bq, 1H).

xlviii. (9-Methoxy-2,3-dimethyl-9-phenyl-7H-8,9-dihydro-pyrano[2,3-c]-imidazo[1,2-a]pyridin-6-yl)-methanol

In a flame-dried flask filled with argon, ethyl 9-methoxy-2,3-dimethyl-9-phenyl-7H-8,9-dihydro-pyrano[2,3-c]-imidazo[1,2-a]pyridine-6-carboxylate (example xlii, 3.80 g, 10.0 mmol) was suspended in dry THF (70 ml). At room temperature, lithium aluminium hydride (1.0 g, 26 mmol) was added in small portions over a period of 30 minutes. Stirring was continued for 30 minutes at room temperature and the reaction mixture was poured slowly onto a mixture of saturated ammonium chloride solution (30 ml) and dichloromethane (150 ml). The phases were separated and the aqueous phase was extracted with dichloromethane (4×15 ml). The combined organic phases were washed with water (2×20 ml), dried over sodium sulfate, and concentrated under reduced pressure. The residue, 2.9 g of a yellow solid, was dried in vacuo and characterized as the pure title compound (86% yield). Melting point: 257-258° C.

¹H-NMR (dmso-d₆, 200 MHz): δ=1.91 (m_{c}, 1H), 2.31, 2.35, 2.37 (s, m_{c}, s, 7H), 2.70 (m_{c}, 1H), 2.86 (m_{c}, 1H), 2.98 (s, 3H), 4.53 (s, 2H), 5.19 (bs, 1H), 7.48 (m_{c}, 3H), 7.63 (m_{c}, 2H), 7.75 (s, 1H).

xlix. 6-Chloromethyl-9-methoxy-2,3-dimethyl-9-phenyl-7H-8,9-dihydro-pyrano[2,3-c]-imidazo[1,2-a]pyridine

A suspension of (9-methoxy-2,3-dimethyl-9-phenyl-7H-8,9-dihydro-pyrano[2,3-c]-imidazo[1,2-a]pyridin-6-yl)-methanol (2.20 g, 6.5 mmol) in dry dichloromethane (80 ml) was cooled to 0° C. and thionyl chloride (0.59 ml, 0.96 g, 8.1 mmol) was added slowly. A yellow solution was obtained which was stirred for 1 hour at 0° C. and was then poured onto saturated sodium bicarbonate solution (20 ml). The biphasic mixture was stirred until gas evolution had ceased and the phases were separated. The aqueous phase was extracted with dichloromethane (2×10 ml). The combined organic phases were washed with saturated ammonium chloride solution (20 ml) and water (30 ml), dried over sodium sulfate, and the solvent was evaporated under reduced pressure. A colourless, foamy solid was isolated which was dried in vacuo. The title compound (2.3 g, 99% yield) was used for the next step without further purification.

¹H-NMR (dmso-d₆, 200 MHz): δ=1.93 (m_{c}, 1H), 2.31, 2.38, 2.41 (2s, m_{c}, 7H), 2.82 (m_{c}, 1H), 2.99, 3.02 (s, m_{c}, 4H), 4.89 (dd, 2H), 7.47 (m_{c}, 3H), 7.63 (m_{c}, 2H), 8.10 (s, 1H).

l. 9-Mothoxy-6-methoxymethyl-2,3dimethyl-9-phenyl-7H8,9dihydro-pyrano[2,3-c]- imidazo[1,2-a]pyridine

6-Chloromethyl-9-methoxy-2,3-dimethyl-9-phenyl-7H-8,9-dihydro-pyrano[2,3-c]-imidazo[1,2-a]pyridine (crude product from example xlix, 2.20 g, 6.2 mmol) was dissolved in dry methanol (20 ml). After addition of sodium methylate (solution: 30 weight-% in methanol, 3.0 ml, 17 mmol) a yellow suspension was obtained which was heated to 50° C. Within a period of 90 minutes a yellow solution was formed, which was concentrated to a volume of 10 ml and poured onto a mixture of saturated ammonium chloride solution (15 ml) and dichloromethane (20 ml). A pH-value of 7 was adjusted by addition of 2 N hydrochloric acid and the phases were separated. The aqueous phase was extracted with dichloromethane (2×8 ml). The combined organic phases were washed with water (20 ml), dried over sodium sulfate, and concentrated under reduced pressure. An oily residue was isolated which was dried in vacuo. The title compound (2.1 g of a foamy solid, 98% yield) was used for the next step without further purification.

¹H-NMR (dmso-d₆, 400 MHz): δ=1.92 (m_{c}, 1H), 2.30, 2.37, 2.37 (2s, m_{c}, 7H), 2.70 (m_{c}, 1H), 2.90 (m_{c}, 1H), 2.98 (s, 3H), 3.33 (s), 4.43 (s, 2H), 7.46 (m_{c}, 3H), 7.62 (m_{c}, 2H), 7.82 (s, 1H).

li. 3-(8-Hydroxy-6-methoxymethyl-2,3-dimethyl-imidazo[1,2-a]pyridin-7-yl)-1-phenyl-propan-1-one

A solution of 9-methoxy-6-methoxymethyl-2,3-dimethyl-9-phenyl-7H-8,9-dihydro-pyrano[2,3-c]-imidazo[1,2-a]pyridine (crude product from example l, 2.00 g, 5.7 mmol) in THF (40 ml) was treated with 2 N hydrochloric acid (15 ml). The yellow solution was stirred at room temperature for 19 hours, heated to 50° C. for 2 hours, and poured onto a mixture of water (50 ml) and dichloromethane (100 ml). A neutral pH-value was adjusted by addition of 2 N sodium hydroxide solution and the phases were separated. The aqueous phase was extracted with dichloromethane (2×15 ml). The combined organic phases were washed with water (30 ml), dried over sodium sulfate, and evaporated to dryness. The solid residue (1.9 g) was suspended in acetone (2 ml). After a period of 30 minutes, the precipitate was isolated by filtration, washed with cold acetone (2 ml) and diethyl ether (10 ml), and dried in vacuo. The pure title compound was isolated in 63% yield (1.20 g of a slightly yellow solid), HPLC purity: 98.20% (RT=12.1 min).

Melting point: 167-168° C.(acetone/diethyl ether)

¹H-NMR (dmso-d₆, 200 MHz): δ=2.30, 2.35 (2s, 6H), 2.97 (t, 2H), 3.25, 3.28 (m_{c}, s, 5H), 4.47 (s, 2H), 7.11 (bs), 7.58 (m_{c}, 3H), 7.71 (s, 1H), 7.98 (m_{c}, 2H).

### Asymmetric Reduction of Prochiral Ketones

lii. (3S)-8-Hydroxy-7-(3-hydroxy-3-phenyl-propyl)-2,3-dimethyl-imidazo[1,2-a]pyridine-6-carboxylic acid dimethylamide

In a flame-dried flask filled with argon, the ketone 8-hydroxy-2,3-dimethyl-7-(3-oxo-3-phenyl-propyl)-imidazo[1,2-a]pyridine-6-carboxylic acid dimethylamide (example xxxvi, 5.00 g, 13.7 mmol) was suspended in dry isopropanol (400 ml), which had been degassed with argon. After addition of potassium tert-butylate (1.85 g, 15.1 mmol), a yellow solution was obtained which was treated with the hydrogenation catalyst RuCl₂[(R)-BINAP][(R)-DAIPEN] (CAS 329735-86-6, catalyst is commercially available from Strem Chemicals) (125 mg, 0.11 mmol, S/C=125:1). The red-yellow solution was stirred for 20 minutes at room temperature and was transferred under inert conditions into a 1 l autoclave equipped with a glass inlay. The reaction mixture was pressurized with hydrogen (40 bar) and was stirred for 22 hours at room temperature. The yellow-brown solution was concentrated to a volume of 80 ml. Ice water (80 ml) and dichloromethane (130 ml) was added and a neutral pH-value was adjusted by addition of 2 N hydrochloric acid. The phases were separated and the aqueous phase was extracted with dichloromethane (3×15 ml). The combined organic phases were washed with water (30 ml), dried over sodium sulfate and concentrated under reduced pressure. The residue, a green solid (8 g), was purified by flash chromatography [80 g of silica gel, eluant: dichloromethane/methanol=20:1 (v/v)]. A suspension of the purified title compound in acetone (30 ml) was stirred for several minutes at room temperature. The precipitate was isolated by filtration, washed with acetone (5 ml) and diethyl ether (15 ml), and dried in vacuo. This furnished a colourless solid (4.40 g, 87% yield), which was characterized as the title compound (optical purity: 95.5% ee).

Melting point: 185-187° C. (acetone)

Determination of the optical purity by CE: RT [(3S)-enantiomer]=18.5 min/97.7 area-%; RT [(3R)-enantiomer]=19.0 min/2.3 area-%; 95.5% ee (A).

¹H-NMR (dmso-d₆, 200 MHz): δ=1.81 (m_{c}, 2H), 2.30, 2.33 (2s, 6H), 2.50 (bm_{c}), 2.78, 2.91 (2s, 6H), 4.49 (t, 1H), 5.43 (bs), 7.25 (m_{c}, 5H), 7.59 (s, 1H).

liii. (3R)-8-Hydroxy-7-(3-hydroxy-3-phenyl-propyl)-2,3-dimethyl-imidazo[1,2-a]pyridine-6-carboxylic acid dimethylamide

In a flame-dried flask filled with argon, the ketone 8-hydroxy-2,3-dimethyl-7-(3-oxo-3-phenyl-propyl)-imidazo[1,2-a]pyridine-6-carboxylic acid dimethylamide (example xxxvi, 10.00 g, 27.4 mmol) was suspended in dry isopropanol (400 ml), which had been degassed with argon. After addition of potassium tert-butylate (3.70 g, 30.2 mmol), stirring was continued until a yellow solution was obtained (approximately 30 minutes). The hydrogenation catalyst RuCl₂[(S)-BINAP][(S)-DAIPEN] (CAS 212143-24-3, catalyst is commercially available from Strem Chemicals) (240 mg, 0.21 mmol, S/C=130:1) was added. The resulting red-yellow solution was stirred for 15 minutes at room temperature and was transferred under inert conditions into a 1 l autoclave equipped with a glass inlay. The reaction mixture was pressurized with hydrogen (40 bar) and was stirred for 24 hours at room temperature. The brown solution was concentrated to a volume of 50 ml and was poured onto a cold mixture of saturated ammonium chloride solution (120 ml) and dichloromethane (250 ml). A neutral pH-value was adjusted by addition of 6 N hydrochloric acid. The phases were separated and the aqueous phase was extracted with dichloromethane (2×40 ml). The combined organic phases were washed with water (30 ml), dried over sodium sulfate and concentrated under reduced pressure. The residue, a green oil (15 g), was purified by flash chromatography [150 g of silica gel, eluant: dichloromethane/methanol=20:1 (v/v)]. This furnished a slightly green solid, which was dried in vacuo and characterized as the title compound (9.30 g, 92% yield, optical purity: 85.8% ee).

Melting point: 152-154° C.

Determination of the optical purity by CE: RT [(3S)-enantiomer]=20.2 min/7.1 area-%; RT [(3R-enantiomer]=20.5 min/92.9 area-%; 85.8% ee (A).

liv. (3R)-[8-Hydroxy-7-(3-hydroxy-3-phenyl-propyl)-2,3-dimethyl-imidazo[1,2-a]pyridins-6-yl]-pyrrolidin-1-yl methanone

In a flame-dried flask filled with argon, the ketone [8-hydroxy-2,3-dimethyl-7-(3-oxo-3-phenyl-propyl)-imidazo[1,2-a]pyridin-6-yl]-pyrrolidin-1-yl methanone (example xlv, 1.00 g, 2.6 mmol) was suspended in dry isopropanol (120 ml), which had been degassed with argon. After addition of potassium tert-butylate (0.34 g, 2.8 mmol), a yellow solution was obtained which was treated with the hydrogenation catalyst RuCl₂[(S)-BINAP][(S)-DAIPEN] (CAS 212143-24-3, catalyst is commercially available from Strem Chemicals) (130 mg, 0.12 mmol, S/C=20:1) was added. The resulting mixture was stirred for several minutes at room temperature until the catalyst had dissolved completely and was transferred under inert conditions into a 1 l autoclave equipped with a glass inlay. The reaction mixture was pressurized with hydrogen (40 bar) and was stirred for 22 hours at room temperature. The green solution was concentrated to a volume of 30 ml and was poured onto a mixture of ice water (20 ml) and dichloromethane (40 ml). A neutral pH-value was adjusted by addition of 6 N hydrochloric acid. The phases were separated and the aqueous phase was extracted with dichloromethane (3×10 ml). The combined organic phases were washed with water (20 ml), dried over sodium sulfate, and concentrated under reduced pressure. The green residue (1.8 g), was purified by flash chromatography [80 g of silica gel, eluant: dichloromethane/methanol=100:3 (v/v)]. A suspension of the purified title compound in diethyl ether (10 ml) was stirred for several minutes at room temperature. The precipitate was isolated by filtration, washed with diethyl ether (5 ml), and dried in vacuo. This furnished a slightly green solid (780 mg, 78% yield), which was characterized as the title compound (optical purity: 87.4% ee).

Melting point: 252-254° C.(diethyl ether)

Determination of the optical purity by CE: RT [(3S)-enantiomer]=20.2 min/6.3 area-%; RT [(3R)-enantiomer]=20.4 min/93.7 area-%; 87.4% ee (A).

¹H-NMR (dmso-d₆, 200 MHz): δ=1.77 (m_{c}, 6H), 2.30, 2.33 (2s, 6H), 2.55 (m_{c}), 3.13, 3.34 (2t, 4H), 4.49 (t, 1H), 5.93 (bs), 7.25 (m_{c}, 5H), 7.65 (s, 1H).

lv. (3R)-8-Hydroxy-7-(3-hydroxy-3-phenyl-propyl)-2,3-dimethyl-imidazo[1,2-a]pyridine-6-carboxylic acid methylamide

In a flame-dried flask filled with argon, the ketone 8-hydroxy-2,3-dimethyl-7-(3-oxo-3-phenyl-propyl)-imidazo[1,2-a]pyridine-6-carboxylic acid methylamide (example xlvii, 1.30 g, 3.7 mmol) was suspended in dry isopropanol (120 ml), which had been degassed with argon. After addition of potassium tert-butylate (0.50 g, 4.1 mmol, a thin yellow suspension was obtained which was stirred for 30 minutes at room temperature. More degassed isopropanol (30 ml) was added and the suspension was gently warmed. The hydrogenation catalyst RuCl₂[(S)-BINAP][(S)-DAIPEN] (CAS 212143-24-3, catalyst is commercially available from Strem Chemicals) (80 mg, 0.07 mmol, S/C=50:1) was added. The resulting mixture was stirred for 20 minutes at room temperature until the catalyst had dissolved completely and was transferred under inert conditions into a 1 l autoclave equipped with a glass inlay. The reaction mixture was pressurized with hydrogen (40 bar) and was stirred for 22 hours at room temperature. The green yellow solution was concentrated to a volume of 20 ml and was poured onto a stirred mixture of ice water (25 ml) and dichloromethane (50 ml). A neutral pH-value was adjusted by addition of 6 N hydrochloric acid. The phases were separated and the aqueous phase was extracted with dichloromethane (3×15 ml). The combined organic phases (containing precipitated title compound) were concentrated under reduced pressure. In order to remove traces of water, the green residue was co-evaporated in the presence of dichloromethane (3×). The crude title compound (1.3 g) was purified by crystallization from methanol (75 ml). The suspension was stirred for 18 h at room temperature. The precipitate was isolated by filtration, washed with acetone (10 ml) and diethyl ether (20 ml), and dried in vacuo. This furnished a-colourless solid (1.05 g, 80% yield), which was characterized as the title compound (optical purity: 92.0% ee).

Melting point: 250-252° C. (methanol)

Determination of the optical purity by CE: RT [(3S)-enantiomer]=19.2 min/4.0 area-%; RT [(3R)-enantiomer]=19.6 min/96.0 area-%; 92.0% ee (A).

### Asymmetric Hydroboration of Prochiral Olefins

lvi. (3R)-8-Hydroxy-7-(3-hydroxy-3-phenyl-propyl)-2,3-dimethyl-imidazo[1,2-a]pyridine-6-carboxylic acid dimethylamide

A flame-dried flask filled with argon was charged with (R)-Alpine-boramine™ (CAS 67826-92-0, 1.50 g, 3.6 mmol). After addition of dry THF (8 ml) a colourless solution was obtained, which was treated with boron trifluoride diethyl etherate (0.92 ml, 1.03 g, 7.3 mmol). The solution was stirred for 2 hours at room temperature. A colourless precipitate was obtained which was removed by filtration and washed with cold THF (6 ml, argon atmosphere). The filtrates [containing (−)-monoisopinocampheylborane] were combined. A suspension of (E)-8-hydroxy-2,3-dimethyl-7-(3-phenyl-allyl)-imidazo[1,2-a]pyridine-6-carboxylic acid dimethylamide (example xxiii, 0.42 g, 1.2 mmol) in dry THF (15 ml) was added slowly at room temperature, at which point a yellow solution was obtained. After a reaction time of 5 hours, the solution was poured onto a cold mixture of aqueous potassium hydroxide solution (230 mg in 1.6 ml of water), ethanol (4 ml), and hydrogen peroxide (30 weight-% in water, 1.6 ml). After a period of 30 minutes, the reaction mixture was poured onto saturated ammonium chloride solution (20 ml) and dichloromethane (40 ml). The phases were separated and the aqueous phase was extracted with dichloromethane (1×10 ml). The combined organic phases were washed with water, dried over sodium sulfate, and concentrated under reduced pressure. The crude product (1.9 g of a yellow oil) was purified by flash chromatography [40 g of silica gel, eluant: dichloromethane (to remove isopinocampheol), then dichloromethane/methanol=20:1 (v/v)]. Evaporation of the corresponding fractions furnished a solid (320 mg), which was washed with acetone (1 ml), isolated by filtration, and dried in vacuo. The title compound was isolated in 50% yield (0.22 g of a colourless solid, optical purity: 27.8% ee).

Melting point: 178-180° C. (acetone)

Determination of the optical purity by CE: RT [(3S)-enantiomer]=18.3 min/36.1 area-%; RT [(3R)-enantiomer]=18.6 min/63.9 area-%; 27.8% ee (A).

¹H-NMR (dmso-d₆, 200 MHz): δ=1.81 (m_{c}, 2H), 2.30, 2.33 (2s, 6H), 2.50 (bm_{c}), 2.78, 2.91 (2s, 6H), 4.49 (t, 1H), 5.69 (bs), 7.25 (m_{c}, 5H), 7.59 (s, 1H).

### IV. CONFIGURATIONAL ANALYSIS

The configurational assignment of the compounds of the formula 1 and 2 is based on the method described by J. A. Dale and H. S. Mosher in J. Am. Chem. Soc. 1973, 95, 512-519. The examples below serve to illustrate the method in more detail without limiting it. The configuration of further compounds of the formula 1 and 2 can likewise be analyzed in an analogous manner as shown in a general way in Scheme 8.

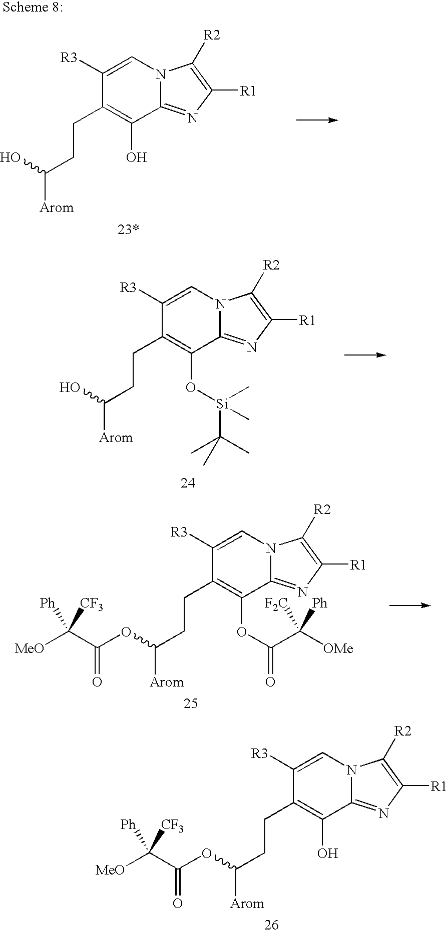

It is well-known that the Mitsunobu reaction proceeds with inversion of configuration (see e. g. O. Mitsunobu Synthesis 1981, 1; D. L. Hughes Org. Prep. Proc. Int. 1996, 28, 127). Specifically, when a chiral secondary alcohol is employed, the substrate undergoes an S_{N}2 displacement with inversion of configuration (see e. g. N. L. Dirlam, B. S. Moore, F. J. Urban J. Org. Chem. 1987, 52, 3587). Thus, the (9S)-enantiomer (compound of the formula 1, example 2) is derived from (3R)-8-hydroxy-7-[3-hydroxy-3-phenyl-propyl]-2,3-dimethyl-imidazo[1,2-a]pyridine-6-carboxylic acid dimethylamide. For the configurational assignment of the enantiomeric diols of 8-hydroxy-7-(3-hydroxy-3-phenyl-propyl)-2,3-dimethyl-imidazo[1,2-a]pyridine-6-carboxylic acid dimethylamide, an enantio-enriched sample obtained by catalytic hydrogenation of the ketone 8-hydroxy-2,3-dimethyl-7-(3-oxo-3-phenyl-propyl)-imidazo[1,2-a]pyridine-6-carboxylic acid dimethylamide [1.2 equivalents of potassium tert-butylate, 2 mol-% of RuCl₂[(S)-BINAP][(S,S)-DPEN], 45 bar hydrogen pressure, isopropanol, 80° C., 18 hours, 82% yield] was treated with tert-butyldimethylchlorosilane (Scheme 8). The enantoselectivity of the catalytic hydrogenation reaction was determined by chiral HPLC separation of the resulting silyl ethers (3S)- and (3R)-8-(tert-butyl-dimethylsilanyloxy)-7-(3-hydroxy-3-phenyl-propyl)-2,3-dimethyl-imidazo[1,2-a]pyridine-6-carboxylic acid dimethylamide, compounds of the formula 24 (with R1, R2=CH₃, R3=(CH₃)₂N—C(O), Arom=phenyl), (7:3 ratio of enantiomers (3R):(3S)). Treatment of the reaction product of the formula 24 with (S)-(+)-MTPACI furnished the diacylated imidazopyridine of the formula 25 (R1, R2=CH₃, R3=(CH₃)₂N—C(O), Arom=phenyl). The phenolic ester group was cleaved and the diasteromeric Mosher esters of the formula 26 (R1, R2=CH₃, R3=(CH₃)₂N—C(O), Arom=phenyl) were obtained in a 7:3 ratio in accordance to the result for the enantiomeric silyl ethers of the formula 24.

[image]

Mosher and coworkers have shown that the conformation depicted in FIG. 1is highly preferred for this class of compounds. In the (3R)-diastereomer of the compound of the formula 26, the methoxy function is located over the Arom radical. The shielding effect of the aromatic electron cloud results in an upfield-shift of the ¹H-NMR signal of the methoxy group as compared to the (3S)-diastereomer. In the ¹H-NMR spectrum of the diastereomeric mixture, the signals of the methoxy groups were observed at 3.43 ppm (major)/3.52 ppm (minor), respectively. Thus, catalytic hydrogenation under the conditions reported above mainly furnishes the (3R)-diol of the formula 23. After Mitsunobu etherification, an enantio-enriched sample of the (9S)-enantiomer of the formula 1 is isolated.

### Experimental Details of the Configurational Analysis

a. 8-Hydroxy-7-(3-hydroxy-3-phenyl-propyl)-2,3-dimethyl-imidazo[1,2-a]pyridine-6-carboxylic acid dimethylamide; Prepared by Asymmetric Catalytic Hydrogenation

The ketone 8-hydroxy-2,3-dimethyl-7-(3-oxo-3-phenyl-propyl)-imidazo[1,2-a]pyridine-6-carboxylic acid dimethylamide (2.00 g, 5.5 mmol), potassium tert-butylate (0.74 g, 6.6 mmol), and the hydrogenation catalyst RuCl₂[(S)-BINAP][(S,S)-DPEN] (CAS 329736-05-2, catalyst is commercially available from Strem Chemicals or can be prepared according to the procedure given by R. Noyori and T. Ohkuma in Angew. Chem. 2001, 113, 40-75, 110 mg, 0.11 mmol, S/C=60:1) were dissolved in dry isopropanol (150 ml) which had been degassed with argon. The homogenous, brown solution was transferred into a 300 ml autoclave, pressurized with hydrogen (45 bar) and heated to 80° C. The reaction mixture was kept at 80° C. for 18 h, cooled to room temperature, and concentrated under reduced pressure. The residue was dissolved in water (50 ml) and the pH-value of the solution was adjusted to 7.5 by addition of 2 N hydrochloric acid (2.4 ml). The aqueous phase was extracted with dichloromethane (3×100 ml). The pH-value was readjusted and the extraction was repeated two more times. The combined organic phases were dried over sodium sulfate and concentrated under reduced pressure. The residue, a green-brown solid, was purified by flash chromatography [100 g of silica gel, eluant: dichloromethane/methanol=15:1 (v/v)]. A grey solid was isolated (1.64 g, 82% yield) which was characterized as the pure diol 8-hydroxy-7-(3-hydroxy-3-phenyl-propyl)-2,3-dimethyl-imidazo[1,2-a]pyridine-6-carboxylic acid dimethylamide. No traces of chemical impurities were visible in the ¹H-NMR spectrum of the compound. A direct determination of the optical purity and the enantiomeric excess of the sample by chiral HPLC was not possible due to extensive peak-tailing.

¹H-NMR (dmso-d₆, 200 MHz): δ=1.81 (m_{c}, 2H), 2.30, 2.33 (2s, 6H), 2.50 (bm_{c}), 2.78, 2.91 (2s, 6H), 4.49 (t, 1H), 7.25 (m_{c}, 5H), 7.59 (s, 1H).

b. 8-(tert-Butyl-dimethylsilanyloxy)-7-(3-hydroxy-3-phenyl-propyl)-2,3-dimethyl-imidazo[1,2-a]pyridine-6-carboxylic acid dimethylamide; Determination of the Enantiomeric Excess Obtained by Asymmetric Reduction of the Ketone

For analytical purposes, the diol 8-hydroxy-7-3-hydroxy-3-phenyl-propyl)-2,3-dimethyl-imidazo[1,2-a]pyridine-6-carboxylic acid dimethylamide (200 mg, 0.54 mmol, product of the asymmetric hydrogenation described in example a) was dissolved in dichloromethane (10 ml). Triethylamine (110 mg, 151 μl, 1.09 mmol) and a solution of tert-butyidimethylchlorosilane (179 mg, 1.19 mmol) in dichloromethane (5 ml) was added. The reaction mixture was heated to reflux for 5.25 hours and was then quenched by addition of saturated ammonium chloride solution (10 ml). The phases were separated and the aqueous phase was extracted with dichloromethane (2×10 ml). The combined organic phases were dried over sodium sulfate and concentrated under reduced pressure. A green oil (296 mg) remained which was purified by flash chromatography (20 g of silica gel, eluant: ethyl acetate). The title compound was isolated in 73% yield (190 mg). No impurities were visible in the ¹H-NMR spectrum of the colourless oil. The following conditions were employed for the determination of the enantomeric excess by chiral HPLC: column: 2 CHIRALPAK® AD-H columns 250×4.6 mm; 5 μm; eluant: isopropanol/hexane=17:83 (v/v), flow rate: 1 ml/min; temperature: 35° C. The (3R)-enantiomer (68.35 area-%) and the (3S)-enantiomer (31.65 area-%) of the title compound were eluted at retention times of 9.97 min/10.60 min, respectively. Thus, the asymmetric catalytic hydrogenation proceeded with 36.7% ee.

¹H-NMR (CDCl₃, 200 MHz): δ=0.33, 0.44 (2s, 6H), 1.02 (s, 9H), 2.00 (m_{c}, 2H), 2.33, 2.37 (2s, 6H), 2.65 (m_{c}, 2H), 2.88, 3.11 (2s, 6H), 4.58 (dd, 1H), 7.26 (m_{c}, 5H), 7.38 (s, 1H).

C. (2R)-3,3,3-Trifluoro-2-methoxy-2-phenyl-propionic acid[3-(6-dimethylcarbamoyl-8-hydroxy-2,3-dimethyl-imidazo[1,2-a]pyridin-7-yl)-(1R,S)-1-phenyl-propyl]ester; configurational Assignment of the Enantiomers of 8-hydroxy-7-(3-hydroxy-3-phenyl-propyl)-2,3-dimethyl-imidazo[1,2-a]pyridine-6-carboxylic acid dimethylamide

(a) In order to determine the absolute configuration of the (3S)- and (3R)-enantiomer of 8-hydroxy-7-(3-hydroxy-3-phenyl-propyl)-2,3-dimethyl-imidazo[1,2-a]pyridine-6-carboxylic acid dimethylamide (example a), (S)-(+)-MTPACI (95 mg, 0.38 mmol) was dissolved in pyridine (810 μl) and carbon tetrachloride (810 μl). A solution of the (3R- and (3S-enantiomers of the silyl ether 8-(tert-butyl-dimethylsilanyloxy)-7-(3-hydroxy-3-phenyl-propyl)-2,3-dimethyl-imidazo[1,2-a]-pyridine-6-carboxylic acid dimethylamide (example b, 100 mg, 0.21 mmol, containing the two enantiomers in a 7:3 ratio) in dichloromethane (500 μl) was added. The reaction mixture was stirred for 6 hours at room temperature and was then diluted with water (5 ml) and chloroform (10 ml). The phases were separated and the aqueous phase was extracted with chloroform (2×10 ml). The organic phases were washed with saturated sodium chloride solution (5 ml), dried over sodium sulfate and concentrated under reduced pressure. The crude product was dried thoroughly and then purified by flash chromatography (10 g of silica gel, eluant: ethyl acetate/petrol ether=7:3). A yellowish oil (50 mg, 30% yield) was isolated which was characterized as the diastereomeric mixture of the diesters of the formula 25 with R1, R2=CH₃, R3=(CH₃)₂N—C(O) and Arom=phenyl.

¹H-NMR (CDCl₃, 200 MHz): δ=2.00-2.60 (bs), 2.34, 2.37 (2s, Σ10H), 2.73 (s, 3H), 2.87, 2.97 (2s, Σ3H), 3.44, 3.48 (2s, Σ3H), 3.79, 3.85 (2s, Σ3H), 5.61 (bt, 1H), 7.30 (m_{c}, 10H), 7.54 (m_{c}, 3H), 7.63 (s, 1H), 8.06 (m_{c}, 2H).

(b) A solution of the diastereomeric mixture of the diesters of the formula 25 with R1, R2=CH₃, R3=(CH₃)₂N—C(O) and Arom=phenyl (42 mg, 0.05 mmol) in deuterated chloroform was allowed to stand for 10 days at room temperature. The solvent was removed under reduced pressure and the crude product was purified by flash chromatography (2×6 g of silica gel, eluant: dichloromethane/methanol=15:1 (v/v)]. A mixture of the diastereomeric esters of the formula 26 with R1, R2=CH₃, R3=(CH₃)₂N—C(O) and Arom=phenyl (22 mg of a colourless foam) was isolated in 72% yield. In the ¹H-NMR spectrum of this compound, two distinct signals for the methoxy group of the acyl moiety were visible. The chemical shift values of the signals corresponding to the major/minor enantiomer were 3.43/3.52 ppm.

¹H-NMR (dmso-d₆, 400 MHz): δ=2.05 (bs, 1H), 2.17 (bs, 1H), 2.29, 2.32 (2s, 6H), 2.48 (bs), 2.71, 2.75 (2s, Σ3H), 2.82, 2.84 (2s, Σ3H), 3.43, 3.52 (2s, Σ3H), 5.98 (m_{c}, 1H), 7.41 (m_{c}, 10H), 7.61, 7.62 (2s, Σ1H).

Based on the method for configurational analysis suggested by Mosher et al. (see above), the major enantiomer of the diol 8-hydroxy-7-(3-hydroxy-3-phenyl-propyl)-2,3-dimethyl-imidazo[1,2-a]pyridine-6-carboxylic acid dimethylamide as prepared above possesses (3R)-configuration.

### Commercial Utility

The compounds of the formula 1 and their salts have valuable pharmacological properties which make them commercially utilizable. In particular, they exhibit marked inhibition of gastric acid secretion and an excellent gastric and intestinal protective action in warm-blooded animals, in particular humans. In this connection, the compounds according to the invention are distinguished by a high selectivity of action, an advantageous duration of action, a particularly good enteral activity, the absence of significant side effects and a large therapeutic range.

“Gastric and intestinal protection” in this connection is understood as meaning the prevention and treatment of gastrointestinal diseases, in particular of gastrointestinal inflammatory diseases and lesions (such as, for example, gastric ulcer, peptic ulcer, including peptic ulcer bleeding, duodenal ulcer, gastritis, hyperacidic or medicament-related functional dyspepsia), which can be caused, for example, by microorganisms (e.g. Helicobacter pylori), bacterial toxins, medicaments (e.g. certain antiinflammatories and antirheumatics, such as NSAIDs and COX-inhibitors), chemicals (e.g. ethanol), gastric acid or stress situations. “Gastric and intestinal protection” is understood to include, according to general knowledge, gastroesophageal reflux disease (GERD), the symptoms of which include, but are not limited to, heartburn and/or acid regurgitation.

In their excellent properties, the compounds according to the invention surprisingly prove to be clearly superior to the compounds known from the prior art in various models in which the antiulcerogenic and the antisecretory properties are determined. On account of these properties, the compounds of the formula 1 and their pharmacologically acceptable salts are outstandingly suitable for use in human and veterinary medicine, where they are used, in particular, for the treatment and/or prophylaxis of disorders of the stomach and/or intestine.

A further subject of the invention are therefore the compounds of the formula 1 according to the invention for use in the treatment and/or prophylaxis of the abovementioned diseases.

A further subject of the invention are the compounds of the formula 1 according to the invention being substantially free of compounds of the formula 2 for use in the treatment and/or prophylaxis of the abovementioned diseases.

The invention likewise includes the use of the compounds of the formula 1 according to the invention for the production of medicaments which are employed for the treatment and/or prophylaxis of the abovementioned diseases.

The invention likewise includes the use of the compounds of the formula 1 according to the invention being substantially free of compounds of the formula 2 for the production of medicaments which are employed for the treatment and/or prophylaxis of the abovementioned diseases.

The invention furthermore includes the use of the compounds according to the invention for the treatment and/or prophylaxis of the abovementioned diseases.

The invention furthermore includes the use of the compounds of the formula 1 according to the invention being substantially free of compounds of the formula 2 for the treatment and/or prophylaxis of the abovementioned diseases.

A further subject of the invention are medicaments which comprise one or more compounds of the formula 1 and/or their pharmacologically acceptable salts.

A further subject of the invention are medicaments which comprise one or more compounds of the formula 1 and/or their pharmacologically acceptable salts which medicaments are substantially free of compounds of the formula 2.

The medicaments are prepared by processes which are known per se and familiar to the person skilled in the art. As medicaments, the pharmacologically active compounds according to the invention (=active compounds) are either employed as such, or preferably in combination with suitable pharmaceutical auxiliaries or excipients in the form of tablets, coated tablets, capsules, suppositories, patches (e.g. as TTS), emulsions, suspensions or solutions, the active compound content advantageously being between 0.1 and 95% and it being possible to obtain a pharmaceutical administration form exactly adapted to the active compound and/or to the desired onset and/or duration of action (e.g. a sustained-release form or an enteric form) by means of the appropriate selection of the auxiliaries and excipients.

The auxiliaries and excipients which are suitable for the desired pharmaceutical formulations are known to the person skilled in the art on the basis of his/her expert knowledge. In addition to solvents, gel-forming agents, suppository bases, tablet auxiliaries and other active compound excipients, it is possible to use, for example, antioxidants, dispersants, emulsifiers, antifoams, flavor corrigents, preservatives, solubilizers, colorants or, in particular, permeation promoters and complexing agents (e.g. cyclodextrins).

The active compounds can be administered orally, parenterally or percutaneously.

In general, it has proven advantageous in human medicine to administer the active compound(s) in the case of oral administration in a daily dose of approximately 0.01 to approximately 20, preferably 0.05 to 5, in particular 0.1 to 1.5, mg/kg of body weight, if appropriate in the form of several, preferably 1 to 4, individual doses to achieve the desired result. In the case of a parenteral treatment, similar or (in particular in the case of the intravenous administration of the active compounds), as a rule, lower doses can be used. The establishment of the optimal dose and manner of administration of the active compounds necessary in each case can easily be carried out by any person skilled in the art on the basis of his/her expert knowledge.

If the compounds according to the invention and/or their salts are to be used for the treatment of the abovementioned diseases, the pharmaceutical preparations can also contain one or more pharmacologically active constituents of other groups of medicaments, for example: tranquillizers (for example from the group of the benzodiazepines, for example diazepam), spasmolytics (for example, bietamiverine or camylofine), anticholinergics (for example, oxyphencyclimine or phencarbamide), local anesthetics, (for example, tetracaine or procaine), and, if appropriate, also enzymes, vitamins or amino acids.

To be emphasized in this connection is in particular the combination of the compounds according to the invention with pharmaceuticals which inhibit acid secretion, such as, for example, H₂ blockers (e.g. cimetidine, ranitidine), H⁺/K⁺ ATPase inhibitors (e.g. omeprazole, pantoprazole), or further with so-called peripheral anticholinergics (e.g. pirenzepine, telenzepine) and with gastrin antagonists with the aim of increasing the principal action in an additive or super-additive sense and/or of eliminating or of decreasing the side effects, or further the combination with antibacterially active substances (such as, for example, cephalosporins, tetracyclines, penicillins, macrolides, nitroimidazoles or alternatively bismuth salts) for the control of Helicobacter pylori. Suitable antibacterial co-components which may be mentioned are, for example, mezlocillin, ampicillin, amoxicillin, cefalothin, cefoxitin, cefotaxime, imipenem, gentamycin, amikacin, erythromycin, ciprofloxacin, metronidazole, clarithromycin, azithromycin and combinations thereof (for example clarithromycin+metronidazole).

In view of their excellent gastric and intestinal protection action, the compounds of formula 1 are suited for a free or fixed combination with those medicaments (e.g. certain antiinflammatories and antirheumatics, such as NSAIDs), which are known to have a certain ulcerogenic potency. In addition, the compounds of formula 1 are suited for a free or fixed combination with motility-modifying drugs.

### Pharmacology

The excellent gastric protective action and the gastric acid secretion-inhibiting action of the compounds according to the invention can be demonstrated in investigations on animal experimental models. The compounds of the formula 1 according to the invention investigated in the model mentioned below have been provided with numbers and their optical antipodes of the formula 2 with letters which correspond to the numbers and letters of these compounds in the examples.

### Testing of the Secretion-Inhibiting Action on the Perfused Rat Stomach

In Table A which follows, the influence of the compounds of the formula 1 according to the invention and of their optical antipodes of the formula 2 on the pentagastrin-stimulated acid secretion of the perfused rat stomach after intraduodenal administration in vivo is shown.

TABLE A

| | Dose | Inhibition of | | Dose | Inhibition of |
|---|---|---|---|---|---|
| | (μmol/kg) | acid secretion | | (μmol/kg) | acid secretion |
| No. | i.d. | (%) | Letters | i.d. | (%) |
| 1 | 1 | 100 | A | 3 | <40 |
| 2 | 1 | 100 | B | 3 | <40 |
| 3 | 6 | >50 | C | 6 | <30 |
| 4 | 3 | >60 | D | 3 | <40 |
| 5 | 3 | >70 | E | 3 | <30 |
| 6 | 3 | 100 | F | 3 | <40 |
| 7 | 1 | 100 | G | 3 | <40 |
| 8 | 2 | 100 | H | 3 | <40 |
| 9 | 1 | 100 | I | 1 | <50 |
| 10 | 1 | 100 | J | 3 | <50 |
| 11 | 1 | 100 | K | 1 | <40 |
| 12 | 3 | 100 | | | |
| 13 | 3 | 100 | | | |

### Methodology

The abdomen of anesthetized rats (CD rat, female, 200-250 g; 1.5 g/kg i.m. urethane) was opened after tracheotomy by a median upper abdominal incision and a PVC catheter was fixed transorally in the esophagus and another via the pylorus such that the ends of the tubes just projected into the gastric lumen. The catheter leading from the pylorus led outward into the right abdominal wall through a side opening.

After thorough rinsing (about 50-100 ml), warm (37° C.) physiological NaCl solution was continuously passed through the stomach (0.5 ml/min, pH 6.8-6.9; Braun-Unita I). The pH (pH meter 632, glass electrode EA 147; φ=5 mm, Metrohm) and, by titration with a freshly prepared 0.01 N NaOH solution to pH 7 (Dosimat 665 Metrohm), the secreted HCl were determined in the effluent in each case collected at an interval of 15 minutes.

The gastric secretion was stimulated by continuous infusion of 1 μg/kg (=1.65 ml/h) of i.v. pentagastrin (left femoral vein) about 30 min after the end of the operation (i.e. after determination of 2 preliminary fractions). The substances to be tested were administered intraduodenally in a 2.5 ml/kg liquid volume 60 min after the start of the continuous pentagastrin infusion. The body temperature of the animals was kept at a constant 37.8-38° C. by infrared irradiation and heat pads (automatic, stepless control by means of a rectal temperature sensor).

1. A compound of the formula 1 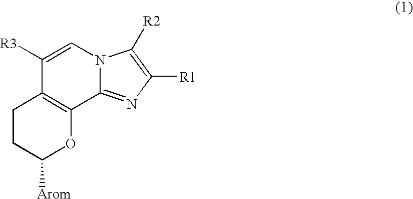
in which
R1 is hydrogen, 1-4C-alkyl, 3-7C-cycloalkyl, 1-4C-alkoxy-1-4C-alkyl or 1-4C-alkoxycarbonyl,
R2 is hydrogen, 1-4C-alkyl, halogen, 2-4C-alkenyl, 2-4C-alkynyl, hydroxy-1-4C-alkyl, 3-7C-cycloalkyl, 1-4C-alkoxycarbonyl,
R3 is hydroxy-1-2C-alkyl, 1-4C-alkoxy-1-2C-alkyl, 1-4C-alkoxy-1-4C-alkoxy-1-2C-alkyl, 1-4-C-alkoxycarbonyl or the radical —CO—NR31R32,
where
R31 is hydrogen, 1-7C-alkyl, hydroxy-1-4C-alkyl or 1-4C-alkoxy-1-4C-alkyl and
R32 is hydrogen, 1-7C-alkyl, hydroxy-1-4C-alkyl or 1-4C-alkoxy-1-4C-alkyl,
or where
R31 and R32 together and including the nitrogen atom to which they are attached are a pyrrolidino, piperidino, or morpholino radical,
Arom is a R4-, R5-, R6- and R7- substituted mono- or bicyclic aromatic radical selected from the group consisting of phenyl, naphthyl, pyrrolyl, pyrazolyl, imidazolyl, 1,2,3-triazolyl, indolyl, benzimidazolyl, furanyl (furyl), benzofuranyl (benzofuryl), thiophenyl (thienyl), benzothiophenyl (benzothienyl), thiazolyl, isoxazolyl, pyridinyl, pyrimidinyl, quinolinyl and isoquinolinyl,
where
R4 is hydrogen, 1-4C-alkyl, hydroxy-1-4C-alkyl, 1-4C-alkoxy, carboxyl, 1-4C-alkoxycarbonyl, carboxy-1-4C-alkyl, 1-4C-alkoxycarbonyl-1-4C-alkyl, halogen, hydroxyl, aryl, aryl-1-4C-alkyl, aryloxy, aryl-1-4C-alkoxy, trifluoromethyl, nitro, amino, mono- or di-1-4C-alkylamino, 1-4C-alkylcarbonylamino, 1-4C-alkoxycarbonylamino, 1-4C-alkoxy-1-4C-alkoxycarbonylamino or sulfonyl,
R5 is hydrogen, 1-4C-alkyl, 1-4C-alkoxy, 1-4C-alkoxycarbonyl, halogen, trifluoromethyl or hydroxyl,
R6 is hydrogen, 1-4C-alkyl or halogen and
R7 is hydrogen, 1-4C-alkyl or halogen,
where
aryl is phenyl or substituted phenyl having one, two or three identical or different substituents selected from the group consisting of 1-4C-alkyl, 1-4C-alkoxy, carboxyl, 1-4C-alkoxycarbonyl, halogen, trifluoromethyl, nitro, trifluoromethoxy, hydroxyl and cyano,
or a salt thereof.

2. A compound of the formula 1 as claimed in claim 1, in which
R1 is 1-4C-alkyl or 3-7C-cycloalkyl,
R2 is 1-4C-alkyl, halogen, hydroxy-1-4C-alkyl, 2-4C-alkenyl or 3-7C-cycloalkyl,
R3 is hydroxy-1-2C-alkyl, 1-4C-alkoxy-1-2C-alkyl, 1-4C-alkoxy-1-4C-alkoxy-1-2C-alkyl, 1-4-C-alkoxycarbonyl or the radical —CO—NR31R32,
where
R31 is hydrogen, 1-7C-alkyl, hydroxy-1-4C-alkyl or 1-4C-alkoxy-1-4C-alkyl and
R32 is hydrogen, 1-7C-alkyl, hydroxy-1-4C-alkyl or 1-4C-alkoxy-1-4C-alkyl,
or where
R31 and R32 together and including the nitrogen atom to which they are attached are a pyrrolidino, piperidino, or morpholino radical,
Arom is a R4-, R5-, R6- and R7- substituted mono- or bicyclic aromatic radical selected from the group consisting of phenyl, naphthyl, pyrrolyl, pyrazolyl, imidazolyl, 1,2,3-triazolyl, indolyl, benzimidazolyl, furanyl (furyl), benzofuranyl (benzofuryl), thiophenyl (thienyl), benzothiophenyl (benzothienyl), thiazolyl, isoxazolyl, pyridinyl, pyrimidinyl, quinolinyl and isoquinolinyl,
where
R4 is hydrogen, 1-4C-alkyl, hydroxy-1-4C-alkyl, 1-4C-alkoxy, carboxyl, 1-4C-alkoxycarbonyl, carboxy-1-4C-alkyl, 1-4C-alkoxycarbonyl-1-4C-alkyl, halogen, hydroxyl, aryl, aryl-1-4C-alkyl, aryloxy, aryl-1-4C-alkoxy, trifluoromethyl, nitro, amino, mono- or di-1-4C-alkylamino, 1-4C-alkylcarbonylamino, 1-4C-alkoxycarbonylamino, 1-4C-alkoxy-1-4C-alkoxycarbonylamino or sulfonyl,
R5 is hydrogen, 1-4C-alkyl, 1-4C-alkoxy, 1-4C-alkoxycarbonyl, halogen, trifluoromethyl or hydroxyl,
R6 is hydrogen, 1-4C-alkyl or halogen and
R7 is hydrogen, 1-4C-alkyl or halogen,
where
aryl is phenyl or substituted phenyl having one, two or three identical or different substituents selected from the group consisting of 1-4C-alkyl, 1-4C-alkoxy, carboxyl, 1-4C-alkoxycarbonyl, halogen, trifluoromethyl, nitro, trifluoromethoxy, hydroxyl and cyano,
or a salt thereof.

3. A compound of the formula 1 as claimed in claim 1, in which
R1 is 1-4C-alkyl,
R2 is 1-4C-alkyl, halogen, hydroxy-1-4C-alkyl or 2-4C-alkenyl,
R3 is hydroxy-1-2C-alkyl, 1-4C-alkoxy-1-2C-alkyl, 1-4C-alkoxy-1-4C-alkoxy-1-2C-alkyl or the radical —CO—NR31R32,
where
R31 is hydrogen, 1-7C-alkyl,
R32 is hydrogen, 1-7C-alkyl,
or where
R31 and R32 together and including the nitrogen atom to which they are attached are a pyrrolidino, piperidino, or morpholino radical,
Arom is a R4- and R5- substituted phenyl, furanyl (furyl), thiophenyl (thienyl), pyrrolyl or pyridinyl,
where
R4 is hydrogen, 1-4C-alkyl, hydroxy-1-4C-alkyl, 1-4C-alkoxy, halogen or hydroxyl,
R5 is hydrogen, 1-4C-alkyl, 1-4C-alkoxy, halogen or hydroxyl,
or a salt thereof.

4. A compound of the formula 1 as claimed in claim 1, in which
R1 is 1-4C-alkyl,
R2 is 1-4C-alkyl, halogen, hydroxyl-1-4C-alkyl or 2-4C-alkenyl,
R3 is hydroxy-1-2C-alkyl, 1-4C-alkoxy-1-2C-alkyl, 1-4C-alkoxy-1-4C-alkoxy-1-2C-alkyl or the radical —CO—NR31R32,
where
R31 is hydrogen or 1-7C-alkyl,
R32 is hydrogen or 1-7C-alkyl,
or where
R31 and R32 together and including the nitrogen atom to which they are attached are a pyrrolidino, piperidino, or morpholino radical,
Arom is a R4- and R5- substituted phenyl, furanyl (furyl), thiophenyl (thienyl), pyrrolyl or pyridinyl,
where
R4 is hydrogen, 1-4C-alkyl, hydroxy-1-4C-alkyl, 1-4C-alkoxy, halogen or hydroxyl,
R5 is hydrogen, 1-4C-alkyl, 1-4C-alkoxy, halogen or hydroxyl,
or a salt thereof.

5. A compound of the formula 1 as claimed in claim 1, in which
R1 is 1-4C-alkyl,
R2 is 1-4C-alkyl, halogen or hydroxy-l-4C-alkyl,
R3 is 1-4C-alkoxy-1-2C-alkyl or the radical —CO—NR31R32,
where
R31 is hydrogen or 1-7C-alkyl,
R32 is hydrogen or 1-7C-alkyl,
or wherein
R31 and R32 together and including the nitrogen atom to which they are attached are a pyrrolidino radical,
Arom is a R4 substituted phenyl or thiophenyl (thienyl),
where
R4 is hydrogen, 1-4C-alkyl or halogen,
or a salt thereof.

6. A compound of the formula 1 as claimed in claim 1, in which
R1 is 1-4C-alkyl,
R2 is 1-4C-alkyl,
R3 is the radical —CO—NR31R32,
where
R31 is hydrogen or 1-7C-alkyl,
R32 is hydrogen or 1-7C-alkyl,
Arom is phenyl,
or a salt thereof.

7. The compound (9S)-2,3-Dimethyl-9-phenyl-7H-8,9-dihydro-pyrano[2,3-c]-imidazo[1,2-a]pyridine-6-carboxylic acid dimethylamide or a salt thereof.

8. The compound (9S)-2,3-Dimethyl-9-(2-methylphenyl)-7H-8,9-dihydro-pyrano[2,3-c]-imidazo[1,2-a]pyridine-6-carboxylic acid dimethylamide or a salt thereof.

9. The compound (9S)-9-(4-Fluorophenyl)-2,3-dimethyl-7H-8,9-dihydro-pyrano[2,3-c]-imidazo[1,2-a]pyridine-6-carboxylic acid dimethylamide or a salt thereof.

10. A process for the synthesis of a compound of the formula 1 as claimed in claim 1, which comprises converting a compound of the formula 8, in which R1, R3 and Arom have the meanings as indicated in claim 1, 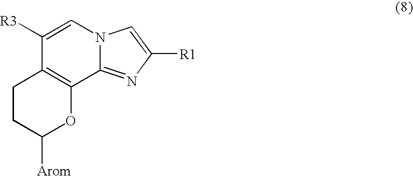
to a racemic mixture of a compound of the formula 1 as claimed in claim 1 and its optical antipode of the formula 2, wherein R1, R2, R3 and Arom have the meanings as indicated in claim 1, 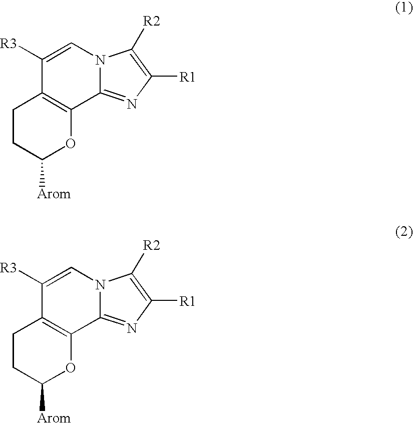
and
separating the compound of the formula 1 from its optical antipode of the formula 2 and
optionally, further derivatizing the compound of the formula 1 either when said compound is a racemic mixture of the compound of the formula 1 and its optical antipode of the formula 2, or after separation of the compound of the formula 1 from its optical antipode of the formula 2.

11. A process for the synthesis of a compound of the formula 1 as claimed in claim 1, which comprises
asymmetrically reducing a compound of the formula 4 to a compound of the formula 17 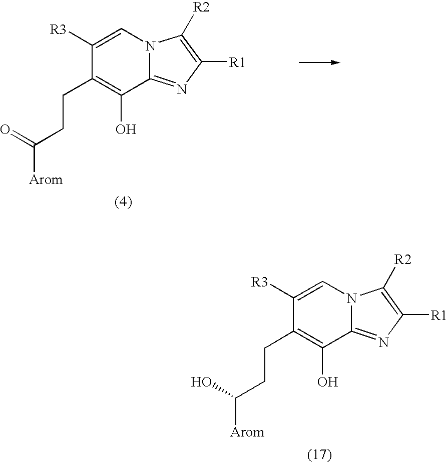
in which
R1, R2, R3 and Arom have the meanings as indicated in claim 1,
and converting a compound of the formula 17 into a compound of the formula 1 or a salt thereof.

12. A process for the synthesis of a compound of the formula 1 as claimed in claim 1, which comprises
converting a compound of the formula 14 to a compound of the formula 17, 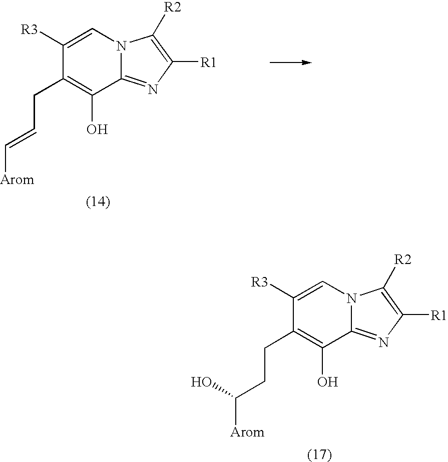
in which
R1, R2, R3 and Arom have the meanings as indicated in claim 1,
and conversion of converting a compound of the formula 17 into a compound of the formula 1 or a salt thereof.

13. A process for the synthesis of a compound of the formula 1 as claimed in claim 1, which comprises
converting a compound of the formula 13, in which R1, R2 and R3 have the meanings as indicated in claim 1, into a compound of the formula 14, in which R1, R2, R3 and Arom have the meanings as indicated in claim 1, 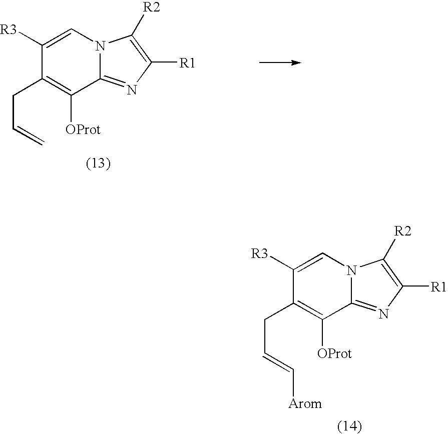
and further converting the compound of the formula 14 into a racemic mixture of a compound of the formula 1 and its optical antipode of the formula 2 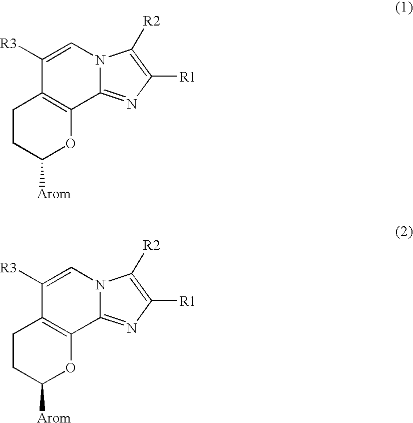
and
separating the compound of the formula 1 from its optical antipode of the formula 2 and
optionally, further derivatizing the compound of the formula 1 either when said compound is a racemic mixture of the compound of the formula 1 and its optical antipode of the formula 2, or after separation of the compound of the formula 1 from its optical antipode of the formula 2.

14. A pharmaceutical composition comprising a compound as claimed in claim 1 and/or a pharmacologically acceptable salt thereof together with a pharmaceutically acceptable auxiliary and/or excipent.

15. A pharmaceutical composition comprising a compound as claimed in claim 1 and/or a pharmacologically acceptable salt thereof together with a pharmaceutically acceptable auxiliary and/or excipent being substantially free of a compound of the formula 2 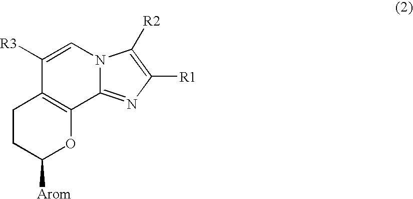
in which R1, R2, R3 and Arom have the meanings as indicated in claim 1.

16. A method of preventing or treating a gastrointestinal disorder in a patient comprising administering to a patient in need thereof a compound as claimed in claim 1 or a pharmacologically acceptable salt thereof.
